(19) United States
(12) Patent Application Publication
(10) Pub. No.: US 2006/0259744 A1
(43) Pub. Date: Nov. 16, 2006

(54) Method for information processing

(76) Inventor: Wolfgang Matthes, Unna (DE)

Correspondence Address: GUDRUN E. HUCKETT DRAUDT, LONSSTR. 53, WUPPERTAL, 42289, DE

(21) Appl. No.: 11/430,824

(22) Filed: May 10, 2006

(30) Foreign Application Priority Data
May 11, 2005 (DE) 102005021749.4

(51) Int. Cl. G06F 15/00; G06F 9/44; G06F 7/38; G06F 9/00

(52) U.S. Cl. 712/220

(57) ABSTRACT

In a method for program-controlled information processing, resources for information processing form a resource pool. Suitable resources are selected from the resource pool and connections between the selected resources are configured. Parameters are supplied to the selected resources and information processing operations are initiated in the selected resources. Data are transported between the selected resources and results are assigned. Connections that are no longer needed are disconnected between the selected resources. The selected resources that are no longer needed are returned to the resource pool.

### BACKGROUND OF THE INVENTION

The invention relates to a method for program-controlled information processing. The invention is to be used in all kinds of program-controlled information processing devices that can perform any type of tasks of information processing by means of programming.

Computing devices (computers) provide their functions based on a combination of circuitry (hardware) and stored programs (software). Decisive for this interaction is the interface between hardware and software (computer architecture). This interface is conventionally characterized by two sets: the set of elementary data structures and the set of machine instructions. The individual machine instructions specify a rather simple processing operation. Instruction sets and data structures have been developed based on experience. The first computers have been developed as automated calculating machines. Therefore, it was self-evident to provide the basic arithmetic operations as instruction functions. An instruction typically triggers such a computing operation, an auxiliary activity (data transport, input, output etc.), or a function of the program sequence control (branching, subroutine call etc.). The individual architectures differ primarily in the supplying functions (addressing, register models). Programs for conventional computer architectures are sequential in their nature. The basic programming model is based on instructions being performed one after another.

It is always desirable to increase the processing performance. The execution time of the individual operations however cannot be shortened arbitrarily. The limits are set by the switching delays and the signal propagation delays of the hardware. In order to increase the processing performance beyond these limits, computers have been provided with several processing devices that can be operated simultaneously (parallel to one another). The problem resides in how to use the devices. In some fields of application it is apparent that a plurality of information processing operations can be performed simultaneously (parallel processing). In many cases, however, the possibility of parallel processing is not easily recognizable. Most programs are not written to take into account parallel processing, and the conventional programming languages are based on the sequential execution of instructions. Not all commands or instructions, however, must be performed sequentially. Example:

1st instruction: X := A + B

2nd instruction: Y := C + D

When two computing units are available, both instructions can be performed at the same time. The fact that instructions and instruction sequences are present in conventional programs that can be performed simultaneously (parallel to one another) is referred to as inherent parallelism.

There are different possibilities to recognize the inherent parallelism and take advantage of it. The decisive prerequisite is the availability of several processing units (superscalar principle). The important differences reside in the control of this hardware. Basically, there are two principles.

A) Conventional Programing Interface or Instruction Set.
The individual instruction indicates a single operation to be performed, respectively, and initiates thus the utilization of a single processing unit. The inherent parallelism is recognized at run time. For this purpose, several sequential instructions are fetched and decoded at the same time. Since parallel processing is not been taken into account when writing the program, conflicts may arise. Example:
   1st instruction: X := A + B
   2nd instruction: Y := C + X
When both instructions are carried out simultaneously, the second instruction uses the prior value of X and therefore provides a wrong result. Such conflicts are detected by special circuits and are solved by repeating the instruction in question. In addition to the actual processing devices, circuits for recognizing the opportunities for parallel processing and for detecting and solving the conflict situations are required. The expenditure for this is comparatively high. Therefore, only a few instructions can be checked with regard to the possibility of parallel execution, and the number of processing devices cannot be increased arbitrarily. Typically, two to four processing units are provided for each data type (binary numbers, floating point numbers etc.). A significantly greater number of processing units would require an unbearable expenditure for detecting the possible conflict situations.
Since in the conflict situation the execution of the instruction must be repeated, the processing performance drops in practice. Moreover, because of the controlling and monitoring overhead, it is conventional to support only elementary instructions in this way. Instructions with complex functions are often still executed only serially.

B) Instructions with Control Codes Related to Parallel Processing.
There are different embodiments, for example, extremely long instructions with control fields for all processing units (VLIW=very long instruction word) or instructions that provide information wether subsequent instructions can be performed in parallel or not (explicit parallelism). Hardware means to detect the inherent parallelism are not required (circuit simplification). The number of processing devices supported in this way is however limited (instructions cannot become arbitrarily long) and, typically, fixed in the respective architecture (for example, limited to 3, 4, or 8 operation units). The actual processing performance depends significantly on the compiler that must recognize based on the source code the programming goal and must decide how the available resources are to be used best. Such an optimized machine program is however not executable on hardware having a deviating configuration (for example, eight instead of three operation units) without new compilation.

In regard to the developmental state of general-purpose computers, extensive literature is available. An overview, inter alia, is provided by the textbook “Computer Architecture—A Quantitative Approach” by Patterson and Hennessy. Details can be taken primarily from manuals and user handbooks that are provided by the respective manufacturers through the Internet. For example, Intel Corporation of Santa Clara, Calif., USA, provides an online “Resource Center” for accessing such information.

A further possibility for improving performance resides in that the desired information processing operations are not carried out with sequences of comparatively simple instruction functions but that the circuitry is designed specifically in a targeted approach in regard to the desired functions (special hardware). Such devices are preferably implemented with programmable logic circuits (field programmable gate arrays FPGAs). This requires a detailed circuit development. In order to facilitate the developmental work, complete circuits (IP cores; IP=intellectual property) are made available that are embedded into one's own designs. There are two kinds of such IP cores:
“soft cores”: They are present as circuit descriptions, are incorporated into the developmental course and are realized with the means of programmable circuits (function blocks, macro cells etc.).
“hard cores”: They are present on the circuit in a fixed form (not programmable).

Such circuits are comparatively expensive and the development is complex. It is therefore obvious to search for compromise solutions and to solve the respective application task with a combination of hardware and software. Typical principles are:
a conventional general-purpose computer (typically a microprocessor) interacts with special hardware;
only functions that are really time-critical are supported by special hardware;
if no extreme performance requirements are made, special hardware is not used;
the general-purpose computer (processor) can be changed with regard to its structure in order to keep cost at a minimum (this concerns, for example, the size of register files and the processing acceleration for certain instructions).

Significant difficulties result from the fact that two different developmental tasks are to be coordinated with one another and adjusted relative to one another (hardware software co-design). Conventionally, such problems have been solved by using two languages (programming language plus hardware description language). In this connection, a general-purpose processor is optionally supplemented by additional hardware. The general-purpose processor remains essentially the same; there is only the possibility of changing the configuration within certain limits (this concerns, for example, the size of cache memories and register files, the arrangement of floating point processing hardware etc.). Special hardware that is attached to the general-purpose processor is addressed by special instructions that are added to the instruction set of the processor. Such a method is disclosed in detail, for example, in U.S. Pat. No. 6,477,683. This patent contains also additional references in regard to prior art.

### SUMMARY OF THE INVENTION

It is an object of the present invention to utilize the inherent parallelism in information processing operations to the highest possible degree, i.e., within the limits that result from the programming task, on the one hand, and the respectively available hardware, on the other hand, and to provide interfaces between hardware and software that ensure arbitrary interchangeability of hardware and software.

The object of the invention resides in providing a method for utilizing information processing devices by which method any number of such devices can be addressed freely by a program or can be freely configured to circuit arrangements that carry out the desired information processing operations.

The shortcomings of the known solutions are caused primarily by still using basically conventional general-purpose computers. Devices that attempt to recognize the inherent parallelism in conventional programs at run time can take into consideration only a few sequential instructions, respectively. Moreover, conflict situations are to be detected and optionally to be solved by repeated execution of instructions. For this purpose, comparatively complex circuits are required. The actual processing devices are utilized only insufficiently because, for the purpose of conflict solution, they must be passed optionally several times (instruction retry). When the parallel operation is controlled explicitly by the instruction, the afore described disadvantages are eliminated. However, only a limited fixed number of processing devices can be supported and the design of the individual processing devices is also subject to rather rigid limitations (for example, with regard to the number and type of operands, the number of clock cycles for each information processing operation etc.). The transition onto systems that are designed only minimally differently requires new compilation of the programs in question (a system that comprises, for example, eight processing devices can be utilized only insufficiently by means of machine instructions that support only three processing devices). When a general-purpose processor is supplemented by special hardware, two different developmental approaches must be mastered (hardware software co-design). Such arrangements are really effective only within a very narrow field of application, and the transition to another field of application requires typically a new developmental approach.

The object is solved according to the invention by the method steps presented in the claims. The method is based on the principle that the devices that are provided for performing the information processing operations form a resource pool. The resources that are required, respectively, are selected from this pool and are used for performing the respective information processing operations. Resources that are no longer required are returned to the resource pool.

The method according to the invention enables the control of individual method steps by means of stored instructions. The method enables the configuration of complex resources from simple ones; the generation, transportation and modification of instructions by recursive application of the method steps; and the configuration of resource arrays that correspond to the data flow diagram of the respective application problem. The method according to the invention enables also making available resources in the form of circuit arrangements by program-based emulation of the respective functions or by creating by means of programming a circuit arrangement on a suitable circuit.

The invention is based on the fact that any program requires always a hardware in order to be executed; essentially, the program is transformed into information transports, combinational operations, and state transitions, i.e., into the flow of information in a register transfer structure. The invention acts in such a way that, starting with the programming objective, an appropriate register transfer structure is configured ad hoc, basically from elementary processing devices that are referred to as resources. A resource in this connection is to be understood, for example, as a conventional arithmetic logic unit (ALU) but also as a complex special circuit. The general model of a resource is hardware that performs certain information processing operations, i.e., computes from provided data (at the inputs) new data (at the outputs). The method is based on the following:
There are sufficient resources available at any time. This is initially a theoretical assumption (hypothesis of (nearly) unlimited (transfinite) resource pool). Based on this principle, it is possible to request any number of resources (for example, several hundred multipliers) and to utilize the inherent parallelism to the fullest. Machine programs are typically generated (for example, by means of compilers) as if any number of resources were available. The adjustment to the practical conditions (any real resource pool is limited) can be realized at compile time or run time (emulation, virtualization).
Whether a resource is realized as software or hardware is of no consequence.
The basic model of a resource is always hardware, i.e., a technical device with input and output.
A processing operation (program sequence) resides in the utilization of resources during the course of time (resources are fetched as needed from the resource pool and returned when not in use).
The instructions (operators) that are provided for controlling the method concern only the basic processing steps of request, transport, initiation etc. but not concrete machine operations (complete machine independence).
The devices serving for performing the method can be configured recursively from elementary resources.
Instructions that control the method steps according to the invention can be generated, transported or modified by recursive application of method steps according to the invention.
It is of no consequence where the resources are located and how they are designed. Inter alia, it is possible to request and utilize resources through the Internet (for example, special computers).

In order to carry out a certain programming task, suitable resources are selected from the resource pool, respectively. They are provided with parameters. Subsequently, the processing operations are triggered in the resources. Subsequently, the results are assigned (final results are stored or output; intermediate results are transferred to other resources). Additional operations of parameter supply, triggering and assigning are carried out until the processing task is completed. Finally, the no longer required resources are returned to the resource pool. The processing operations are controlled by instructions that are provided in memory means. Special method steps enable the creation of connections between resources (the resources are linked with one another) and the disconnection of the resources. When a connection (link) is provided between resources, the method steps of supplying parameters, triggering the processing operations and assigning the results within the linked resources are carried out automatically. It is then no longer required to control each method step by special instructions.

The instructions contain, on the one hand, a bit pattern that characterizes the type of information and the function to be performed and, on the other hand, information regarding the memory devices, processing devices and control devices for performing the method. They act typically in the sense of selecting or addressing and in the sense of triggering transport sequences and processing sequences. For requesting the instructions from the memory means, additional resources are provided. There are different possibilities for designing the instructions:
they are laid out especially for controlling the method steps according to the invention;
they are formatted similar to known machine instructions or microinstructions;
their functions are emulated with sequences of conventional machine instructions or microinstructions.

Essentially, the method is based on developing hardware that can carry out the respective processing task, initially as a thought experiment independent of the actual practical feasibility. This virtual hardware can be configured, modified, and released dynamically during run time. It is decided case by case, which configuration is actually to be implemented as hardware and which is not. If a resource is not directly available as hardware, its function is emulated with other resources based on the method according to the invention (recursion) or with conventional machine programs.

The method steps of parameter transfer, function initiation etc. can be used on processing circuits (hardware) as well as programs (software); programs and hardware resources are requested in the same way. Each program or subroutine corresponds to the model of hardware with registers at the inputs and outputs (register transfer model).

The instructions do not encode certain operations but the configuration, modification and release of resources, the corresponding data transports and the activation of the corresponding resources.

Devices for performing the method contain platform arrangements, processing circuits and memory means. It is possible to arrange corresponding circuitry on programmable circuits (FPGAs). All these devices can be incorporated into the resource pool and can be addressed by application of the method steps according to the invention.

The individual resource can be:
A circuit arrangement with fixed function.
A circuit arrangement with selectable function.
A program-controlled circuit arrangement (controlled by conventional machine instructions or by microinstructions).
An appropriately divided memory area, supplemented by program control operators (emulation).
An appropriately divided memory area, supplemented by a description of a circuit arrangement that can perform the respective information processing operations (for example, in the form of netlists or Boolean equations). This description can be used to simulate the circuitry in a known way. Alternatively, the circuitry in question—assuming that appropriate programmable circuits (FPGAs) are present—can be generated actually by programming (circuit synthesis).

The method according to the invention can be performed:
with conventional general-purpose computers,
with modified general-purpose processors (modified instruction decoder, modified register file, different microprograms etc.),
with special computers designed from scratch for performing the method,
with programmable circuits (FPGAs).

By utilizing the method according to the invention, the inherent parallelism that resides in the programs to be executed can be used to the degree of the quantity of hardware being actually available. Hardware means for conflict detection, instruction retry etc. are not required. Memory means and operation units can be connected directly with one another (in comparison to the register files of the known high-performance processors, fewer access paths are required and the address decoding is simplified). The operation units can be embedded in memory arrays (resource cells, active memory arrays) so that very short access paths are provided. This simplification of the hardware provides the possibility of increasing the clock frequency, saving on pipeline stages (shortening of the latency of operation execution), and of arranging on a given silicon real estate a larger number of or more powerful operation units. The perspective possibilities that are provided by the semiconductor technology (for example, a few hundred million transistors on a circuit) can be utilized to a large degree. Since the inherent parallelism is recognized directly from the programmer's intentions (in statu nascendi), it is possible to optionally utilize even hundreds of processing units at the same time in order to accelerate the execution of the individual programs. Depending on the cost and performance goals and depending on the state of technology, hardware and software are interchangeable with one another (for example, a subroutine can be exchanged for a special processing unit and vice versa). Corresponding programs are therefore invariant with regard to technological development; they can utilize any progress of circuit integration without problems. Systems can be realized on programmable circuits that represent basically arbitrary combinations of hardware and software. Auxiliary functions that are important for applications in regard to practical use, for example, debugging, system administration, data encryption etc., that require conventionally additional software routines (loss of speed) or special hardware (cost) can be organically embedded into the resources (the additional cost is minimal because, as a result of the direct connections, more possibilities for circuit optimization are present and the system efficiency is not affected). Moreover, additional resources can be taken from the general resource pool in order to configure corresponding devices as needed (when the respective function, for example, for debugging, is no longer required, the resources in question are again available for general use).

### BRIEF DESCRIPTION OF THE DRAWING

In the following, details of the method, embodiments of devices for performing the method as well as exemplified variants of corresponding instruction formats will be described in more detail. The drawings show in:

FIG. 1 a general illustration of hardware at the register transfer level (RTL);

FIG. 2 RTL diagrams of resources of different types;

FIG. 3 two arrangements of several resources;

FIG. 4 resources connected to a random access memory (RAM);

FIG. 5 alternative realization of resources as hardware and as software;

FIG. 6 utilization of a resource according to the method of the present invention;

FIG. 7 connection of resources according to the data flow diagram of the information processing operations, respectively;

FIG. 8 resources with sequentially numbered parameters;

FIG. 9 a resource configuration that is the basis for an exemplary application program;

FIGS. 10 to 12 different devices for performing the method according to the invention;

FIG. 13 a processing resource with a system interface controller;

FIG. 14 a simple platform structure;

FIG. 15 a resource configuration in which conditional branching is executed;

FIG. 16 and FIG. 17 platform structures for supporting branching operations;

FIG. 18 and FIG. 19 branching operations in typical program constructs;

FIGS. 20 to 23 modifications of the platform structure;

FIG. 24 an overview of the parameters of the platform;

FIGS. 25 to 28 typical principles of memory addressing;

FIG. 29 a system with two memory devices;

FIG. 30 signal flows of instruction fetching;

FIGS. 31 and 32 embodiments of the processing resources;

FIG. 33 a processing resource with upstream and downstream addressing resources;

FIGS. 34 to 39 different embodiments of addressing resources and iterator resources;

FIGS. 40 to 48 different embodiments of processing resources;

FIGS. 49 to 58 details regarding concatenation of resources;

FIGS. 59 to 70 resources that are connected to memory means and embedded in memory means;

FIGS. 71 to 79 resources in integrated circuits, primarily in FPGAs;

FIGS. 80 to 85 examples of table structures for resource administration;

FIGS. 86 to 96 details of resource addressing;

FIGS. 97 to 101 variants of instrumentation;

FIGS. 102 to 105 details of byte codes;

FIG. 106 an exemplary memory layout;

FIG. 107 parameter addressing in the memory;

FIGS. 108 and 109 high-performance systems according to the prior art;

FIGS. 110 and 111 block diagrams of high-performance superscalar processors;

FIG. 112 a modification of a conventional superscalar processor for performing the method according to the invention.

### DESCRIPTION OF THE PREFERRED EMBODIMENTS

First, characteristic terms and background information will be explained. Subsequently, the method according to the present invention will be explained in detail. The description also concerns devices for performing the method according to the present invention, variants of the design of the instruction formats as well as explanations of typical fields of application.

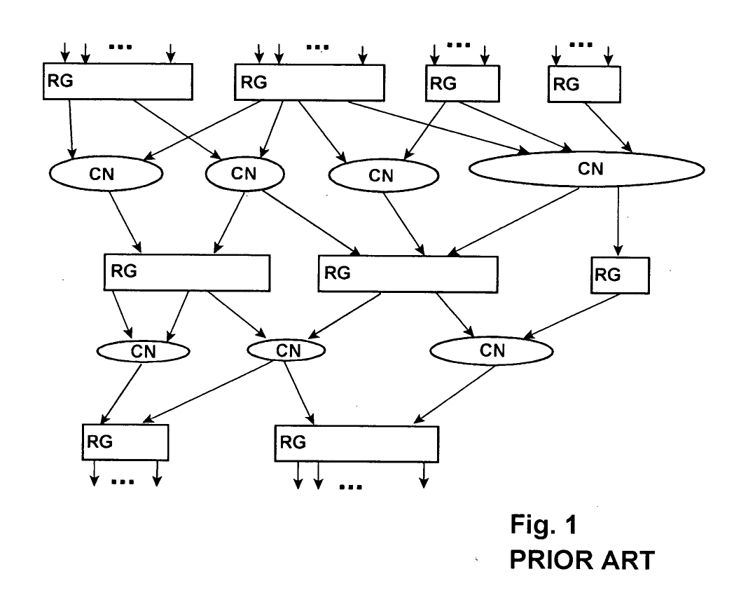

With the aid of FIGS. 1 to 7, the meaning of the term resource in accordance with the present invention with the explained in more detail. Moreover, it will be demonstrated how such resources can be used in order to carry out elementary tasks of information processing.

FIG. 1 illustrates the term of register transfer level (RTL). Each digital information processing device can be reduced to memory means (flip flops, registers, memory cells) and combinational networks; its function is determined completely by memory means RG and by Boolean equations that describe the combinational networks CN. In the following, the resources can therefore be illustrated without limitation in regard to general applications by simple register transfer (RTL) diagrams. The Boolean equations that describe the conventional basic information processing operations are general knowledge of the art.

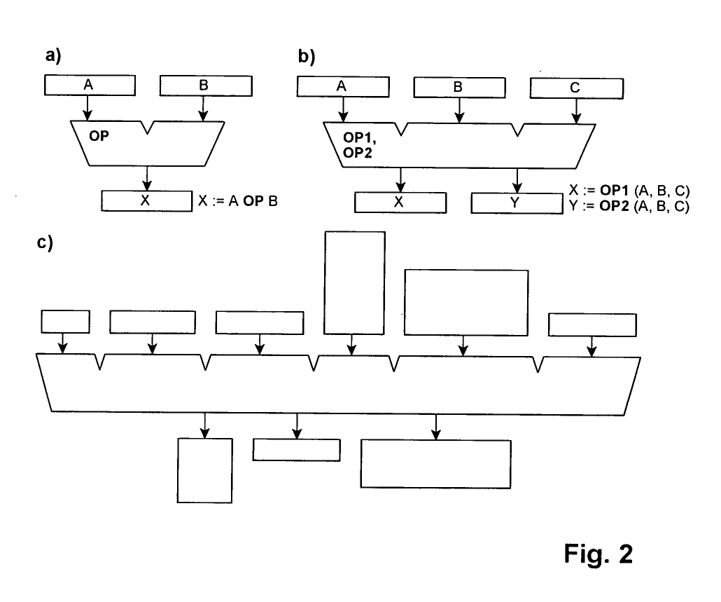

FIG. 2 shows register transfer diagrams of simple resources. They are comprised of registers that receive the operators and the results and of intermediate combinational networks. For example, elementary resources (FIG. 2a) generate a single result (X) from two operators (A, B):
X := A OP B or X := OP (A, b)

Most of the processing instructions of typical general-purpose computers correspond to this scheme (the differences lie primarily in the way how the operands are fetched delivered and how the result is assigned). The conventional operation units and arithmetic logic units (ALUs) can be viewed as an example of such elementary resources.

General-purpose computers know only a few elementary data types, for example, integers, floating point numbers, characters, etc., wherein at least several formats are supported (for example, 16, 32, and 64 bits). The operation unit usually processes only data of a certain type (for example, integers or floating point numbers). For elementary operations, the operands and the results have the same format.

Resources according to the invention have no such limitations. A resource can create from an arbitrary number of operands any number of results, wherein the operands and the results may belong to any data type or data format (FIG. 2b, FIG. 2c). There is also no limitation to elementary data types. The data types can be as complex as desired (bit and character strings, arrays, heterogeneous structures (records) etc.).

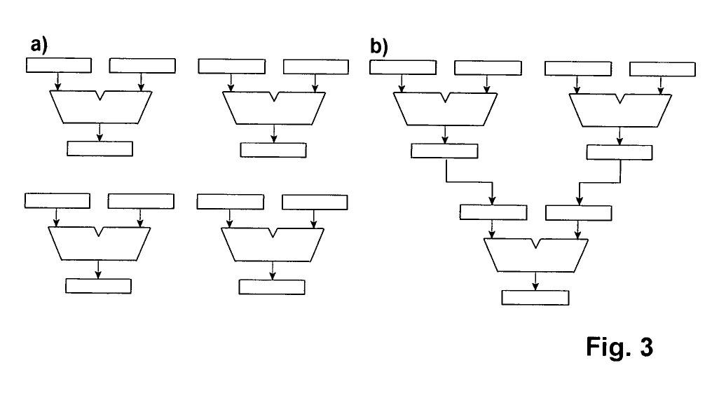

The typical conventional general-purpose computer executes one instruction at a time. For this purpose, a single processing resource is sufficient. It is self-evident to increase the processing performance by providing several processing resources. FIG. 3 shows two examples. When the resources are independent from one another (FIG. 3a), utmost flexibility is ensured. However, there remains the problem of supplying them with operands (parameters) and to transport the results. One solution resides in that the resources are to be connected according to the most frequent data flow with one another such that the results can immediately become operands of other resources (concatenation; FIG. 3b).

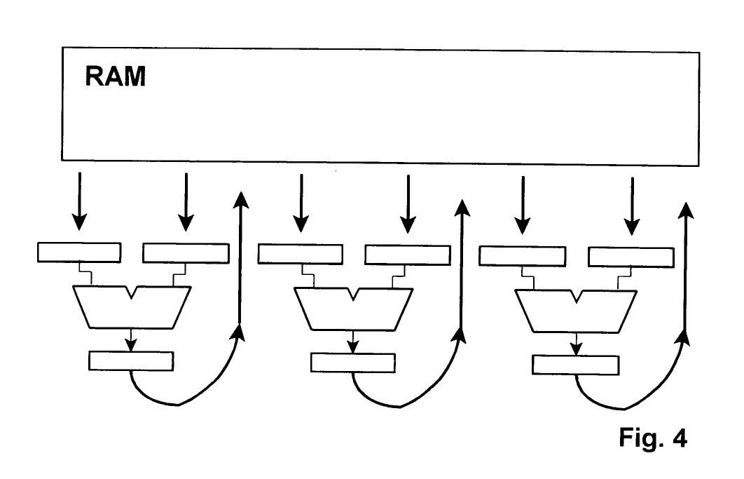

FIG. 4 illustrates an alternative configuration. The resources are connected to a random access memory (RAM). Each processing sequence is divided into three time slots:
transport of the operands to the resources;
processing within the resources (simultaneously in all of them);
transport of the results into the memory.

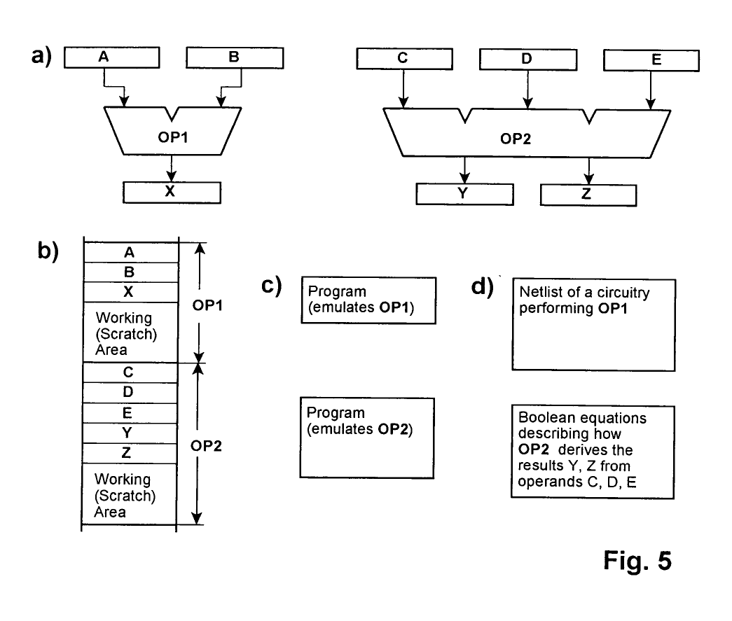

FIG. 5 illustrates that the resources can be realized with hardware as well as with software. Memory areas with memory cells for the parameters and the results (FIG. 5b) correspond to the operand registers and the result registers of the hardware (FIG. 5a); programs that carry out the respective information processing operations (FIG. 5c) correspond to the combinational networks. The alternative is to store the description of a circuitry that can perform the respective information processing operations (FIG. 5d). In order to emulate or simulate the operations of the resources by means of software, additional working areas are often required (compare FIG. 5b).

There are several possibilities for coding the information processing operations:
A. Conventional machine programs or microprograms (emulation).
B. Utilization of the method according to the invention. In order to provide the function of the corresponding resource, an arrangement of other resources is configured, supplied with parameters etc. (will be explained in the following in detail). A complex resource can therefore be emulated by a configuration of several simple resources (recursion). Alternatively, it is possible to request corresponding general-purpose resources and to initialize them such that they can perform the respective information processing operations.
C. Description of a circuit arrangement that carries out the respective information processing operations (for example, in the form of a netlist). Based on this, it is possible to generate the respective hardware (for example, on a programmable circuit) or to emulate its function (circuit simulation).
D. Representation of the Boolean equations that describe the respective information processing operations. Based on this, it is possible to generate a corresponding hardware (circuit synthesis) or to evaluate the Boolean equations computationally (simulation of register transfer level).

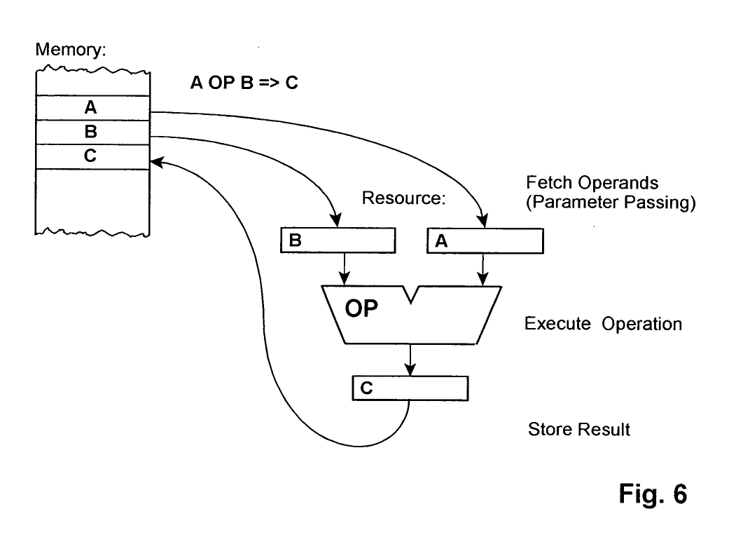

The method according to the invention employs any number of any resources. FIG. 6 illustrates how a resource can be used according to this method. In the example the following method steps are performed:
the selected resource is supplied with parameters (operands);
the operation is performed (by activating the hardware or by executing the program),
the result is transported (assigned to the result variable).

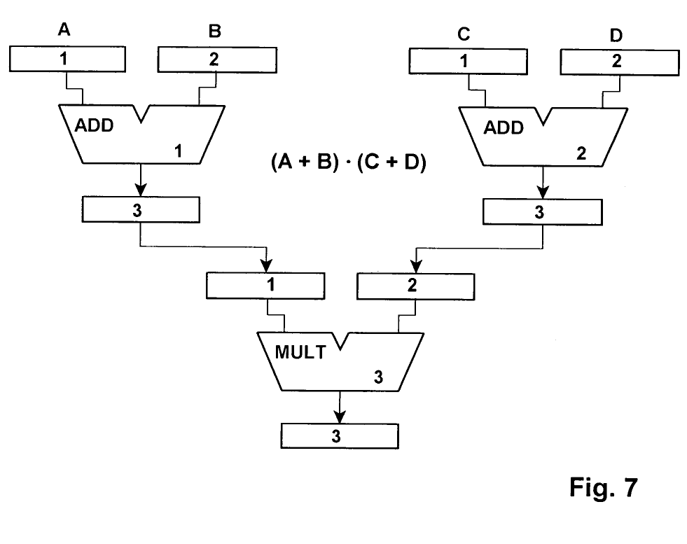

Functional units of the hardware can be combined to complex arrangements. Such a (special) hardware corresponds to the data flow diagram of the respective information processing operations. FIG. 7 shows an example (utilization of this arrangement will be explained infra). The method according to the invention provides the possibility of connecting (in the following: concatenate) resources to such data flow diagrams and to disconnect the connections (concatenations).

The method steps according to the invention are controlled by stored instructions. Instructions that are formed specifically for controlling the method steps according to the invention will be referred to in the following as operators. The method steps with be explained with the aid of the correlated operators:
a) selecting resources: s-operator (select),
b) providing connections between resources (concatenation): c-operator (connect),
c) supplying parameters: p-operator (parameter),
d) initiating information processing operations: y-operator (yield),
e) transporting data between resources: l-operator (link),
f) assigning results: a-operator (assign),
g) disconnect connections (concatenations) that are no longer needed: d-operator (disconnect),
h) releasing resources: r-operator (release).

Depending on how the concatenation provisions are provided in the resources, there are several basic variants of the method:
A. The concatenation is not supported at all. Steps 2 and 7 are obsolete. The parameter transport must be performed exclusively with p-operators, l-operators, and a-operators, the operation initiation exclusively with y-operators.
B. Not all resources support an unlimited concatenation. When this is the case, random data flow diagrams cannot be configured. In some cases, the concatenation provisions are not usable, and the method must be performed according to a).
C. The input concatenation—to be described infra in more detail—is not supported. The concatenation can only be used for the transport of parameters but not for initiation of operations (for initiation, y-operators are always required).
D. The input concatenation is supported. In this case, it is possible to automatically initiate the respective operations (i.e., without y-operator). Such a resource begins—if set up or initialized appropriately—with the execution of the operation when all operands are valid, no matter in which way they are supplied (p-operator, l-operator, concatenation).

In practice, additional supplemental information is often required, for example, for supporting compilers, for system administration etc. In order to be able to introduce such information into the notation used in this context, the following supplemental operators are introduced:
hints: h-operator,
meta-language functions and information: m-operator,
administrative and auxiliary functions: u-operator (utility).

Hints (h-operators) inter alia can cause variables or program pieces to be loaded as a speculative measure into cache memories so that, when required, they are already available at high probability. This principle is known in the art. Therefore, it must not be described in detail. Additional h-operators can be provided in the same context in order to indicate future demand in regard to certain resources or certain configurations of connected (concatenated) resources. Such information can be advantageously used, inter alia, in order to optimize the removal of resources (s-operators) from the resource pool (in that, for example, resources are assigned to the requesting program; the resources—for the subsequent concatenation—are arranged at an especially beneficial location on the circuit).

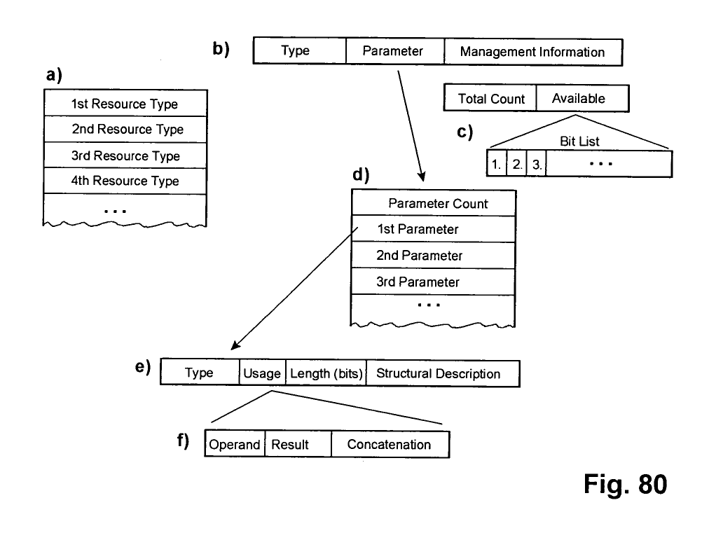

Meta-language functions and information (m-operators) concern, inter alia, the setup of configurations and the conditioned execution of method steps. In approximation, such operators can be compared to pre-processor and compiler directives of conventional programming languages. However, they can become active not only at compile time but also at run time. A typical application: as a function of which resource types are available, one of several sequences is selected in order to realize a certain programming task. Conventional conditioned branches depend on the processing results, initial allocations, operands etc. Meta-language caused branching depends, inter alia, on the type and number of available resources. The m-operators can access and change the contents of the table structures of resource administration (will be explained infra in connection with FIGS. 80 to 85).

Administrative and auxiliary functions (u-operators) carry out general organizational and supporting tasks. All those functions that are required during program execution but can not be encoded with operators s, c, p, y, l, a, d, r, h, m are performed by u-operators.

The functions that are encoded with h-, m-, and u-operators can be provided by devices that are outside of the resource pool. This can be, for example, a conventional general-purpose computer that administers and controls the pool of processing resources. Such devices are generally referred to in this context as platforms.

Alternatively, it is possible to specifically provide for many of these functions additional resources or to configure, based on already present resources, corresponding arrangements ad hoc, for example, resources that fill speculatively cache memory, reserve other resources, or administer resource tables. Basically, the platform that is outside of the resource pool can be limited to simplest functions of instruction fetching, initialization etc. All additional functions can be reduced to the utilization of a sufficiently furnished resource pool by appropriate application of the method steps according to the invention (recursion). Therefore, a more precise description of the h- and m-operators is not required. The u-operators will be explained in more detail when this is necessary for understanding the respective details.

The data with which the resources work are generally referred to in this context as “parameters”. Input parameters are also referred to as operands; output parameters are referred to as results. The following types of parameters are present:
inputs (operands; IN-type)
outputs (results; OUT-type),
inputs and outputs (INOUT-type).

The parameter transfer is realized in general by value. If this is not easily possible, additional resources must be provided in order to supply and transport the values.

Processing operations according to the invention can be represented as follows:
colloquial; this requires no special conventions but is copious and not always clear;
as text code; formalized notation based on simple character strings;
byte code; compact binary coded representations; derived from text code;
machine code; binary; machine-specific.

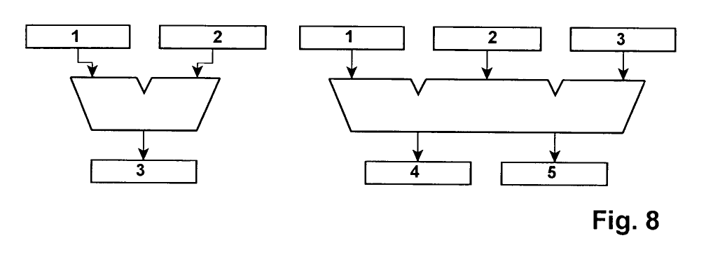

In the following description a text code is employed that has the features explained in the following:
1) Remarks are introduced by -- (compare programming language Ada).
2) The assignment sign in language constructs (for example, in equations) is the colon equal sign := (: identifies the destination of the assignment).
3) Parameters are numbered sequentially (ordinal numbers):first the inputs, then the inputs and outputs, then the outputs. FIG. 8 shows two examples.
4) Sequential numbering of the resources: the following examples refer to sequential numbering (1, 2 etc.) according to the sequence of the s-operators. The assigned sequential numbers (ordinal numbers) remain valid even when intermediately resources with lower numbers have been returned (r-operator). Instead of ordinal numbers symbolic names can be assigned.
5) Designation of resource types, resources and parameters: by ordinal numbers or symbolic names. Syntax of the assignment of a symbolic name: ordinal number symbolic name.
6) Representation of transport processes (parameter transfer), assignments and connections in operators: => (arrow symbolizes transfer direction).
7) Naming of a parameter of a certain resource: resource . parameter (dot between resource designation and parameter designation).
8) Blank spaces can be inserted or omitted as needed.
9) Identification of variants of the operators: by additional designations that are separated by an underscore_ (for example, s_a; p_imm or u_rs2).

The notation used in this connection is essentially intended for machine-internal use. Therefore, user-friendliness etc. is not important. This concept does not concern a new programming language for application programmers. The text code should instead be short in order to be able to effectively process corresponding representations by software means (parsing, analysis, conversion, translation etc.). First, the operators—and thus the method steps—will be explained in detail.

1. Selecting resources: s-operator:

s (1st resource type, 2nd resource type etc.).

By means of the s-operator resources are requested. For conventional (generic) resources, the respective type is provided, for special resources the respective identifier (symbolic name) is provided. Generally, Internet addresses etc. can also be used as identifier.
The requested resources are numbered sequentially. Subsequent operators then refer to the thus assigned ordinal numbers or to the correlated symbolic name.
In a further modification, the s-operators can also contain explicit information regarding the identifier, ordinal numbers or addresses that are assigned to the requested resources (operator variant s_a).
s_a (1st resource type => 1st resource number, 2nd resource type => 2nd resource number etc.).
As a function of the respective resource array, s-operators can act as follows:
   a corresponding hardware resource is reserved, initialized, and assigned;
   corresponding memory space is reserved, initialized, and assigned; optionally, the respectively required control information is loaded (programs, microprograms, netlists, Boolean equations etc.);
   the required resource is built from other resources (recursion);
   a corresponding hardware is generated, for example, by programming cells and connections of a programmable logic circuit.
Initializing a resource means that, for example, fixed values and initial values are entered, access widths are set, function codes and other control information is loaded. Assigning a resource means that it is incorporated into the administration of the selected resources so that it can be accessed by operators under a sequential number (ordinal number) or by means of address information. Details in this regard will be explained in connection with FIGS. 80 to 85.
   2. Providing connections between resources (concatenation): c-operator:
   c (1st source resource . 1st result => 1st destination resources . 1st parameter, 2nd source resource . 2nd result => 2nd destination resource . 2nd parameter etc.).
The simplest concatenation connects an output (result parameter) of the source resource with an input (operand parameter) of the destination resource. Moreover, it is possible to concatenate inputs with one another (input concatenation). The function of such a concatenation corresponds to a parallel connection of the corresponding inputs. Application: for supplying simultaneously the respective parameters to several resources. The c-operator enters concatenation control information into the respective resources. In some implementations (for example, in FPGAs) it can cause the generation of corresponding physical connections (for example, by programming the circuit). The resources are to be concatenated before the corresponding processing functions are initiated (y-operator).
   3. Supplying resources with parameters: p-operator:
   p (1st variable => resource . parameter, 2nd variable => resource . parameter etc.).
The p-operators indicate which variable is transported into which parameter position of which resource. The variables are identified by name, ordinal numbers or address.
Instead of variables, it is also possible to provide immediate values (operator variant p_imm):
p_imm (1st immediate value => resource . parameter, 2nd immediate value => resource . parameter).
In resources that support the input concatenation, the operators can also initiate execution of the operation (processing begins when all operands are valid).
   4. Information processing operations: y-operator:
   y (1st resource, 2nd resource etc.).
The y-operator initiates the processing operations in the designated resources. What is performed in the respective resources results either directly from the type of resource (if it can perform only a single function) or from the parameters (function codes) that have to be set beforehand (for example, with s-operators or p-operators).
In another configuration, the function code is transferred in the y-operator (operator variant y_f):
y_f (1st function code => 1st resource, 2nd function code => 2nd resource etc.).
This variant is in conflict with the principle of coding only basic process steps but not concrete machine operations. It is a type of pragmatic minimalist solution (suitable, for example, for small FPGAs, microcontrollers etc.).
An alternative variant of the operation initiation (without y-operator) is based on starting the processing operations when all required operands are valid. For this purpose, the corresponding resource must support input concatenation. Valid operands can be supplied by concatenation, by p-operators or by l-operators.
   5. Transporting data between resources: l-operator:
   l (1st source resource . 1st result => 1st destination resource . 1st parameter, 2nd source resource . 2nd result => 2nd destination resource . 2nd parameter etc.)
The l-operator effects the transport of parameters between different resources (from the output of the source resource to the input of the destination resource, respectively).
In resources that support input concatenation, the l-operators can also initiate execution of operation (processing begins when all operands are valid).
   6. Assigning results: a-operator:
   a (1st resource . 1st result => 1st result variable, 2nd resource . 2nd result => 2nd result variable etc.).
The a-operator assigns the contents of the designated result positions of the designated resources to the designated variables. The variables are identified by name, ordinal numbers or addresses.
   7. Disconnecting connections (concatenation) that are no longer needed: d-operator:
   d (1st source resource . 1st result => 1st destination resource . 1st parameter, 2nd source resource . 2nd result => 2nd destination resource . 2nd parameter etc.).
The d-operator disconnects existing concatenations. In some implementations (for example, in FPGAs) it can cause the corresponding physical connections to be dissolved (for example, by reprogramming). Subsequently, the resources can be concatenated differently or can be operated individually.
   8. Returning the resources (release): r-operator:
   r (1st resource, 2nd resource etc.).
The resources are returned to the resource pool. They are therefore available for other processing tasks.

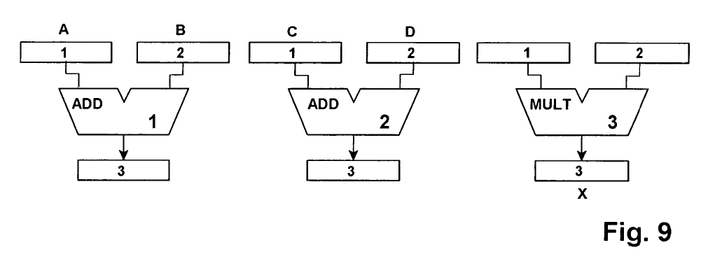

The following example illustrates how a programming goal can be realized based on the method according to the invention. FIG. 9 illustrates the resource array comprised of two adders (ADD) and a multiplier (MULT). See FIG. 7 for the concatenation. The sequential numbers (ordinal numbers) of the resources: first adder=1, second adder=2, multiplier=3. The sequential numbers (ordinal numbers) of the parameters of a resource: inputs (operands)=1 and 2, result=3.
programming goal: X := (A + B) * (C + D).
available resource types: ADD, MULT.
   Expanded notation (each step individually):
s (ADD)
s (ADD)
s (MULT)
p (A => 1.1)
p (B => 1.2)
p (C => 2.1)
p (D => 2.2)
y (1)
y (2)
l (1.3) => 3.1)
l (2.3 => 3.2)
r (1,2)
y (3)
a (3.3 => X)
r (3)
   Abbreviated notation:
s (ADD, ADD, MULT)
p (A => 1.1, B => 1.2, C => 2.1, D => 2.2)
y (1, 2)
l (1.3 => 3.1, 2.3 => 3.2)
r (1, 2)
y (3)
a (3.3 => X)
r (3)
   As data flow diagram (concatenation):
s (ADD, ADD, MULT)
c (1.3 => 3.1, 2.3 => 3.2)
p (A => 1.1, B => 1.2, C => 2.1, D => 2.2)
y (1, 2, 3)—begin of processing in the concatenated resources
a (3.3 => X)
r (1, 2, 3)

The y-operator is not needed when the resources support the input concatenation.

In order to carry out the method in practice, the operators must be present in stored form as machine code. There are several alternatives of machine codes:
operators as byte code (variable length);
fixedly formatted machine instructions that correspond to the operators of the present invention (1 instruction=1 operator);
instructions that initiate very basic operations (for example, information transport); the functions of the operators according to the invention are emulated with sequences of corresponding instructions (compare conventional microprogram control);
control words that contain individual control bits as well as immediate value fields, address fields, and control fields; such control words serve primarily for supplying, activating etc. a large number (optionally all) resources at once with parameters (compare conventional machines with long instruction words (VLIW));
instructions that are similar to the machine instructions of conventional architectures;
conversion of the operators according to the invention as sequences of conventional machine instructions or corresponding function calls (compiling).

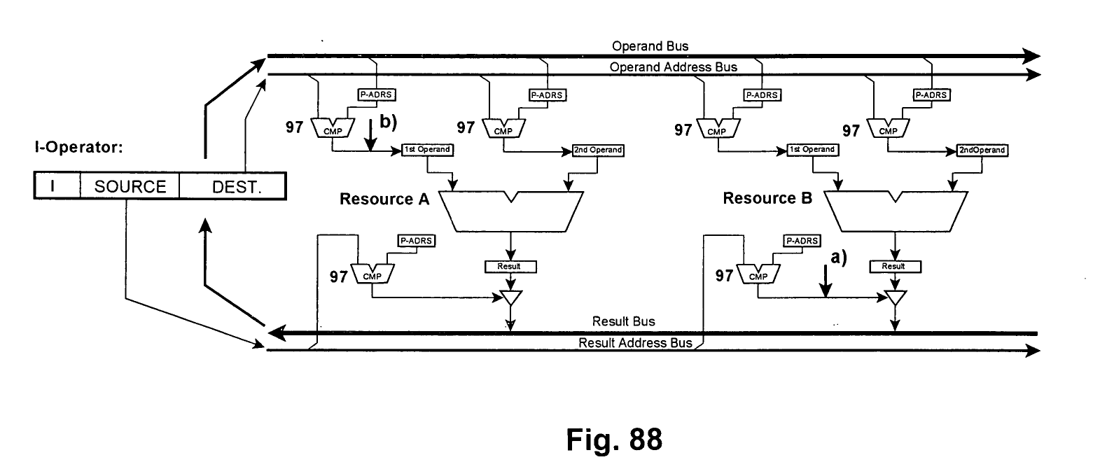

Various examples are described infra in connection with FIGS. 88, 90 and 102 to 105 as well as Tables 5 to 24.

The method has the following characteristic advantages:
Essentially, a random number of resources can be addressed (no limitation of the number of resources, as is the case, for example, in so-called VLIW architectures).
The allocation and release of resources can be program-controlled in great detail; it is possible to configure based on the available resources for each current processing task ad hoc a type of virtual special machine and to release it again in the end.
Once such structures are configured, the program-caused administration overhead is significantly reduced in comparison to conventional machines (no building and release of stack frames, no storing and rereading of intermediate values).
In contrast to conventional operating instructions, the operation selection (s-operator) is separate from the operation initiation (y-operator). Each resource knows thus from the beginning for which purpose the transferred parameters are to be used. This can be utilized optionally for optimizing the hardware. The initiation information is typically shorter than the selection information. This is advantageous (code shortening) when same functions are to be initiated again and again or when many functions are to be initiated at once. For a given instruction length, more functions can be initiated at once in comparison to conventional methods. For example, one of the best-known architectures for high-performance processors has instruction words of a length of 128 bits that contain three instructions. Accordingly, up to three operations can be initiated at once. A modification according to the invention of this format could provide, for example, an operating code of 8 bits. In y-operators, the remaining 120 bits are therefore available for initiating functions. Depending on the configuration of the instruction format, the following can be initiated, for example:
   when each resource has assigned 1 bit: up to 120 processing operations;
   when the resource address is 6 bits: up to 20 processing operations;
   when the resource address is 12 bits: up to 10 processing operations.

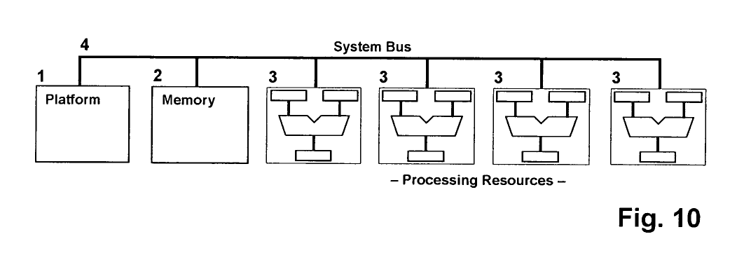

With the aid of FIGS. 10 to 13 the principal structures of devices for performing the method according to the invention will be explained in more detail. Such devices contain memory means, processing circuits, and control circuits. These devices are considered in the context of the present invention as resources. The way the individual resources are implemented is essentially inconsequential. In order to perform the respective processing tasks, the resources are to be selected in sequential steps, to be supplied with parameters, to be activated and to be released again. These operations are controlled by stored instructions (the machine code). The method, by means of corresponding programs, can be executed in conventional computing devices (computers, processors). The advantages however will be fully effective only when the hardware is matched all the way through to the method of the present invention. Corresponding systems comprise:
platform arrangements,
processing resources,
memory means and I-O devices.

Elementary configurations are similar to conventional general-purpose computers. FIG. 10 shows such a system. Platform 1, memory means 2, and processing resources 3 are connected with one another by a system bus (universal bus) 4. Additional I-O devices of any kind can be connected to the system bus 4. In contrast to conventional general-purpose computers, the processing resources 3 however are not limited to a single operation unit or a few processing units.

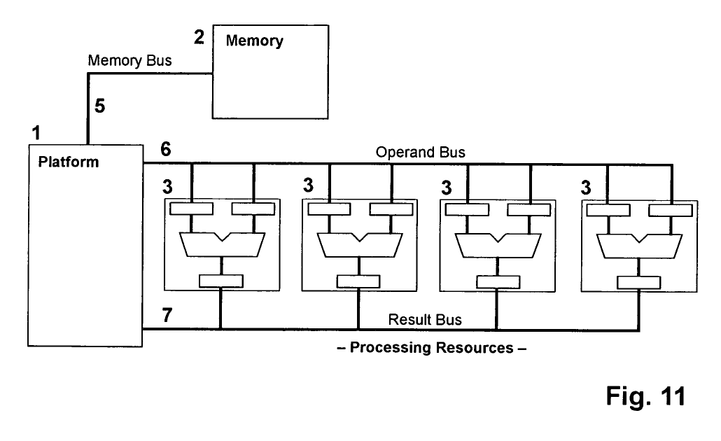

In a modified configuration according to FIG. 11, the memory means 2 are connected to the platform 1. The system bus 4 is comprised of several bus systems, for example, a memory bus 5, an operand bus 6, and a result bus 7.

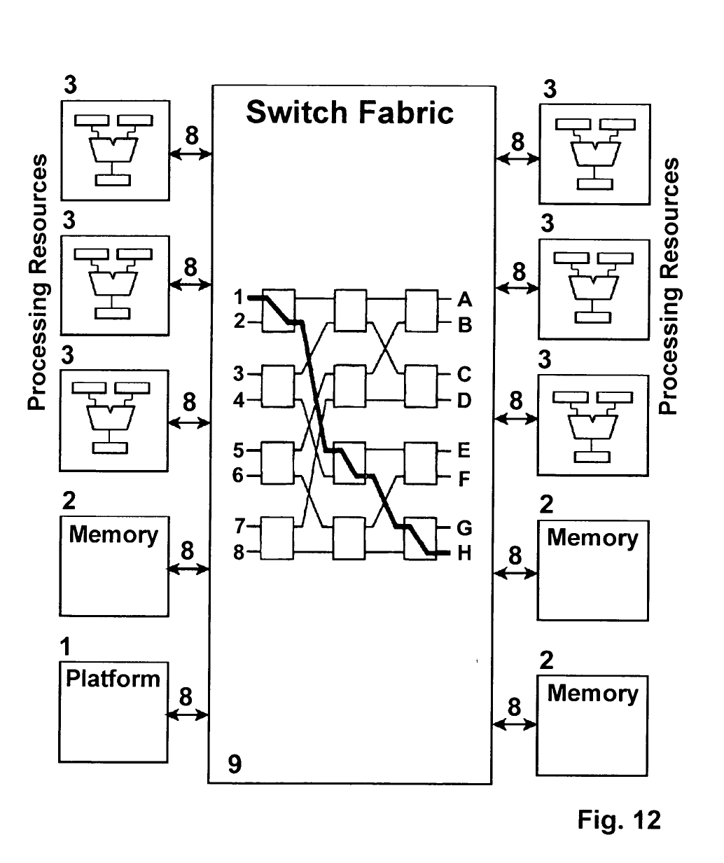

Conventional bus systems have the disadvantage that at one time only one information transfer can be carried out. FIG. 12 illustrates an alternative: fast point-to-point connections 8 that are connected by switch fabric or switching hubs 9. Point-to-point high-speed interfaces with data rates of several Gbits per second and short latencies are known in the art. Switching hubs enable to connect devices with one another randomly. In this way, many independent information transfers can be carried out simultaneously.

Smaller systems can be controlled centrally. The platform 1 controls in this connection all memory access operations and information transports. Only the y-operators are carried out autonomously in the processing resources 3. The concatenation is emulated by the platform. Such machines can be configured, for example, on the basis of bus systems to which are connected all processing resources 3 as slaves (destinations).

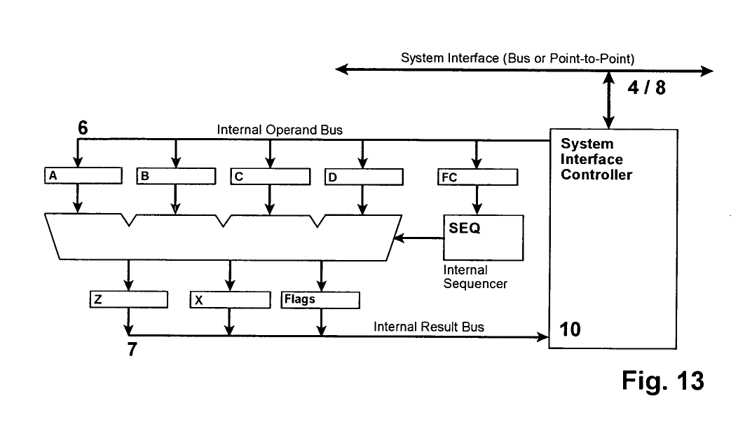

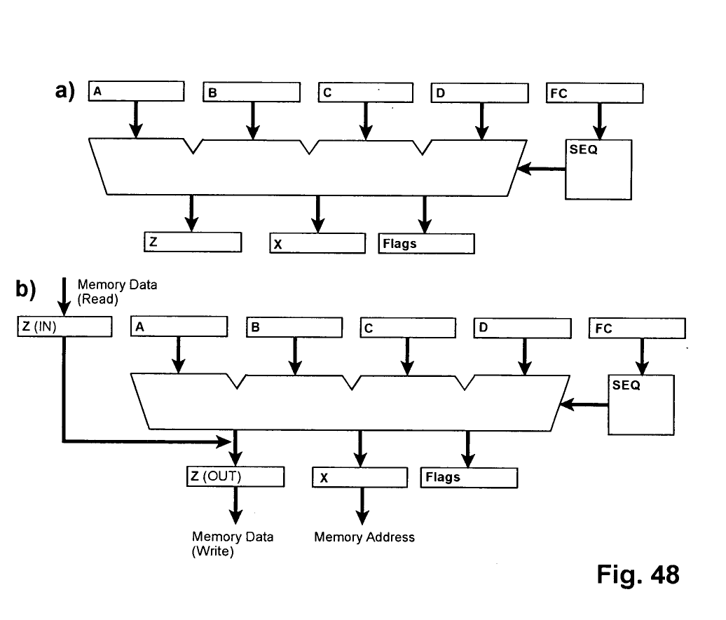

High-performance systems require an autonomous control of the memory access functions and concatenations functions. The platform 1 and the processing resources 3 are to be provided with corresponding connect control circuits and to be connected to one another by universal multimaster bus systems 4, switching hubs 9 or the like. FIG. 13 shows a processing resource 3 whose memory means are connected by operand bus 6 and a result bus 7 to the system interface controller 10 that, in turn, is connected to a multimaster bus system 4 or a corresponding point-to-point interface 8. The processing resource described here will be explained in more detail with the aid of FIG. 48 and Table 2. Suitable bus systems and interfaces are known in the art. For example, reference is being had to industrial standards PCI, HyperTransport and PCI Express. Corresponding interface controllers are available as complete circuit designs and therefore must not be explained in detail in this connection.

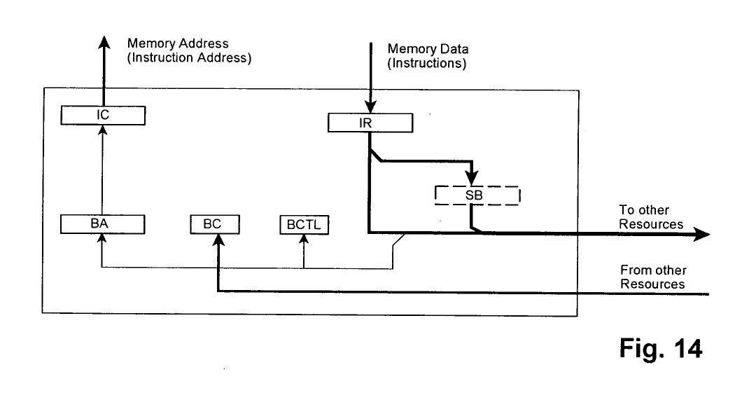

Based on FIGS. 14 to 30, variants of the configuration of platforms and systems will be explained in the following. The platform comprises the resources that are mandatorily required in order to initiate and maintain operation of the system. Platform arrangements serve for executing the respective machine code. The machine code is comprised of instructions that directly correspond to the operators according to the invention or that enable the emulation of the function of the operators. There are various possibilities for configuring a platform:
utilization of a conventional processor,
implementation as a microprogram-controlled device,
implementation as a collection of elementary resources,
building a platform from general-purpose processing resources with initially fixed connections (after power-on or reset).

Accordingly, the functions of the platform can be controlled by:
1) conventional machine instructions,
2) microinstructions or control words,
3) elementary machine instructions, for example, load, save, branch, subroutine call, return, interrupt control,
4) machine instructions that initiate the functions of the operators according to the invention,
5) any combination of 1) to 4).

Systems according to the invention can comprise several platforms.

Complex resources can be built from more simple ones (recursion), be it by appropriate connections (concatenation), be it by program-controlled utilization with an appropriate number of sequential processing steps. In this context, the resources are identified by ordinal numbers:
ordinal number 0: the resources of the platform;
ordinal number 1: the resources that are directly addressed by the platform;
ordinal number 2: resources that are built from resources of the ordinal numbers 0 and 1;
ordinal number 3: resources that are built from resources of the ordinal numbers 0, 1, 2 etc.

This corresponds in conventional computer architectures to the following:
ordinal number 0: general principles of operation (instruction fetch, addressing data, subroutine call, branching etc.);
ordinal number 1: processing instructions (basic machine operations);
ordinal number 2: basic system functions, subroutine libraries, etc.

Moreover, it is sometimes expedient to differentiate resources that are busy with processing tasks from resources that are busy with administration and support of other resources. For this purpose, the term level is used. Resources that carry out processing tasks belong to the level 1; resources that administer resources of level 1 are designated as level 2 etc. Within each level, there can be resources of ordinal numbers 0, 1, 2 etc.

All programming tasks must be converted in the end to the utilization of resources of the ordinal numbers 0 and 1. This can be performed during run time or compile time.
A. Conversion at run time. The program structure according to the programming task remains intact. The resources required for the sequential program steps are requested, utilized and released again. Each function or operation (formulated in an appropriate programming language) corresponds to a subroutine, each function call corresponds to a call of the respective subroutine. When a subroutine is called, it requests in turn resources, supplies them with parameters, initiates the execution of the processing operations etc. When returning to the calling program, the required resources are released again. Relative to the typical configuration of run time systems of conventional programming languages, each function call initiates that a stack frame is built and released. In this connection, the local variables are present only temporarily. They must be provided anew for each call and are lost upon return.
B. Conversion at compile time. The program development system (for example, a compiler) converts the programming goal completely into resources of the ordinal numbers 0 and 1. In the extreme, all resources are requested at once even those that are required for performing functions (subroutines). They remain assigned during the entire run time of the program. A function call is limited to the transports of the operands, activation of the resources, and retrieval of the results. If it is possible to concatenate resources with another, it is often sufficient to only enter the parameters. All other operations are then carried out essentially automatically, i.e., without any intervention of the platform (the sequences are autonomously controlled by the processing resources). In this connection, building and releasing stack frames is no longer needed. When translating this into a conventional application, a processing model is provided in which the stack frames of all function calls are pre-built at the beginning. All local variables (in the resources) thus become practically global variables that can be reached easily and are always accessible.

The circuit means of the platform must be addressed by the program. For this purpose, the following alternatives are provided:
A. By means of elementary instructions or u-operators that correspond to conventional machine instructions. Typical functions: loading of address registers, branching, subroutine call, return, interrupt control. In the extreme, the platform is a conventional general-purpose computer (for example, a microprocessor) that organizes and coordinates the operation of the actual processing resources.
B. The devices of the platform are resources of the ordinal number zero. They are addressed, like all other resources, by operators.

In the following, the second alternative will be described preferably.

Simple platforms can only read instructions. All other functions are to be provided by the processing resources. For example, when data are to be retrieved from a memory area, it is necessary to request corresponding resources for this purpose. Such platforms are not able to support all operators according to the invention.

FIG. 14 shows a simple platform that comprises an instruction counter IC, a branch address register BA, a branch condition register BC, a branch control register BCTL, an instruction register IR, as well as, if needed, additional state buffers SB. The instruction counter IC and the instruction register IR act in a conventional way (as in any conventional general-purpose computer) in order to address the sequential instructions as well as to read the addressed instructions and to make them available for subsequent decoding.

The configuration of the instruction register IR depends on the instruction formats, respectively. When all instructions are of the same length, (for example, 16 bits), the instruction register is designed such that it can receive a complete instruction.

When instructions of different length are present (this refers to e.g. byte codes), the instruction register IR can be designed such that it is able to receive the longest instruction that occurs. The instruction counter IC and the memory interface for reading instructions must be able to transport the instructions of different length into the instruction register IR by means of several sequential accesses. Corresponding circuits are used in many conventional general-purpose computers. Therefore, they must not be explained in detail in this connection.

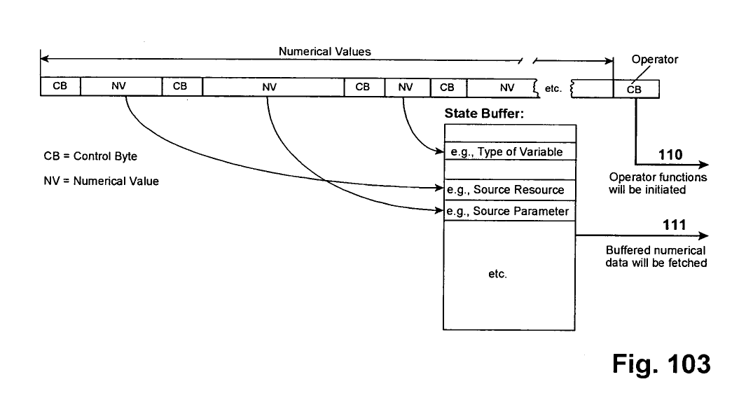

An intermediate solution resides in that instructions of a single length are used and information that cannot be included in such instructions are distributed onto several instructions. This will be explained infra in more detail in connection with examples (inter alia with the aid of FIG. 103 and Tables 14 to 30). FIG. 14 illustrates the expansion of the hardware by state buffers SB that are arranged downstream of the instruction counter IR and are required for implementing these examples. In simple embodiments the state buffers SB are buffer registers. As many buffer registers as required are provided (for example, three or four). They are loaded with special instructions (or u-operators). The signal lines that are required for control and parameter supply of the resources are arranged downstream of the instruction register IR as well as of the state buffers SB (or the buffer registers).

The platform has three own parameters that can be loaded with p-operators, with I-operators, or by concatenation. The branch address is entered into the branch address register BA, the branch condition into the branch control register BCTL. As a third parameter, the actual branch condition is transported into the branch condition register BC, in particular by the processing resource whose result is to decide the further processing sequence. The branch condition register BC is accessible through l-operators or by concatenation so that the processing resources are able to initiate a branch by supplying the actual condition bits. The registers BA and BCTL can be loaded in simple platforms (as shown in FIG. 14) only with immediate values from the instruction register IR (direct entry of branch address and branch condition). In platforms that are developed further these registers also are accessible by the operators or by concatenation. Accordingly, it is possible to work with computed branch addresses and conditions.

Branch conditions are special results that are generated by appropriate resources. The simplest form corresponds to conventional flag bits. Moreover, any special function is conceivable. For example, a processing resource could be provided that adds numbers and upon overflow causes the branch to an appropriate overflow handler.

A branch resource provides an instruction counter content. Branching means in this context application of the y-operator to the branch resource. Aside from the platform, other resources can be used as branch resources also.

A typical branch sequence:

| | |
|---|---|
| p (address => BA, condition => BCTL) | entering address and condition |
| . . . | |
| . . . | additional operators |
| l (result from processing resource => | actual condition is transferred |
| BC) | |

When the actual condition corresponds to the entered condition, a branch is initiated; the branch address BA is transported into the instruction counter IC.

A branch may be initiated: 1) instantly at the time an actual condition is received; or 2) by means of a corresponding y-operator (see the following example).

The first embodiment eliminates the y-operator but requires a strict sequential processing sequence (the next operator, respectively, may become active only once the preceding operator has been carried out completely). In this way, it is ensured that the branch is triggered immediately after receiving the actual condition without processing of other operators having been started in the meantime.

The second embodiment makes it possible that additional operators are executed between receiving the condition and initiating the branch. A similar principle is provided in some of the known high-performance processors. A typical configuration resides in that after the branch instruction first the immediately following instruction is carried out so that the gap in the instruction pipeline that results mandatorily as a result of the branch can be filled with useful work. This type of delay (delayed branching) is however rigid and, for example, is limited to a single subsequent instruction. By utilizing the y-operator for initiating the actual branching, it is possible instead to carry out any number of additional instructions between the decision in regard to the branching direction and the actual branching.

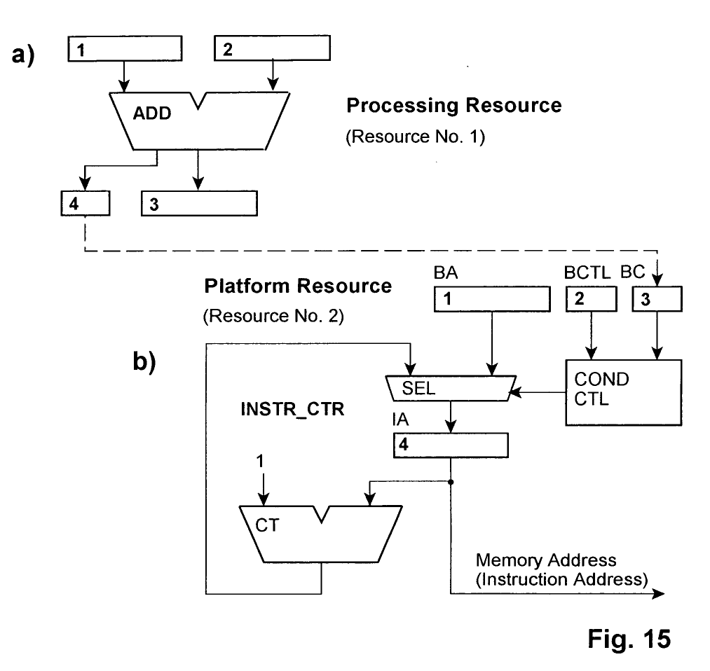

With the aid of FIG. 15, a simple conditioned branching will be illustrated by means of an example. The programming task is as follows:

C := A + B

if CARRY-OUT then goto OUT_OF_RANGE

The resources are:
1. processing resource ADD: a conventional adder (or an ALU); provides based on parameters 1, 2 the sum 3 as well as the flag bits 4;
2. branching resource INSTR_CTR: the instruction counter, comprised of the instruction address register IA and a counter network CT that increases the register contents by one; the sequential numbers of the parameters: 1—branch address; 2—branch condition; 3—condition bits to be evaluated; 4—result=address of next instruction; COND CTL=condition control; normal situation: address increment through counter network CT; branch situation: adopting the branch address 1.

The sequence is as follows:

| s (ADD, INSTR_CTR) | |
|---|---|
| p (A => 1.1, B => 1.2, OUT_OF_RANGE => 2.1, | |
| CARYY_OUT => 2.2) | |
| y (1) | -- adding |
| a (1.3 => C) | -- assign result |
| l (1.4 => 2.3) | -- flag bits to condition bits |
| y (2) | -- branching |

Alternative (concatenation):

| s (ADD, INSTR_CTR) | |
|---|---|
| p (A => 1.1, B => 1.2, OUT_OF_RANGE => 2.1, | |
| CARYY_OUT => 2.2) | |
| c (1.4 => 2.3) | -- flag bits to condition bits |
| y (1) | |
| a (1.3 => C) | -- assign result |
| y (2) | -- branching (may be performed only after |
| | result has been assigned) |

Branching causes particular problems in devices that operate with instruction pipelining because branching causes interruption of the instruction flow in the pipeline and requires a new start. In order to attenuate the loss of speed caused by this, conventionally complex measures are required. Two principles are employed in combination:
A. Branch prediction: when the instruction pipeline intercepts a branch instruction, it carries out instruction fetching first in the direction that is presumed to be the most probable one. A new start in the pipeline is only required when this prediction is not met.
B. Branch target buffering: The instructions addressed as branch targets are inserted into a special buffer memory (branch target cache memory) so that they are accessible, if needed, at once (without renewed memory access) and can pass on the fastest possible path into the instruction pipeline.

Usually, this is an autonomously controlled trial and error procedure where conflicts are to be recognized and solved. The control and monitoring circuits are correspondingly complex. In a system according to the invention however the branch preparation and buffering can be controlled completely by the program. Complex control circuits are not required (the corresponding circuit area could be used, for example, for larger buffers).

In the arrangement of FIG. 15, the branch address can be provided early enough (before the actual branching) so that it becomes possible to timely provide the instructions to be branched to (branch targets).

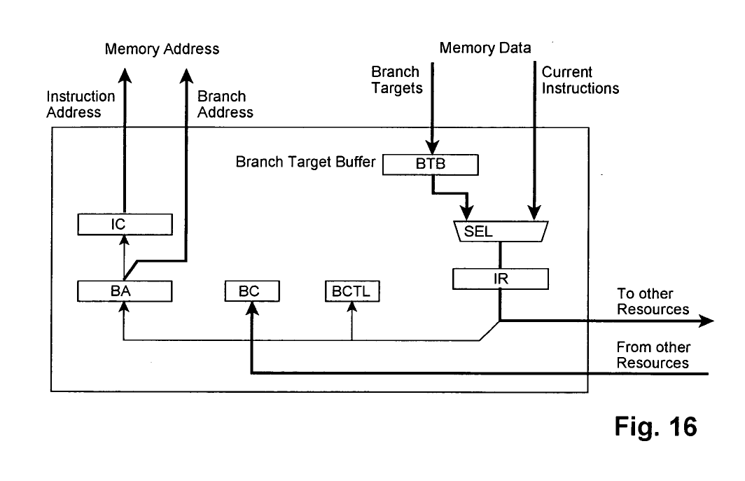

FIG. 16 shows a platform according to FIG. 15 that has been expanded by a branch target buffer BTB. The branch target buffer BTB is connected to the memory data input and is connected upstream of the instruction register IR by means of a selector. By means of the branch address the memory is accessed in order to load speculatively the corresponding instruction (the branch target) into the branch target buffer BTB. When the branch becomes active, the content of the branch target buffer BTB is transferred into the instruction register IR.

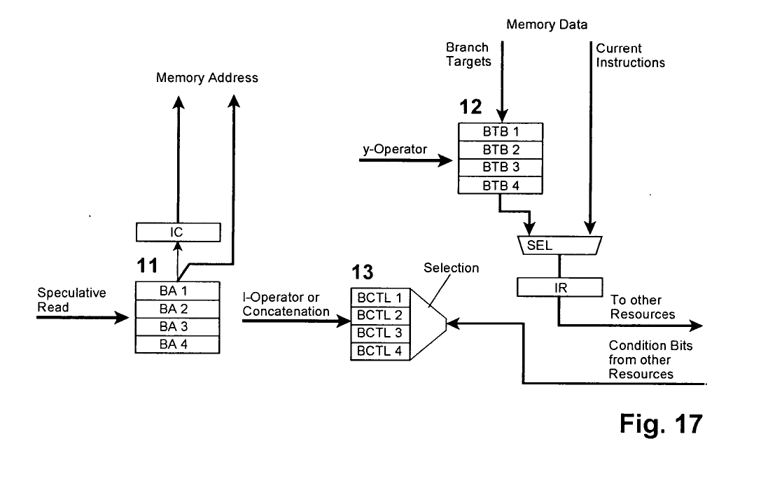

The principle can be expanded to several branch targets. FIG. 17 shows the essential modifications relative to FIG. 16. Provided are: a branch address buffer 11, a branch target buffer 12, and a branch condition buffer 13. The branch addresses are loaded into the branch address buffer 11, the corresponding branch conditions into the branch condition buffer 13 (for example, by means of p-operators). According to the addresses in the branch address buffer 11, the respective first instructions of the branch targets are retrieved from the memory and loaded into the branch target buffer 12. This can be initiated automatically by the platform preferably when no other access operations are to be performed. This speculative fetching of instructions is prior art technology. It is provided in high-performance processors that are available on the market and must therefore not be explained in detail. A simplification results when the instructions that are potential branch targets are input directly, i.e. by program control, into the branch target buffer 12, for example, by p-operators.

Conditions that are signaled by the processing resources (l-operators or concatenation) concern the branch condition buffer 13 (there is no general branch condition register BC but one branch condition parameter for each entry). The processing resources do not transfer their condition signals to the general branch condition register but to the branch condition parameter of the respective buffer entry. If the respective condition is satisfied, the corresponding entry of the branch target buffer 12 is activated. This entry is either transported immediately or after initiation of a corresponding y-operator into the instruction register IR. Accordingly, the corresponding instruction address is transferred from the branch address buffer 11 into the instruction counter IC. As a further development of the arrangement of FIG. 17, certain condition signals of the processing resources can be used in order to directly address entries in the branch address buffer 11 and in the branch target buffer 12. In this way, branching to one of several branch targets can be initiated. A platform configured in this way can support the following branching types:
A. Conventional branching. For each such branch an entry into the buffer memories 11, 12, 13 is required. The branch condition is entered in the branch condition buffer 13. The respective processing resource sends its condition to the corresponding entry. When the sent condition corresponds to the entered one, the corresponding branch is activated.
B. Conditioned multiway branches. Several entries are used in order to branch in several directions as a function of certain conditions. For example, for an arithmetic comparison of numbers, the following conditions can result: <, <=, =, =>, >=. Accordingly, five entries can be allocated in order to support a multiway branching according to the respective result. For this purpose, in the branch condition buffer 13 a special mode of operation must be set.
C. Unconditioned multiway branches. Several entries are used for branching without condition evaluation. In this connection, the condition signals received from the processing resources are directly used as selection addresses (for example, with three condition bits one of 8 subsequent instructions can be selected).

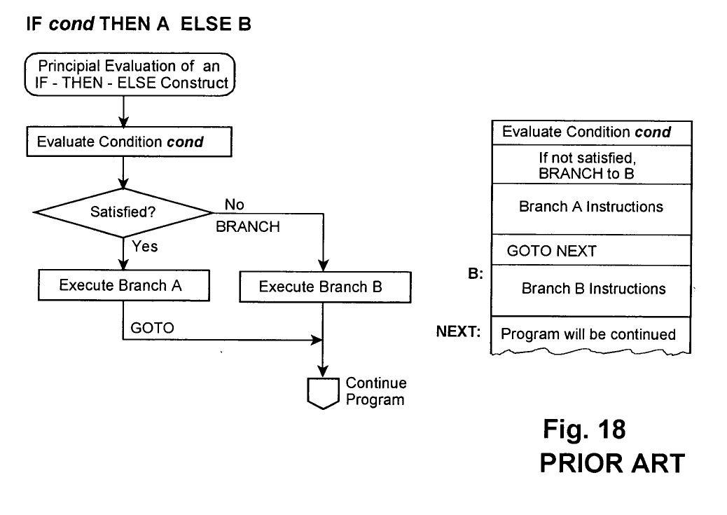

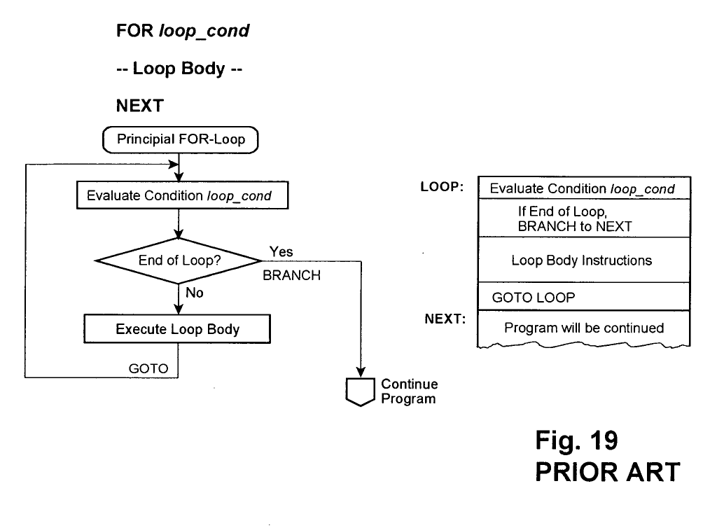

FIGS. 18 and 19 illustrate how many branches are required in order to support conventional programming constructs; in particular, FIG. 18 shows this by means of the conditional statement IF . . . THEN . . . ELSE and FIG. 19 by means of a FOR loop. The elementary conditional statement (FIG. 18) as well as the program loop (FIG. 19) require only two branches, respectively: a conditioned one (BRANCH) and an unconditioned one (GOTO). Accordingly, buffer devices (for example, similar to FIG. 17) should be designed for at least two branches. In this way, it is possible to prepare conditional statements and loops in such a way that in the individual passes the branches no longer must be newly set up (e.g., by means of p-operators) but must only be initiated (y-operators or concatenation).

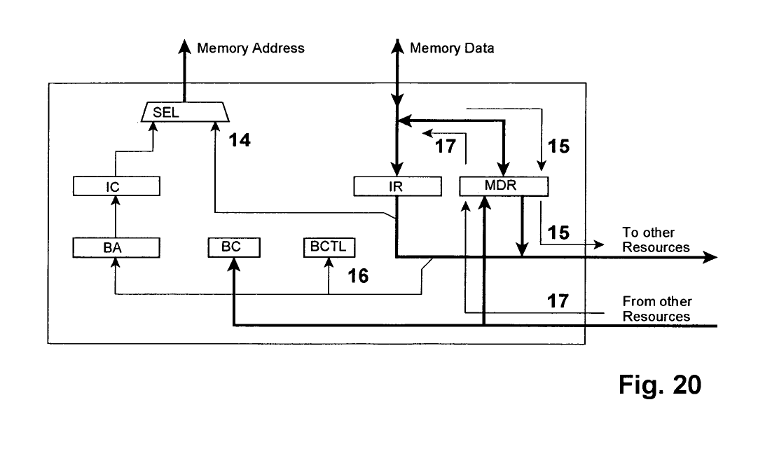

With the aid of FIGS. 20 to 24 some modified platform structures will be explained. In this connection, for reasons of simplification, means for accelerating branches are not illustrated.

For expanding the platform, basically a compromise between platform configuration and resource configuration is to be found. For example, a platform will be designed on a FPGA circuit to be only so complex as required for the respective application. In order to support all operators, it must be possible to address parameters in the memory and to call subroutines. FIG. 20 illustrates a platform that is modified based on the arrangement of FIG. 16; this platform supports parameter access operations with addresses that are contained as immediate values in the corresponding instructions (absolute addressing). The memory address lines are connected for this purpose to a selector that is connected to the instruction counter IC and to parts of the instruction register IR. The memory data lines are configured as bidirectional data bus and are connected to the instruction register IR as well as to the memory data register MDR. The supported parameter access operations are characterized by the following signal flows:
14: addressing of a parameter in the memory (p-operator and a-operator),
15: reading of memory contents into the memory data register MDR; the read data are transmitted to the processing resources (p-operator);
16: loading the branch address register BA and branch control register BCTL (parameters of the platform resource),
17: writing data that are supplied by the processing resources into the memory data register MDR and farther into the connected memory (a-operator).

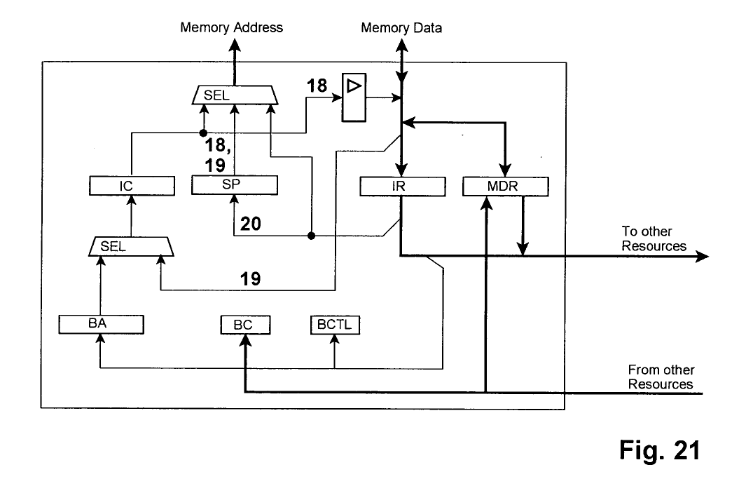

FIG. 21 shows a modified platform that supports (in addition to absolute addressing of parameters) also subroutine call and return. The circuit means shown in FIG. 20 have been expanded by a stack pointer register SP and a selector between instruction counter IC and branch address register BA whose second input is connected to the stack pointer SP. The selector arranged upstream of the branch address lines is additionally connected to the stack pointer SP. The instruction counter IC can be connected to the memory data lines (for example, according to the tri-state principle). The stack pointer SP is configured as is known in the art as a forward/backward counter. This is the generally known stack mechanism for recovery of the return address during subroutine call. The following signal flows result:
18: Subroutine call. This stack pointer content is reduced by one (predecrement) so that the stack pointer SP points to the next free position within the stack. The stack pointer SP is used for addressing the memory, the instruction counter IC is connected to the memory data lines. A write access thus has the effect that the actual instruction counter content is saved into the memory (the instruction counter points to the subsequent instruction).
19: Return. The stack pointer SP is used for addressing the memory. A read access takes place. The read memory content (the return address) is transferred through the selector to the instruction counter IC. Subsequently, the stack pointer content is increased by one (postincrement) so that the stack pointer again points to the uppermost occupied position in the stack.
20: The stack pointer SP is a resource like any other and can be loaded with any immediate value (p-operator).

In many applications, it is advantageous when the platform supports those types of addressing that are typical for run time systems of the conventional programming languages:.
relative addressing according to the principle base+displacement,
availability of several base registers,
stack accessible by relative addressing,
stack organization based on stack frames.

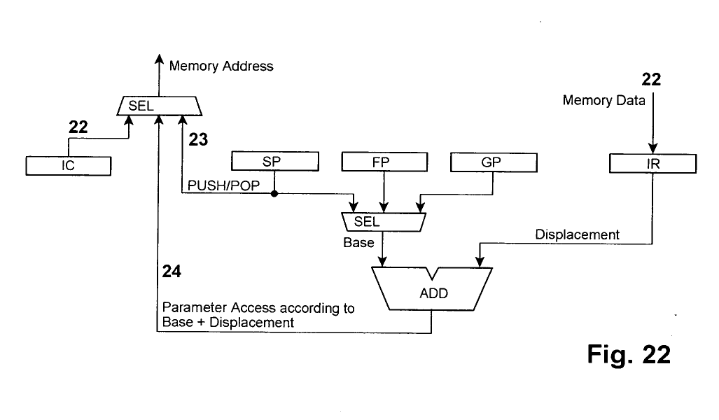

FIG. 22 shows an expansion of the memory addressing that supports accessing according to the principle base+displacement. In addition to the stack pointer SP, a frame pointer FP and a global pointer GP are provided. These three address registers can be used as base address registers. The following memory access types result:
22: Instruction fetch. Address from instruction counter IC, data into the instruction register IR.
23: Stack access (PUSH/POP). Address from stack pointer SP with increment or decrement of the stack pointer content (predecrement/postincrement). PUSH: write access with data from instruction counter IC (subroutine call, interruption) or memory data register MDR (data pushed onto stack). Predecrement. POP: read access. Data into the instruction counter IC (return) or into the memory data register MDR (data popped from stack). Postincrement.
24: Reading or writing parameters. Selection of one of the base registers SP, FP, GP to which the displacement from the instruction register IR is added. Displacements are, for example, contained in p-operators and a-operators (the data flows of read and write operations have been shown in FIG. 20).

The utilization of the stack pointer SP and the frame pointer FP corresponds to standard practice (compare the known principles of function call in C-programs, Pascal programs etc.). The global pointer GP can be used in order to hold any other base addresses (for global variables, for access to the heap etc.). The arrangement of FIG. 22 can be supplemented by additional base address registers.

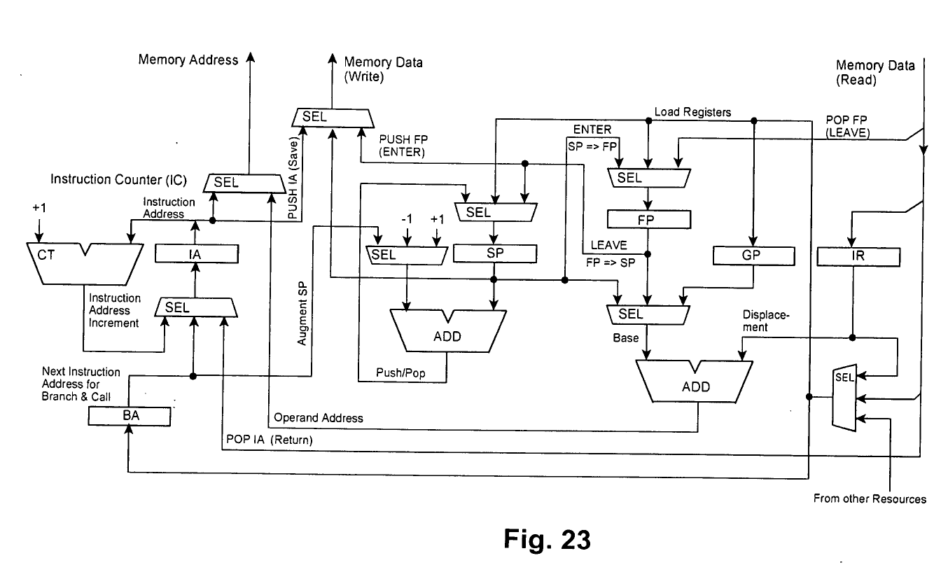

FIG. 23 provides an overview of the addressing hardware of a platform that supports the typical sequences of subroutine call and return (such sequences are disclosed in detail in textbooks of system programming). The instruction counter IC is illustrated with its parts: instruction address register IA, counter network CT, selector (compare also FIG. 15). The subroutine call is a branch (branch address in register BA) that is preceded by pushing the next instruction address (=return address) onto the stack. During the subsequent ENTER sequence (entry into the subroutine) the contents of the frame pointer FP is pushed onto the stack (PUSH FP). Subsequently, the actual stack pointer becomes the new frame pointer (SP => FP). If needed, subsequently a stack area for the local variables is initialized. For this purpose, the stack pointer content is correspondingly modified (augment SP). The length of the stack area is taken from the branch address register BA. The branch address register BA has been loaded with the corresponding value beforehand, for example, by means of a p-operator. (This is a minimalist solution. Alternatively, for such tasks additional registers can be provided.) During the leave sequence (leaving the subroutine), the stack pointer is loaded with the content of the frame pointer (FP => SP). Subsequently, the old frame pointer is removed from the stack (POP FP). The return instruction loads the instruction address register IA with the return address from the stack (POP IA). The various address registers (BA, SP, FP, GP) can be loaded from the memory, from the processing resources or with an immediate value from the instruction register.

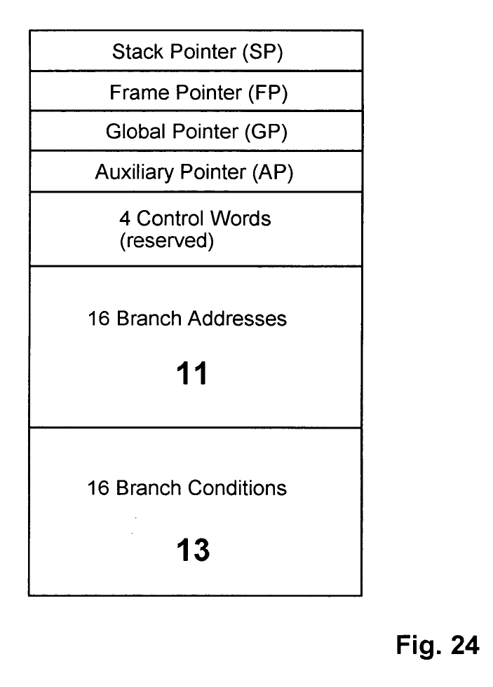

FIG. 24 shows an overview of the parameters of a small platform that is however already useable in practical applications. This Figure illustrates how many parameter addresses are to be reserved for a platform that can be envisioned as a combination of the afore described configurations. In comparison to FIGS. 22 and 23, an additional base register was added (auxiliary pointer AP). Four additional parameters are provided as control words in order to be able to set different operating modes. This concerns inter alia the branch control and the interrupt initiation. The utilization of control words and control registers for controlling operating modes is known in the art and is provided in many processor architectures. The branch address buffer 11 and the branch condition buffer 13 are designed for a total of 16 branches (including subroutine calls). This is sufficient for supporting, for example, a loop with several IF-THEN-ELSE constructs and function calls. Platforms for high-performance systems require significantly larger branch buffers. As a whole, 40 parameter addresses are required. This corresponds to an address length of 6 bits.

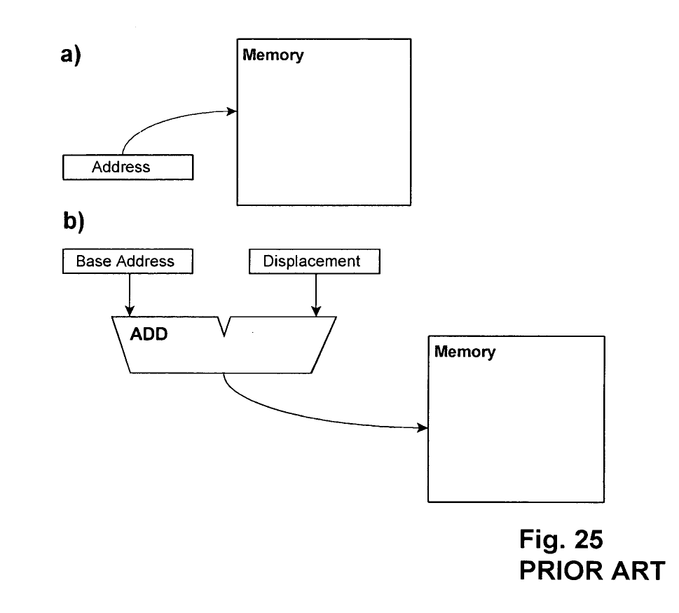

In the following, with the aid of FIGS. 25 to 28 typical principles of memory addressing will be explained. Memory cells contain instructions or data. There is no limitation with regard to access principles. Typical access principles are: a) different types of addressing, or b) associative selection.

FIG. 25 illustrates two types of conventional addressing. In the simplest case (FIG. 25a), a single address (absolute address) is used in order to select the corresponding memory position. The information addressed in this way however must be stored always at the same memory position. It is not possible to store programs and data areas at different positions according to the actual memory allocation. In order to ensure this so-called relocatability, provisions for address calculation are introduced. One of the simplest principles resides in that to a base address a displacement or offset is added (FIG. 25b). The base address points to the beginning of the respective memory area. The displacement points to the individual memory position. The base address is set by the system software. The displacement or offset refers to the beginning of the memory area (its first memory position has the displacement 0, the second memory position has the displacement 1, etc.).

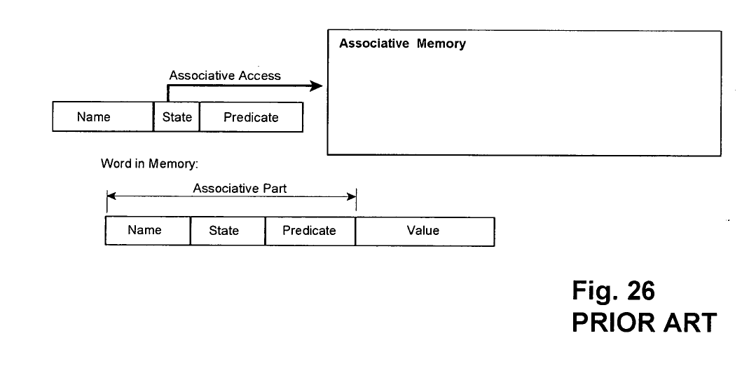

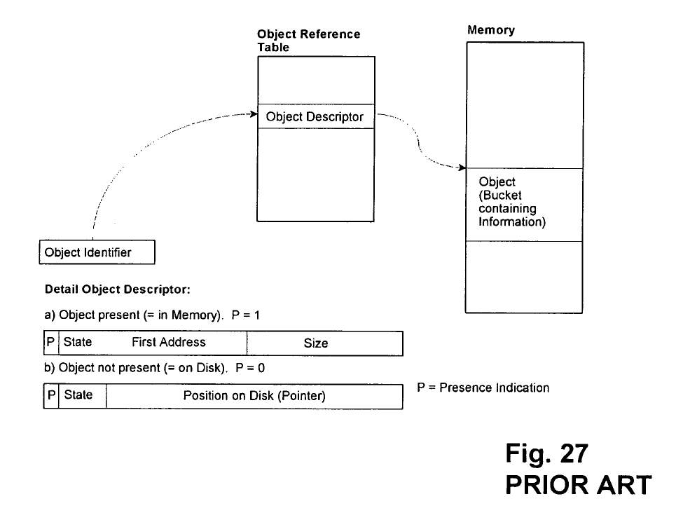

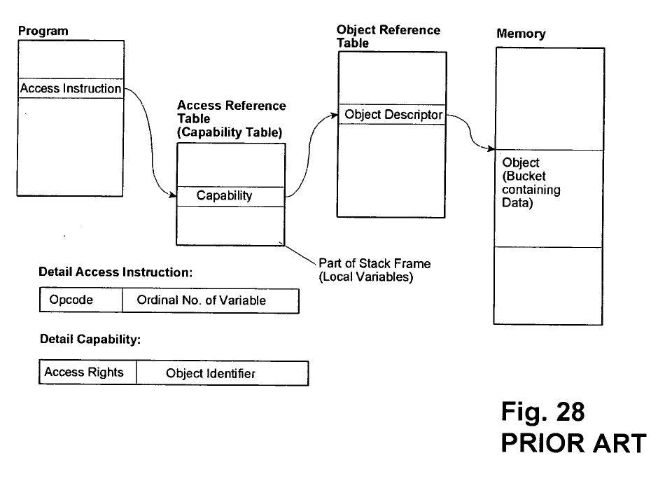

By associative selection, the stored information can be called by its symbolic name, no matter at which location in the memory it is located. The symbolic name is supplemented typically by status information and predicate information that characterize the validity of the corresponding value (FIG. 26). Associative memories are complex because for each value also the symbolic name as well as the status information and predicate information must be stored (associative portion). In order to keep the access time short, each memory position requires a comparator that compares the contents of the associative portion with the actual access information. Therefore, associative memories are used only for special purposes (cache memories, TLBs, reordering buffers in superscalar machines etc.). The storing of data and programs according to the prior art is based primarily on addressable memories. Such memories have typically a fixed access width e.g. 8, 16, 32 or 64 bits. According to the prior art, the byte (eight bits) is the smallest addressable unit (byte addressing). The data structures of the applications however vary greatly. In order to convert the application data addressing into hardware addressing, there are two principles that differ in regard to when the address translation or address calculation takes place:
A. At compile time. The most common and simplest solution. At run time, typically the principle base+displacement is used (compare FIG. 25) in order to ensure the relocatability of program areas and data areas. All other forms of address calculation are programmed (this is done by the compiler when utilizing higher programming languages).
B. At run time. In the extreme, the compiler only converts the mnemonic names into sequential numbers (ordinal numbers). The actual address translation takes place when the program is executed. This configuration has some advantages. It is possible to assign access rights etc. for each individual variable, to relocate the variables at run time as desired, etc. With a corresponding configuration, it is also possible to utilize a single program for different data types (for example, to work alternatingly with 32-bit binary numbers and 64-bit floating point numbers) without this requiring new compilation (object-oriented access). The expenditure with regard to hardware is however higher and the access times are longer because the actual memory access is typically preceded by a table lookup (FIGS. 27, 28).

When utilizing an object-oriented access method, programs and data areas are viewed as objects. Objects are containers for information that are each treated as a unit. Each object has a name or, during run time, a binary coded ordinal number that selects the respective object from the set of all objects. The programs do not relate to addresses but to objects. The objects are described by object descriptors which are combined in object reference tables:
1) when the object is present in the system memory, the descriptor has a pointer pointing to the corresponding memory area (initial address+length),
2) when the object is not present, the descriptor has positional information for the mass storage.

The object administration ensures that the respective object is moved into the system memory or is moved to the mass storage.

FIG. 27 illustrates a one-level access method. The variables in the program identify directly the respective object. This corresponds to a program environment with exclusively global variables.

FIG. 28 shows a two-level access method (capability based addressing). The variables in the program are pointers into a capability table that contains the object identifiers with which the object table can be referenced. This principle isolates the object set from the programs and enables a fine-grain assignment of protective rights (precise down to the individual variable). The capability table corresponds practically to a stack frame with object identifiers of the current local variables.

There are several possibilities to implement the memory means 2 in devices that can perform the method according to the invention:
a) as a conventional common system memory (v. Neumann architecture);
b) as a conventional memory for programs and data (Harvard architecture);
c) as a combination of different dedicated (programs, data, resource administration, emulation etc.);
d) as part of the resource pool.

It is possible to implement the memory devices as resources and to administer the memory areas like resources. Such memory areas can be requested by s-operators and can be released by r-operators. In this way, the method according to the invention can also be applied to memory management. Typical advantages are:
The requirements with regard to memory capacity, utilization of the memory devices etc. are derived directly from the programming purpose. They are therefore more precise than information that can be determined by conventional operating systems only by observing the access behavior.
All details can be controlled by the program.
It is possible to configure specific resources that support the memory management.
It is practical to administer arrangements in which memory devices and processing devices are coupled directly (for example, the so-called resource cells to be explained in the following). The direct interaction of memory and processing hardware results in reduced latency (because not as many pipeline stages must be passed) and a higher data throughput (because a plurality of resource cells can operate simultaneously and independent of one another).

Memory resources can perform reading and writing operations. The operands of a writing operation are address information and data to be written. When writing is performed, there are no results. The operands of a reading operation are address information. The read data are returned as results. Additional results can be, for example, hit indications in a virtual memory address space (compare the function of the conventional virtual memories) or error messages (such results can also occur in the case of writing access).

In computer architectures that correspond to the prior art, large universally usable memory arrays are preferred that are accessible via a unified linear address space. This is the basic principle also for the following description.

For accessing memory devices, special access resources can be provided. For example, they can be implemented in accordance with any of the principles explained in connection with FIGS. 25 to 28. This principles are part of the general knowledge of a person skilled in the art so that a more detailed description of the different variants not necessary. The further examples concern therefore primarily the conventional principles (address conversion at compile time, address computation according to the principle base+displacement). Such access resources have already been described supra, as part of the platform, supra inter alia with the aid of FIG. 23. A system according to the invention can also contain more advanced access resources that are configured, for example, according to FIG. 28. Several such resources can be provided and they can be implemented as special-purpose hardware (with address calculation units, dedicated memories for object reference tables etc.). Moreover, they are fully program-controlled. In this way, the performance weaknesses of the known solutions (for example, according to FIG. 28) can be avoided.

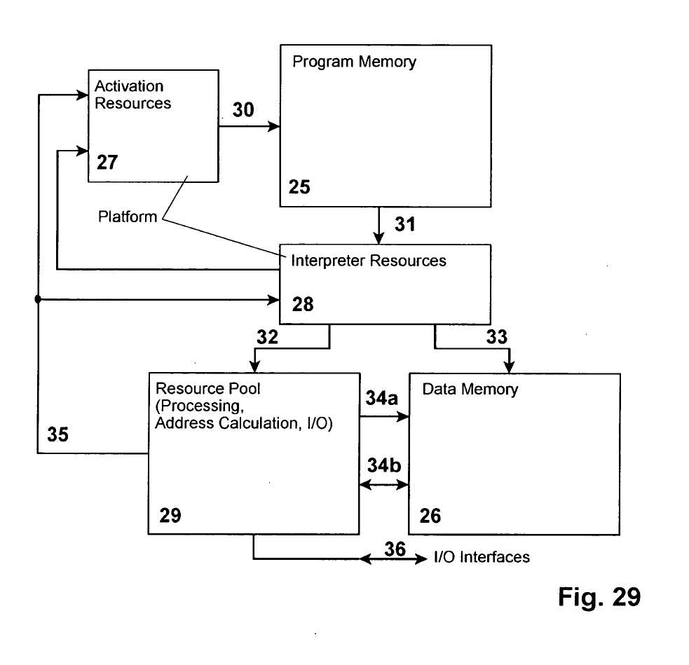

The access resources can be arranged outside of the respective memory device or can be incorporated therein. The number and configuration of the memory devices are essentially arbitrary. It is possible to provide a single memory (v. Neumann architecture) that contains all information (instructions and data) as well as several memory devices that are designed purpose-oriented based on memory capacity, access width, access method etc. (typical configuration of special purpose computers). FIG. 29 illustrates a system with two memory devices, a program memory 25, and a data memory 26 (Harvard architecture). The address inputs of the program memory 25 are connected to activation resources 27. Interpreter resources 28 are arranged downstream of the date outputs. The data memory 26 is connected to a processing resource pool 29. The following basic data paths and address paths or information flows are present:
30: call (addressing) of machine instructions by the activation resources 23;
31: supplying the control information (machine code) to the interpreter resources 24; here the instruction decoding takes place;
32: control of the processing resource pool 29 (by instructions that initiate the functions corresponding to the operators of the present invention);
33: addressing the data memory 22 by means of the operators (this concerns primary p-operators and a-operators);
34: data access by the processing resources 29 (34a: address, 34b: data);
35: condition signals of the processing resources 29 act on the activation resources 27 and interpreter resources 28;
36: the I-O interfaces are controlled by the processing resources 29.

Program memory 25 and data memory 26 can be combined (v. Neumann architecture). In the example of FIG. 29 the address paths 30, 33 and 34a are combined to an address bus and the data paths 31 and 34b to a data bus.

Input and output are realized either by certain address areas (memory mapped I-O) or by special resources (I-O ports, interface adapters, pulse pattern generators, clocks, etc.; compare the configuration of conventional microcontrollers).

An input resource can deliver results only but cannot receive any operand. It has, in the context of the system, no inputs (its inputs are excited from the exterior; they are therefore not loadable and also cannot be the destination of concatenation). An output resource can only receive operands but cannot deliver results; it has, in the context of the system, no outputs (its outputs are directed to the exterior; nothing can be fetched; also, they cannot be effective as a source of concatenation).

In simpler systems the activation resources 27 and the interpreter resources 28 correspond to an elementary platform structure as described supra inter alia in connection with FIG. 23. More advanced systems can have several and more efficient platforms (for example, platforms that can fetch and decode several machine instructions at once). Moreover, it is possible to also configure ad hoc the activation and interpreter resources from a corresponding resource pool according to the method of the present invention (for example, large branch buffers, arrangements for implementing the access method according to FIG. 28, associative memory arrays etc.). Elementary platform structures, for example, according to FIG. 23, then serve only for initialization and for configuration and administration purposes.

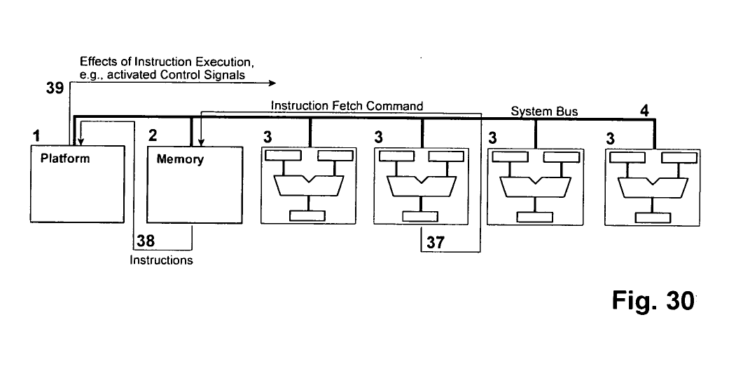

Resources that are provided as functional units for configuring platforms must be able to expressly request instruction access. For this purpose, a separate access command “instruction fetch” can be provided within the context of the respective signal protocols. FIG. 30 illustrates the signal flows of instruction fetching in a simple system according to FIG. 10. A corresponding access command acts as follows:
37: the corresponding resource 3 provides the instruction address and initiates the instruction fetch command;
38: the memory 2 carries out read access and provides the read data as instructions to the actual platform resource 1;
39: the platform resource 1 provides instruction decoding and triggers the instruction function.

A system that is embodied in this way can be employed, for example, as follows:
1) the platform initializes in the above described way the processing resources (primarily with s-operators, p-operators, and c-operators);
2) y-operators initiate the processing operations; this causes the further instruction fetching to be transferred to correspondingly initialized processing resources;
3) with the last instruction that is read by the platform itself, the platform is switched into a standby mode;
4) the processing resources are able to cause the platform to continue with instruction fetching, for example, by means of special continuation instruction or by activation of a platform resource (by y-operator or concatenation) that triggers the program continuation in the platform.

In systems that are more advanced the command “instruction fetch” is not only linked with the instruction address but also additionally to a resource address that identifies the platform resource to which the instructions are to be sent.

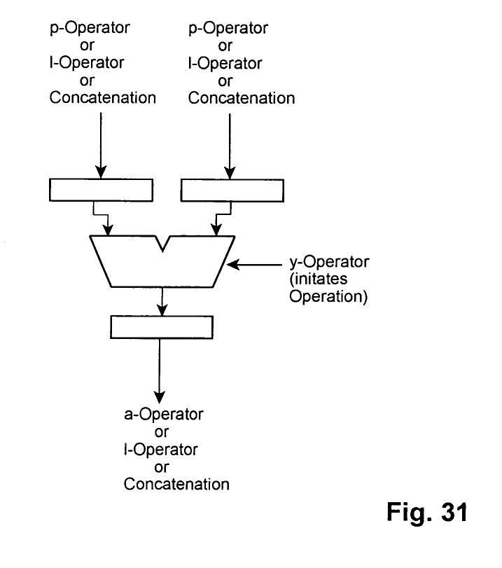

In the following, with the aid of FIGS. 31 to 33 configurations of typical processing resources will be explained in more detail. Processing resources are comprised of memory means for the parameters (operands and results) and of intermediate processing circuits. They differ from one another primarily in:
the number of operands and results,
the type of data structures (of the operands and results),
the number of executable operations (one or several),
the processing width (number of bits),
the type of parameter transfer (for example, by value or by reference),
the concatenation (included parameters, principles of the concatenation control),
the correlated processing states (stateless configuration or incorporation of parameters into the processing state or the program context),
the auxiliary functions (monitoring of value ranges, registration of utilization frequency etc. (instrumentation)).

FIG. 31 illustrates a simple resource that executes only a certain type of information processing operations (operation fixed, processing width (number of bits) fixed). The memory means for operands and results are typically implemented configured as registers. The operands are transferred as values, the results are stored as values. In very simple resources no concatenation is provided. Operators that can be used are: p, y, a, l.

When the parameter transfer is to be supported by reference, the corresponding address registers and access paths to the memory are to be provided. Circuits for addressing and data transport are incorporated into the processing resources or configured as separate resources (upstream or downstream). They are comprised of the actual addressing provisions and means for access control whose configuration is dependent on the respective memory interface (bus, switching hub or the like). Some devices have also buffer arrangements (register, FIFOs or the like) for buffering data to be transported.

Address provisions, inter alia, can be configured as follows:
as an address register,
as an address register with counter function (increment, decrement),
as an address calculation unit (for example, base+displacement),
as an iterator, for example, for the control variables in typical FOR loops.

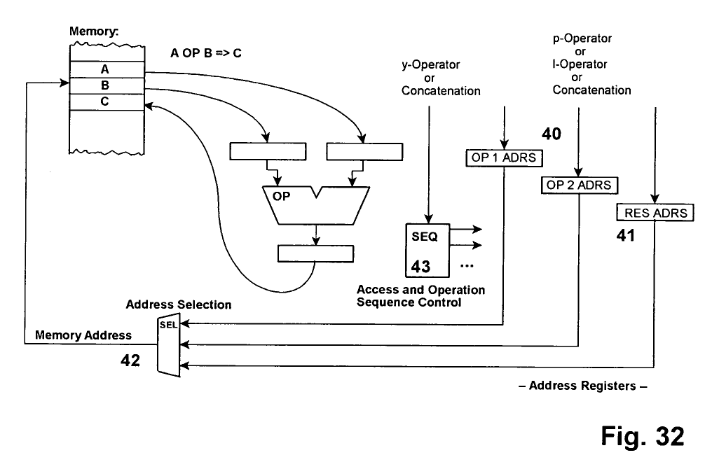

FIG. 32 illustrates a processing resource that is provided in addition to the operand registers and result registers with additional address registers 40, 41. The output of these address registers are connected to memory address lines 42. In FIG. 32, a selector is provided for this purpose; however, it is also possible to connect the outputs of the address registers 40, 41 to internal bus lines (compare FIG. 13). A sequence control circuitry (sequencer) 43 is provided in order to initiate memory access and processing operations. Such an arrangement functions as follows:
1) The operand addresses are written into the operand address registers 40, the result addresses are saved in the result address register 41 (p-operators or l-operators or concatenation).
2) The operation is initiated (by means of y-operator or as a result of concatenation at the input side).
3) The sequencer 43 is activated. It initiates initially two read access operations to the memory for which purpose the operand address registers 40 are connected to the memory address lines 42. The operands that have been read are entered into the operand registers upstream of the processing circuits. Subsequently, the computation of the result is triggered. When the result is formed, the sequencer 43 initiates write access to the memory and connects for this purpose the result address register 41 to the memory address lines 42.

An alternative configuration resides in that processing resources that are provided for value transfer have further resources that are arranged upstream or downstream and that execute the memory accesses (addressing resources). Elementary addressing resources have as parameters address information and data information. The address information is contained in the address register; the data information is in the data register. The address is an operand. When the addressing resource is to perform read access, the data information is a result; when write access is to be performed, the data information is a further operand.

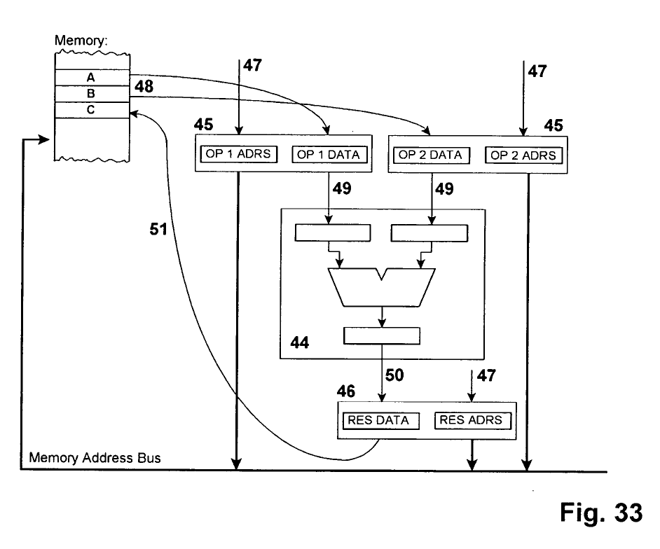

FIG. 33 shows a processing resource 44 that has arranged upstream thereof two addressing resources 45 for the operands and is connected at the output side to a further addressing resource 46 for the result. The connections between the resources 45, 44, 46 are typically no fixed connections but are formed temporarily by concatenation (c-operators). The result registers of the addressing resources 45 are concatenated with the operand registers of the processing resource 44. The result register of the processing resource 44 is concatenated with the data register of the addressing resource 45.

Such an arrangement operates as follows:
47: The addresses of the operands and of the results are entered into the address registers (OP 1 ADRS, OP 2 ADRS, RES ADRS) of the addressing resources 45 and 46 (p-operators or l-operators or concatenation).
48: The addressing resources 45 are activated (by y-operators or as a result of concatenation at the inputs). They carry out read accesses to the memory.
49: When the read data are received in the respective data registers (OP 1 DATA, OP 2 DATA) of the addressing resources 45, their concatenation with the operand registers of the processing resource 44 becomes active. The operand values are transferred and the processing sequence in the processing resource 44 is initiated (as a further effect of the concatenation).
50: When the processing resource 44 forms its result, the concatenation of the result registers with the data register (RES DATA) of the addressing resource 46 becomes active.
51: The addressing resource 46 initiates write access in order to transfer the data register contents into the memory.

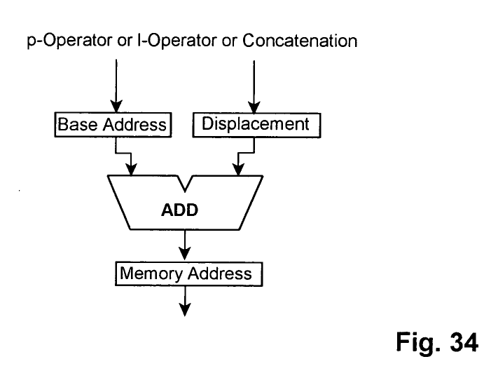

Based on FIGS. 34 to 39, in the following typical addressing provisions in processing resources will be explained in more detail. FIG. 34 shows an addressing circuit that acts as an address adder and forms a memory address according to the principle base+displacement. It depends on the configuration of the entire system whether this address addition is carried out in the processing or addressing resources or centrally on the platform (in the latter case the additional resources receive address parameters that have been computed beforehand by the platform). In a few applications it is even possible to operate with absolute addresses (calculated at the time of compilation); this concerns, for example, some embedded systems with ROM-resident programs.

It is advantageous to configure the addressing devices such that sequential accesses can take place without having to introduce the address parameters anew every time. For this purpose, the address registers (compare FIGS. 32 and 33) can be configured as address counters. After each access the address is incremented by one (or according to the respective access width) so that sequentially stored data can be accessed sequentially.

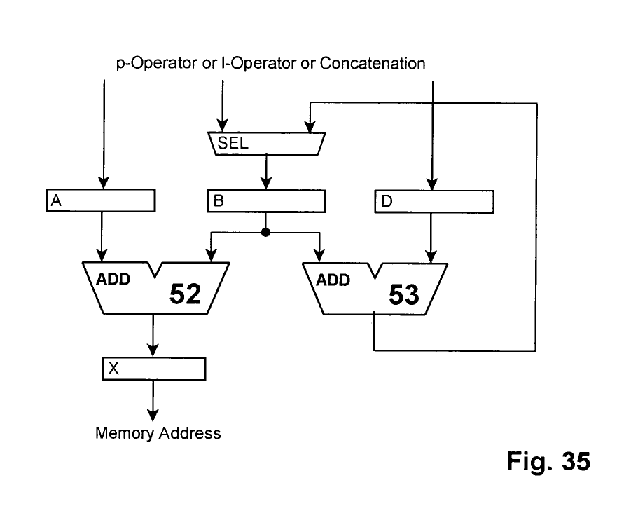

In the modification according to FIG. 35, the address increment is not “one” but adjustable as an additional parameter. The illustrated arrangement calculates the memory address based on base address A, a displacement B, and a distance value D. The base address register A and the displacement register B are connected to an adder 52 that is connected at the output side by means of an address register X to the memory address lines. The base address register A and the distance value register D have arranged downstream thereof a displacement adder 53 whose outputs are connected to the displacement register B. In this way, the displacement is modified after each access. The following calculations take place:
memory address := A + B
displacement B := B + D (autoincrement/autodecrement, depending on the sign of the distance value D).

Access example: a two-dimensional matrix of floating point numbers that are stored line by line:
a) access to sequential elements of a line: with D=1 (word addressing) or length of the floating point number in bytes (byte addressing),
b) access to sequential elements of a column: with D=column number (word addressing) or column number·length of floating point number in bytes (byte addressing); the respective value is to be set once before access operations.

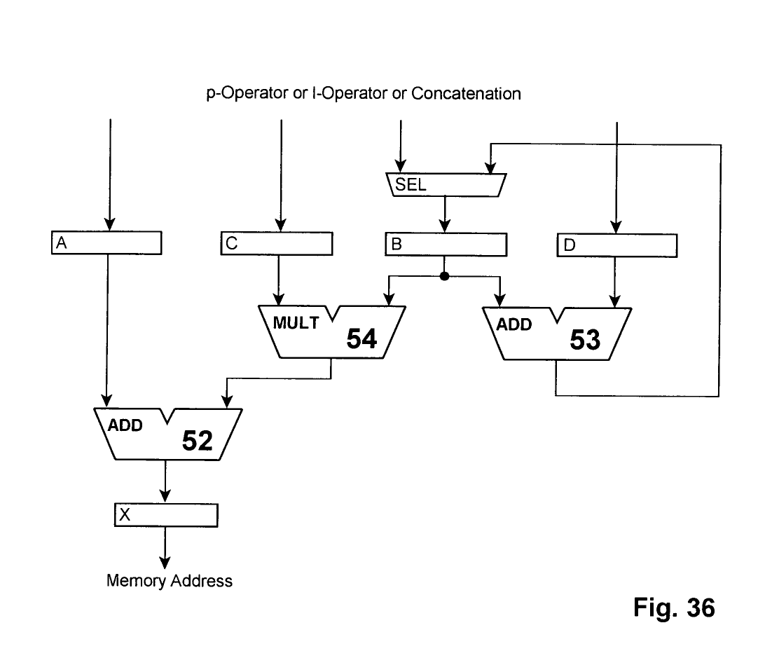

FIG. 36 illustrates a modification of the address circuit according to FIG. 35 that supports access to sequential data structures of the same length (length Z) based on an index value (=sequential numbers 0, 1, 2, 3 etc.). Base address in A, actual index in B, length of the data structure in C, distance value in D. Into the connection between address adder 52 and displacement register B a multiplier 54 is inserted having arranged upstream thereof a length register C. The multiplier 54 serves for calculating the displacement address of the n-th element (n=0, 1, 2, . . . ) of a one-dimensional array relative to the beginning of the array when the length of the individual field element=C. In most performance-critical application this length is 2 to the power of n with n being not very large (for example, the length is 2, 4, 8, 16 bytes). When the arrangement is designed to support only such access operations, the multiplier 54 can be a simple shift network (multiplication by a value 2ⁿ corresponds to shifting to the left by n bits).

Calculations
1. memory address := A + (B*C)
2. displacement B := B + D (autoincrement)

Access example: a two-dimensional matrix of floating point numbers stored line-wise. Byte addressing applies. The floating point numbers have a length of 8 bytes. Accordingly, C=8 is to be set.
a) access to sequential elements of a line: with D=1,
b) access to sequential elements of a row: with D=number of rows (this value is to be set once before access).

Many sequential accesses are performed in program loops. When performing program loops, there is the problem of recognizing when to exit the loop (loop termination). In general, the loop condition is queried by a conditional branch (compare FIG. 19). The usual loop constructs of conventional programming languages can be supported also by corresponding resources.

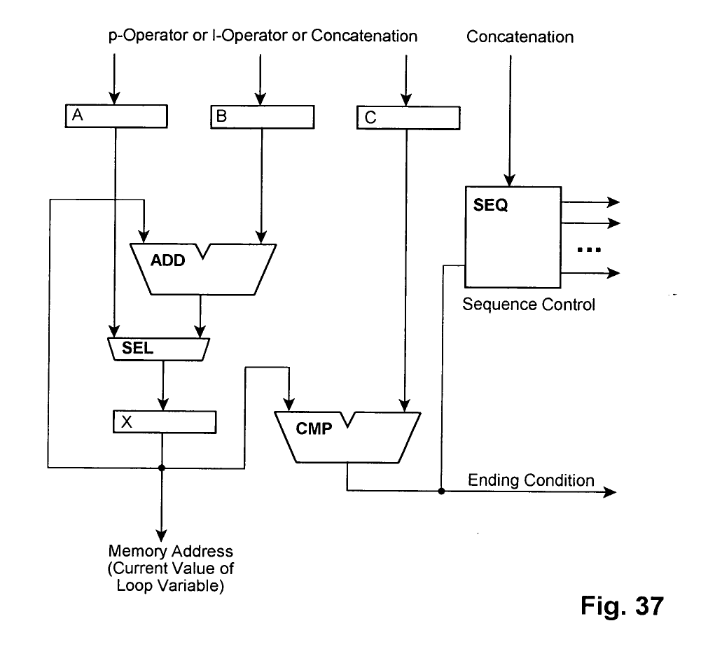

FIG. 37 illustrates a resource configuration (in the following referred to as iterator) for supporting typical FOR loops. Operands: initial value A, step width B, end value C. Results: the actual value of the control variable X (in the following loop value) as well as the ending condition (termination condition). The initial value register A and an adder ADD are connected by means of a selector upstream to the loop value register X; the adder ADD is connected to the step width register B and the loop value register X is returned to the adder ADD. Moreover, a comparator CMP is connected downstream to loop value register X. The comparator has arranged upstream thereof an end value register C. The comparator output provides the ending condition. The loop value register X can be used as a source of a memory address or the current control variable. The described arrangement supports loops of the type FOR X := A TO C STEP B. It can be used, for example, as follows:
concatenations are generated (c-operators), if necessary,
initial address, step width and end values are entered (p-operators, l-operators or concatenation),
the program loop is activated (by y-operator or as an effect of an input concatenation); the sequence control is activated; in the first step the contents of the initial value register A is transported through the selector into the loop value register X; in the following steps, the contents of the step width register B is added to the contents of the loop value register X;
the contents of the loop value register X is compared to the contents of the end value register C; the loop pass is repeated cyclically as long as C<X; when C=X, the last loop pass is completed and the ending condition becomes effective.

The arrangement according to FIG. 37 can be operated with a single pass or continuous passes:
A. Single pass: each y-operator or input concatenation (for example, from the sequence control to the iterator) initiates a loop pass. This causes the operators of the loop body to be carried out.
   loop start:
      y (operator)
      -- loop body --
      y (branch) -- continuation or return to the loop start.
B. Continuous passes: a y-operator or the input concatenation initiates passing of the entire loop. Upon continuation of the loop the output concatenation of the loop value register X becomes effective (conditional concatenation), and at the termination of the loop the ending condition becomes effective (for example, it can be concatenated to the platform). By means of the output concatenation of the loop value register X the iterator resource triggers the subsequent processing resources that carry out the functions of the loop body.

It is known that several loop passes can be replaced by corresponding multiple parallel executions of the operations of the loop body (loop unrolling). When the number of passes (1) is known from the beginning (at compile time) and (2) is not too great, this does not present any particular problem for a system configured according to the invention.

Example
FOR n = 1 TO 20
-- loop body --
NEXT N
   is processed in parallel (unrolled) in that the resource configuration required for implementing the loop body is requested 20 times and supplied correspondingly with parameters.

When not enough resources are available, parallel processing is possible only in stages.

Example: in the expression
FOR n = 1 TO 20
-- loop body --
NEXT n
   it is possible, for example, to support for parallel processing only four loop body functions (because the number of utilizable processing resources is limited correspondingly). For this purpose, the loop must be reconfigured:
FOR n = 1 TO 20 STEP 5
1st loop body | 2nd loop body | 3rd loop body | 4th loop body
NEXT n
   The resource configuration of the loop body is requested four times; the loop is executed in five passes.

When the number of loop passes is not known at the compiling time (example: FOR n = 1 TO x), this simple type of unrolling is not possible. One solution is that a certain number of processing resources are made available for parallel processing in general and that their utilization is controlled by correspondingly designed iterator resources and memory access resources.

The number of parallel-supported processing resources is referred to in the following as degree of parallelization P (P = 1: 1 resource, P = 2: 2 resources, etc.). The utilization is controlled usually by the compiler. It assigns, for example, to a certain loop four processing resources (P = 4) and corrects the step width accordingly:
FOR n = 1 TO x is changed to FOR n = 1 TO x STEP P.
   Example:
FOR n = 1 TO 14 is changed with P = 4 to FOR n = 1 TO 14 STEP 4.

Values for n (each processing resource takes care of one of these values):

in the first pass: 1, 2, 3, 4

in the second pass: 5, 6, 7, 8

in the third pass: 9, 10, 11, 12

in the fourth pass: 13, 14

It is apparent that in the last pass not all four processing resources are busy. In order to recognize the last pass, the actual value A is subtracted from the end value E: remainder value R=E−A. When the remainder value R is smaller than the degree of parallelization (R<P), the loop end has been reached. When R=0, exit from the loop takes place. When R>0, the last pass is carried out in which some processing resources are not busy.

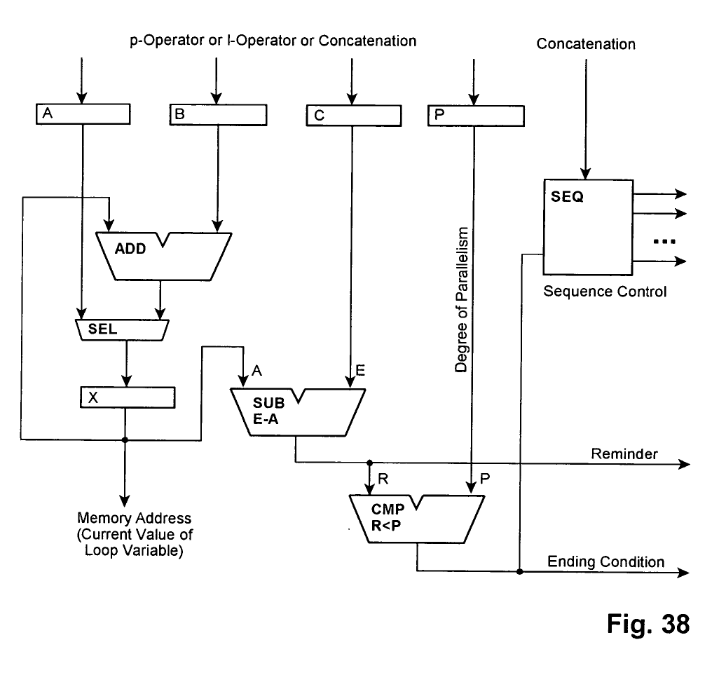

FIG. 38 shows an iterator resource that is modified relative to FIG. 37. In addition to the operand registers A, B, C illustrated in FIG. 37, an additional operand register P is provided. Its content indicates the degree of parallelization. Loop value register X and end value register C are connected to a subtractor that has arranged downstream thereof an arithmetic comparator whose second input is arranged downstream of the register P of the degree of parallelization. The following calculations take place:
the subtractor determines the actual remainder value = end value − loop value,
the arithmetic comparator recognizes the ending condition remainder value < degree of parallelization; if this condition is met, it is necessary to deactivate in the last pass some of the processing resources.

Because the activation and supply of the parallel-operating processing resources must be coordinated, it is expedient to arrange all respective processing resources downstream of a single memory access resource of a corresponding design. For example, a memory access resource has concatenated downstream thereof four identical processing resources. The memory access resource, like the entire memory subsystem, must be able to support the memory bandwidth that is required to supply the parallel-operating processing resources with data and to transport the results.

Example: when four resources with access width of 64 bits are connected, the memory accesses are carried out with an access width of 256 bits (or, for example, with 128 bits and twice the data rate). Data buffers that collect accesses with different width and different addresses and can convert them into accesses with greater widths are contained inter alia in modern high-performance processors and in bus control circuits (bridges, hubs). They correspond to the prior art and therefore must not be explained in detail.

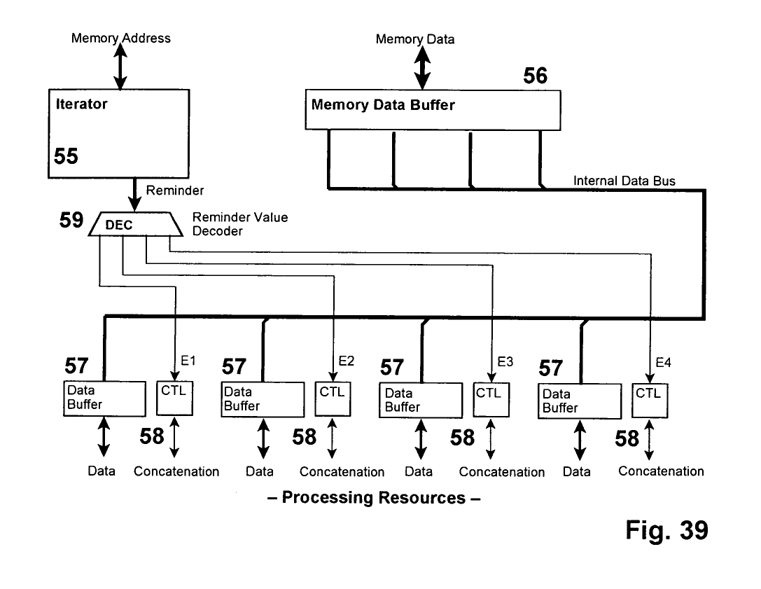

FIG. 39 illustrates a memory access resource that contains an iterator 55 according to FIG. 38. The iterator 55 provides the memory address. The memory interface comprises also the memory data buffer 56. The memory data buffer 56 is designed for a memory bandwidth which results from the memory bandwidth of the individual processing resource multiplied by the degree of parallelization. In the example, this bandwidth is ensured by a quadrupled access width (for the same data rate; for example, 256 bits for four processing resources with 64 bit data path). For each processing resource a data buffer 57 and a concatenation control 58 are assigned to the memory data buffer 56.

A concatenation process is triggered when data are available (reading) or to be retrieved (writing). A concatenation control 58 becomes effective only when its enable input (for example, E1) is active. The enable inputs E1 to E4 are excited by a remainder value decoder 59 that is connected downstream of the remainder value output of the iterator 55. The remainder value decoder 59 is a combinatorial circuit that generates the enable signals E1 to E4 for the concatenation controls 58 (Table 1). If the loop pass is not the last, all four concatenation controls 58 become active. In the last loop pass, the activation is based on the remainder value.

TABLE 1

| remainder value | E1 | E2 | E3 | E4 |
|---|---|---|---|---|
| 1 | 1 | 0 | 0 | 0 |
| 2 | 1 | 1 | 0 | 0 |
| 3 | 1 | 1 | 1 | 0 |
| >3 | 1 | 1 | 1 | 1 |

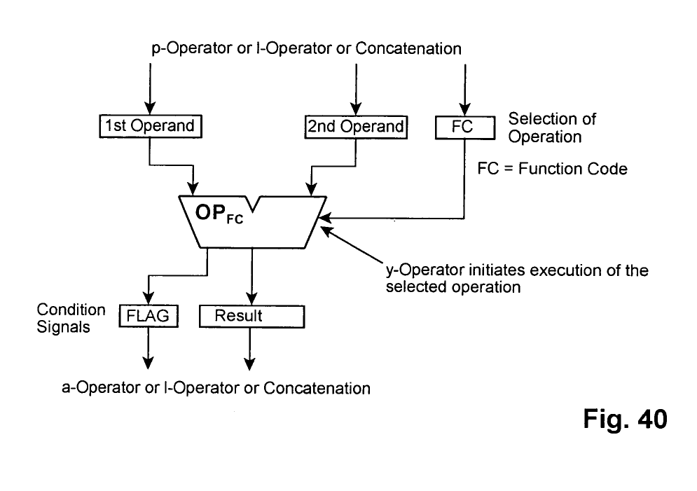

In the following, with the aid of FIGS. 40 to 48, further details of the configurations of typical processing resources will be explained in more detail. In this connection, the function selection and the control of the processing width (number of bits) will be explained. There are processing resources with fixed functions and processing resources that can perform one of several information processing operations. For function selection additional input parameters are provided. This enables also a function selection that depends on previous processing results (the operation to be performed, respectively, is computed by the upstream resources; is taken from tables; or the like). In this context, it is expedient to have a function code without effect (no operation, NOP). When such a function code is set, the resource does not change any of the parameters. The processing state (program context) remains intact. Output concatenations are not initiated. In this way, it is possible to circumvent the resource depending on the processing state (conditional operation).

FIG. 40 illustrates a simple processing resource that has a function code register FC as an additional input parameter. The following possibilities to set the resource to a certain function are available:
A. The function code is treated like a conventional parameter, i.e., can be loaded by p-operators, l-operators or concatenation. This mode of operation is advantageous when resource configurations are concerned that for the same structural configuration can be used for different data types (for example, a certain data flow diagram is built by concatenation and, as needed, is converted to processing of 16-bit binary numbers, 32-bit binary numbers, floating point numbers etc.).
B. There is a version of the y-operator that not only initiates the function but also introduces the corresponding function code.
C. The function code is set by the s-operator. This mode of operation decouples the formulation of the programming task from the technical configuration of the system. From the standpoint of the method according to the invention, each information processing operation corresponds to its own resource type. The programs request by means of s-operators all required resources. When the system has these resources actually available as hardware, they are assigned directly. When the system has universal resources, they are initialized by the s-operator for the required functions.

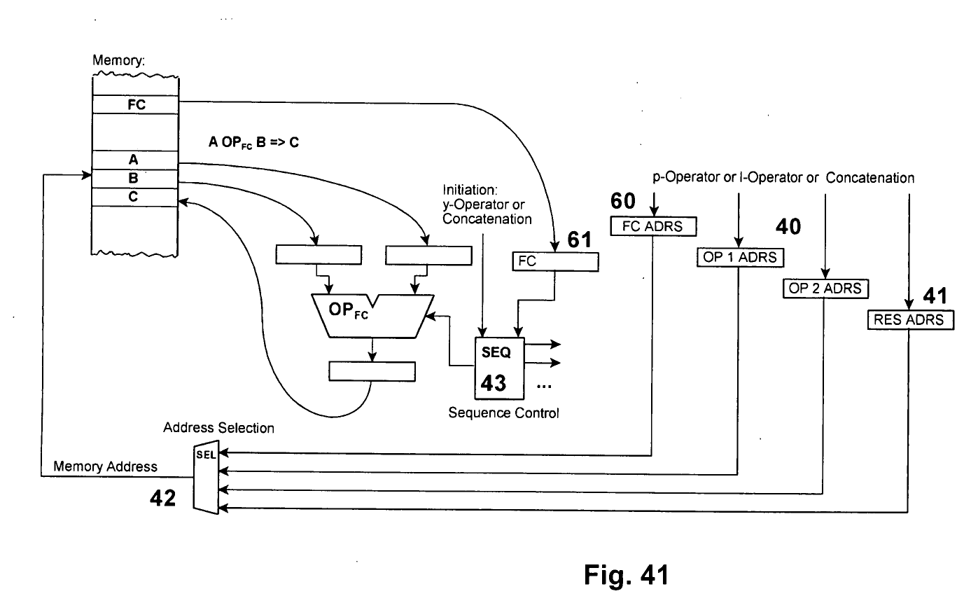

FIG. 41 shows a processing resource that is designed for parameter transfer by addressing (by reference). In addition to the address registers 40, 41 illustrated in FIG. 32, a function code address register (FC ADRS) 60 is provided. The sequence control 43 has a function code register (FC) 61 upstream thereof. Before activating the resource, the address of the function code must be transported to the function code address register (FC ADRS) 60 (p-operator, l-operator, concatenation). A function initiation (for example, by means of y-operator) has the effect that the sequence control (SEQ) 43 initiates first a memory access that enters the actual function code into the function code register (FC) 61.

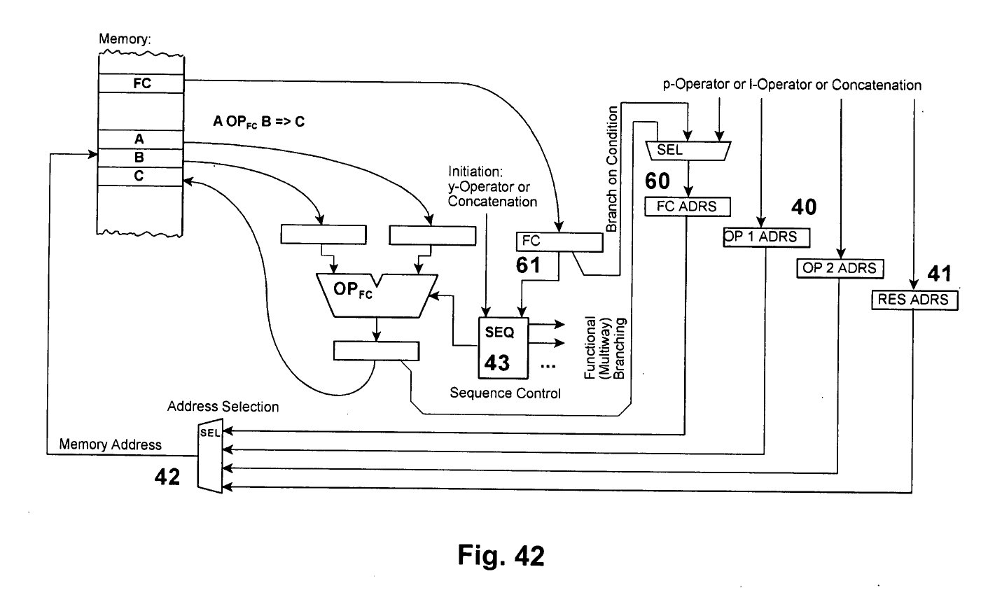

In modified resources of this type, the function code address register 60 is a counter. After performing a function, the sequence control 43 initiates further counting and retrieval of the next function code. In this way, operation sequences (i.e. program pieces) can be performed by the resource autonomously. Essentially, this is a program within a program. This autonomous function execution is terminated by function codes that are provided particularly for this purpose. In a further modification of such resources according to FIG. 42, the function code address register (FC ADRS) 60 is an instruction counter (as it is in conventional general-purpose computers) and is connected at its input side to parts of the function code register 61. This arrangement supports the execution of conditional branches. In some resources, a connection to parts of the result register is expedient also. In this way, it is possible to provide functional branches (multiway branches) depending on certain results.

The programmed sequence control within the processing resource is preferably a type of microprogram control based on an elementary instruction set. The configuration of microinstructions and simple machine instructions is within the general knowledge in the art. Detailed descriptions are therefore not required. This configuration can be used inter alia in order to perform complex functions by means of comparatively simple hardware, for example, resources are made available that compute trigonometric equations. Another utilization possibility, for example, is to assign to such resources the execution of elementary subroutines or innermost loops (i.e., subroutines that contain no additional subroutine calls and loops that contain no additional loop constructs).

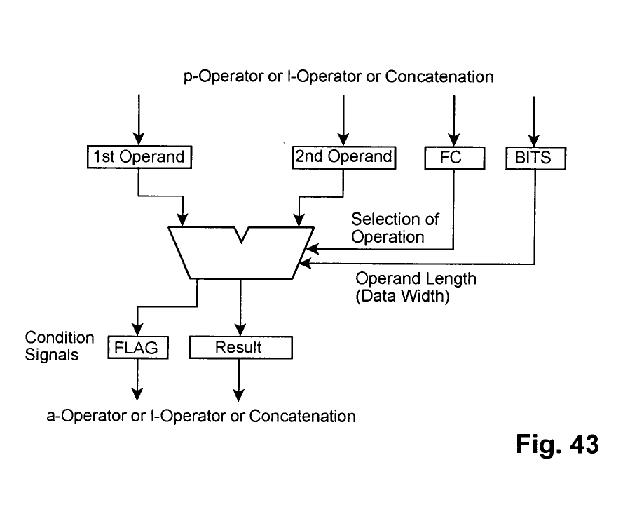

There are resources with fixed and with changeable processing width (number of bits). FIG. 43 illustrates a simple resource modified in comparison to FIG. 40 and provided with an additional processing width register (BITS). The processing width set therein is valid for all parameters. Processing widths and function codes are entered (compare explanations in regard to FIG. 40). Operands are processed only according to the entered width, results are provided only according to the entered width. The treatment of excess bit positions depends on the configuration of the resources and the platform (in regard to the memory).

Typical variants:
filling with zeroes (zero extension),
filling with the content of the highest-order bit position according to the current processing width (sign extension),
ignoring excess bits and inserting short operands right-aligned (the remaining content stays intact).

For the purpose of processing, the operands are typically extended to the maximum processing width of the processing circuit (zero extension, sign extension etc.). The details of operand extension for numerical and non-numerical elementary operations are within the general knowledge in the art.

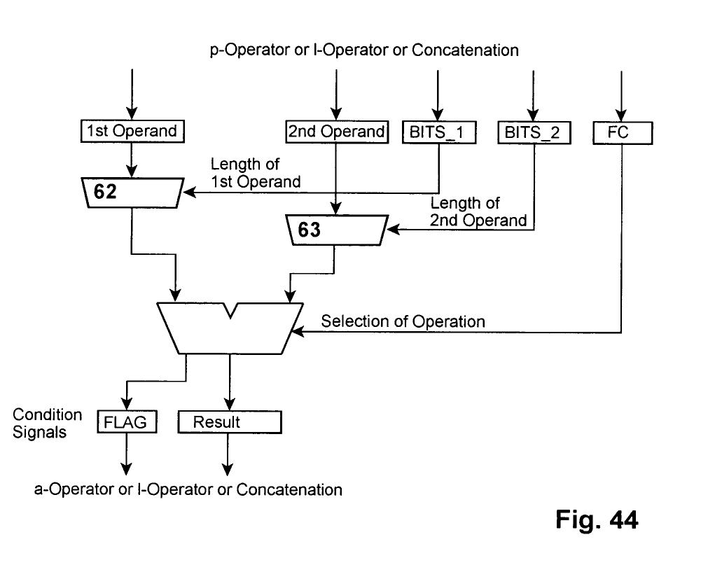

FIG. 44 shows a processing resource that makes it possible to individually set the width of different parameters. In the example, two processing width registers BITS_1, BITS_2 are provided that each have arranged downstream thereof operand extension circuits 62, 63. The operand extension circuits 62, 63 are inserted into the signal paths between the operand registers and the actual processing circuits. They act in such a way that they supply to the actual processing circuits operands that are extended to the respective maximum processing width.

Processing widths not only can be set but also have to be queried sometimes—the resources and the platform must know of how many valid bits the individual parameters are composed. For this purpose, inter alia the following principles can be used:
A. The actual access width is described in corresponding tables (such tables will be explained infra the aid of FIGS. 80 to 85). This general-purpose and not very complicated solution has the disadvantage that at run time a table lookup must be performed before carrying out a corresponding operand access in order to query the respective actual access width.
B. The machine code comprises information in regard to the access width. This solution is similar to the usual prior art configuration (there are separate instructions for transporting bytes, words etc.). For cost reasons, only a few access widths can be supported. Moreover, the respective processing width must be fixed at compile time; a dynamic switching (at run time) is not possible.
C. The memory means in the resources that indicate the processing width (processing width register, TAG bits) are designed to be queried. This information is transferred together with the data bits, respectively, or can be queried from other resources. For this purpose, interfaces between the resources (bus systems, point-to-point interfaces or the like) are appropriately supplemented.

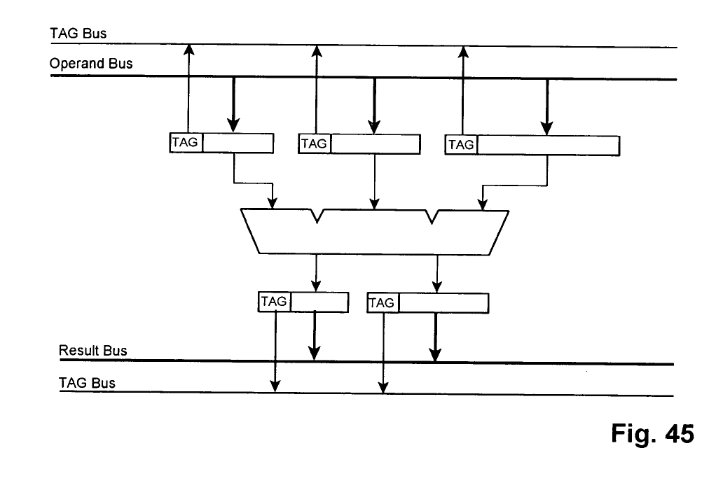

FIG. 45 shows a processing resource whose parameter registers have been extended by TAG bits that indicate the respective access width. Resources that are arranged upstream and downstream can query this information by additional bus lines. For this purpose, the operand bus and the result bus are supplemented by additional lines (TAG bus). For all information transports (p-operators, l-operators, a-operators, concatenation), the TAG bits are queried (read access only). Writing via the TAG bus takes place only in order to set TAG bits, for example, when executing s-operators.

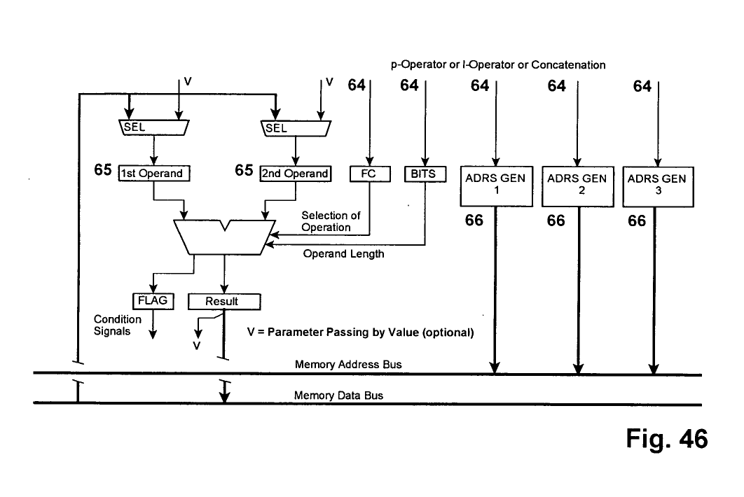

The resources can be designed for various forms of parameter transfer (value transfer, address transfer etc. as well as any combination thereof). FIG. 46 illustrates a processing resource modified in comparison to FIG. 43 that is switchable with regard to parameter transfer and is connected to a universal memory bus and signal lines (not illustrated) for value transfer (for example, to an operand bus and a result bus according to FIG. 11). Some of the parameter registers 64 are fixedly assigned to value transfer. The switchable operand registers 65 have arranged upstream thereof selectors. In order to be able to address the parameters in the memory for address transfer, for each parameter an address generator 66 is provided. In the simplest case, this is an address register that is configured as a counter. The address generators 66 can also be designed, for example, according to FIGS. 35 to 37.

Variants of switching:
By operation selection (by means of information in the context of function code).
By state control in the interior of the resource. The form of the last transfer before initiation of operation (y-operator or concatenation) is viewed as valid. Example 1: entry of a parameter into the first of the address generators 66 leads to address transfer being set for the first operand. Example 2: a p-operator that enters the second operand directly causes the second of the address generators 66 to be deactivated and thus the value transfer to be set.

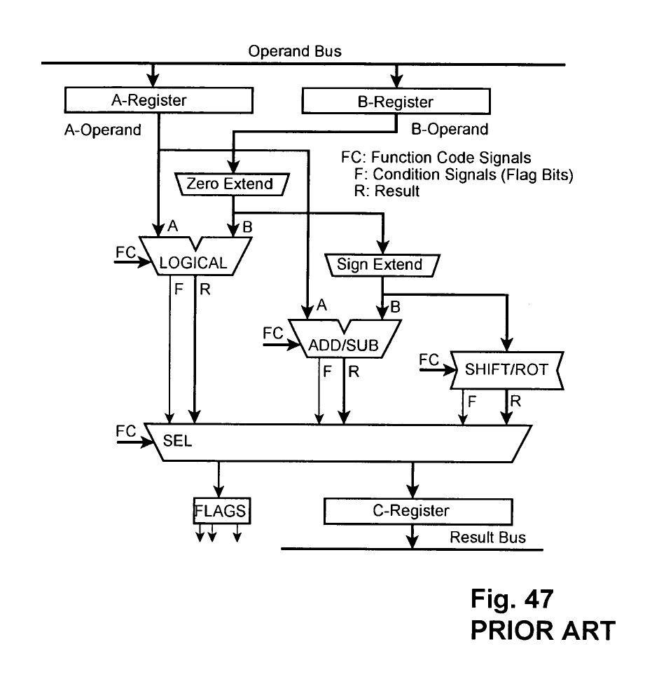

FIGS. 47 and 48 illustrate typical examples of elementary universally useable resources. Inter alia, such resources can be configured advantageously as arithmetic logic units (ALUs), with fixed as well as changeable processing width.

FIG. 47 illustrates an arithmetic logic unit with a conventional function repertoire. Downstream of the operand registers, circuits means for zero extension (zero extend) and for sign extension (sign extend), a circuit for performing logical operations, an adder and a subtractor as well as a shifter are arranged downstream. These processing circuits are connected by a selector to the result register and a branch condition register (flag register). The function select signals (FC) originate in function code register (compare, for example, FIG. 43). The function code FC sets all the combinational circuits to a certain function and addresses the subsequent selector in order to select the desired type of functions (logic, add/subtract, shift/rotate).

Example of a typical set of operations:

1) adding (ADD),

2) adding with input carrying (ADD WITH CARRY)

3) subtracting (SUBTRACT)

4) subtracting with input carrying (SUBTRACT WITH CARRY)

5) bit-wise conjunction (AND)

6) bit-wise disjunction (OR)

7) bit-wise anti-valence (XOR)

8) bit-wise negation (NOT)

9) complement on two (NEG)

10) shifting/rotating to the left (LEFT SHIFT/ROTATE)

11) shifting/rotating to the right (RIGHT SHIFT/ROTATE)

12) no function (NOP)

Details of such processing circuits are general knowledge in the art so that a more detailed description is not required. Arrangements similar to FIG. 47 are conventional inter alia in microcontrollers and processors of the medium performance range. FIG. 48 illustrates a general-purpose processing resource whose function repertoire corresponds to the range of high-performance processors of the prior art. It is comprised of an arithmetic logic unit that is connected to register memories and a controller (sequencer) SEQ. The resource has four operand registers A, B, C, D; a function code register FC; two result registers X, Z; and a further result register in the form of a branch condition register (flag register). The data structures are binary integers and bit fields. Table 2 provides an overview of the repertoire. For each function it is listed how many operands are required, how many results are formed, and which registers are used. The support of individual bits, strings, floating point numbers etc. is not illustrated.

Resources that are configured as universal arithmetic logic units are to be used also for address calculation and memory addressing as well as supporting memory access functions. It should be possible to configure arrangements of addressing and processing resources from such resources (compare FIG. 33).

Load functions fetch the addressed memory content and make it available as a result that is supplied to the processing resources (l-operators or concatenation). Store functions store a value provided as an operand that has been supplied prior to this by the processing resources (l-operators or concatenation).

FIG. 48a shows the configuration as a typical processing resource. The registers A, B, C, D can receive operands, the registers X, Z can deliver results (for an appropriate circuit with a corresponding system interface controller compare FIG. 13). When such a resource serves for addressing and memory access purposes, register X, for example, is used as a memory address register. When loading, the data word fetched from the memory is written, for example, into the operand register C and then transferred into the result register Z. From here, it can be transported by l-operators or by concatenation to the processing resources. A data word to be stored is first to be written into the operand register C (l-operator or concatenation). It is transferred into the result register Z and from there is written into the memory; the memory address is taken from the result register X. The remaining operand registers A, B, D are available for address calculation purposes. For example, calculations according to FIG. 35 can be supported.

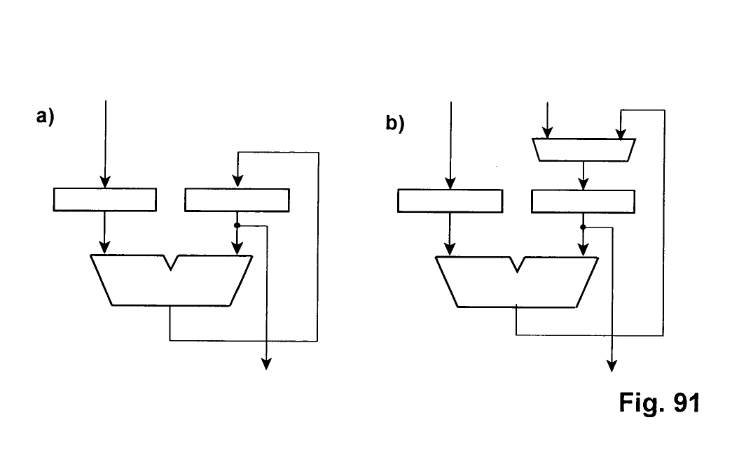

FIG. 48b shows a modification that can be expanded, inter alia, to calculations according to FIG. 36. For this purpose, an additional operand register is required. For a total of 8 register addresses (3 address bits) to be still sufficient, the result register Z is configured as a bi-directional register for memory data. It can be used as an operand register and as a result register (INOUT parameter, compare FIG. 91) and is designed for concatenation at the input side as well as the output side. When loading, Z acts as a result register. The data word retrieved from the memory is written into the register Z and can be transferred from here to the processing resources (l-operators or concatenation). When storing, Z acts as an operand register. The data word to be stored is transferred into the register Z as a parameter and from there is transferred to the memory.

TABLE 2

| resource | operands | | results | | function |
|---|---|---|---|---|---|
| NOP | — | | — | | no operation |
| MOVAX | 1 | A | 1 | X | X := A |
| MOVAZ | 1 | A | 1 | Z | Z := A |
| MOVAB | 2 | A, B | 2 | X, Z | X := A, Z := B |
| ADD | 2 | A, B | 2 | X, flags | X := A + B |
| SUB | 2 | A, B | 2 | X, flags | X := A − B |
| MUL | 2 | A, B | 3 | X, Z, flags | Z\|X := A · B |
| DIV | 3 | A, B, C | 3 | X, Z, flags | X := A\|B : C, Z := A\|B mod C |
| | | | | | (remainder) |
| NEG | 1 | A | 2 | X, flags | X := A · (−1) (two's complement) |
| AND | 2 | A, B | 2 | X, flags | X := A and B |
| OR | 2 | A, B | 2 | X, flags | X := A or B |
| XOR | 2 | A, B | 2 | X, flags | X := A xor B |
| NOT | 1 | A | 2 | X, flags | X := not A |
| SHL | 3 | A, B, C | 3 | X, Z, flags | Z\|X := A shifted to the left by C bits, |
| | | | | | filled with B |
| SHR | 3 | A, B, C | 3 | X, Z, flags | Z\|X := A shifted to the right by C |
| | | | | | bits, filled with B |
| SHRA | 2 | A, B | 3 | X, Z, flags | Z\|X := A shifted arithmetically to the |
| | | | | | right by B bits |
| ROTL | 2 | A, B | 2 | X, flags | X := A rotated to the right by B bits |
| ROTR | 2 | A, B | 2 | X, flags | X := A rotated to the left by B bits |
| EXTRACT | 3 | A, B, C | 2 | X, flags | X := bit field from A, beginning at bit |
| | | | | | B, length C |
| DEPOSIT | 4 | A, B, C, D | 2 | X, flags | X := A with inserted bit field B; |
| | | | | | insertion beginning at bit C, length D |
| FIRSTOCC | 1 | A | 3 | X, Z, flags | X := bit vector with highest-order |
| | | | | | [leftmost] 1 from A (zeroes |
| | | | | | otherwise), |
| | | | | | Z := corresponding bit address (first |
| | | | | | occurrence) |
| LASTOCC | 1 | A | 3 | X, Z, flags | X := bit vector with lowest-order |
| | | | | | [rightmost] 1 from A (otherwise |
| | | | | | zeroes), Z := corresponding bit |
| | | | | | address (last occurrence) |
| NOOCCS | 1 | A | 2 | X, flags | X := number of ones in A (number |
| | | | | | of occurrences) |
| LOAD | 3 | A, B, D | 2 | X, Z, flags | X := A + B; |
| | | | | | load Z (through C) according to |
| | | | | | address in X; |
| | | | | | B := B + D (autoincrement) |
| STORE | 4 | A, B, C, D | 2 | Z, flags | Z := A + B; |
| | | | | | store C (through Z) according to |
| | | | | | address in X; |
| | | | | | B := B + D (autoincrement) |
| LOAD_A | 3 | A, B, D | 2 | X, Z, flags | X := A + B; |
| | | | | | load Z according to address in X; |
| | | | | | B := B + D (autoincrement) |
| STORE_A | 5 | A, B, C, D, Z | 2 | X, flags | X := A + B; |
| | | | | | store Z according to address in X; |
| | | | | | B := B + D (autoincrement) |
| LOAD_X | 2 | A, B, C, D | 3 | X, Z, flags | X := A + (B · C); |
| | | | | | load Z according to address in X; |
| | | | | | B := B + D (autoincrement) |
| STORE_X | 5 | A, B, C, D, Z | 2 | X, flags | X := A + (B · C); |
| | | | | | load Z according to address in X; |
| | | | | | B := B + D (autoincrement) |
| FORLOOP | 3 | A, B, C | 2 | X, flags | initially: X := A; then |
| | | | | | X := X + B, as long as X < C |
| Remarks to Table 2: | | | | | |
| 1) Z\|X and A \|B = high-order word in Z or A, low-order word in X or B. | | | | | |
| 2) LOAD, STORE = loading and storing according to address calculation base + displacement with subsequent increment of displacement information. Base in A, displacement in B, increment in D. Supports access to sequential same-length data structures of the length D (compare explanations in regard to FIG. 35). Is supported by resources according to FIG. 48a. Calculated memory address in X. Read data are transferred from the memory to C and from there farther | | | | | |
| # to Z. Data to be written are transferred into C and reach the memory through Z. | | | | | |
| 3) LOAD_A, STORE_A = loading and storing according to address calculation base + displacement with subsequent increment of displacement information. Base in A, displacement in B, increment in D. Supports access to sequential same-length data structures of the length D (compare explanations in regard to FIG. 35). Memory data are transferred into register Z. Requires configuration according to FIG. 48b. | | | | | |
| 4) LOAD_X, STORE_X = loading and storing according to the index information with subsequent increment of index value. Supports access to sequential same-length data structures on the basis of an idex information (= sequential number 0, 1, 2, 3 etc.). Base address in A, index information in B, length of data structure in C, increment in D (compare also explanations in regard to FIG. 36). Memory data are | | | | | |
| # transferred into register Z. Requires configuration according to FIG. 48b. | | | | | |

5) FORLOOP = FOR X := A TO C STEP B. Compare also explanations in regard to FIG. 37. Evidently, a maximum of 8 registers is sufficient. It is therefore sufficient to have a parameter address of 3 bits. This enables also the support of the additional conventional operations (floating point numbers, strings, individual bits etc.) in modern high-performance processors.

Any operation in Table 2 corresponds, from the standpoint of system architecture, at least to one resource type (there are modifications with regard to the operand length etc.). The hardware according to FIG. 48 is set with s-operators to the respective function.

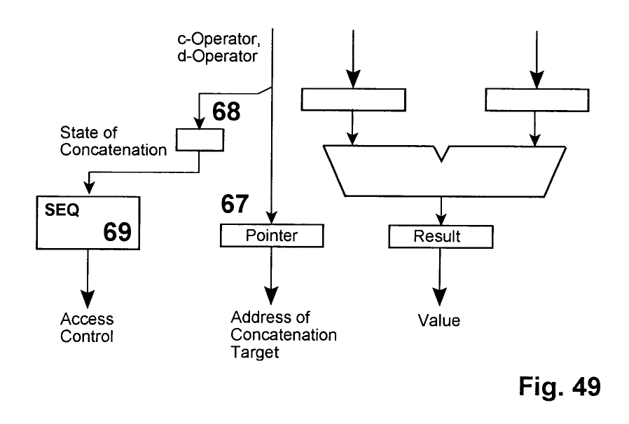

In the following, with the aid of FIGS. 49 to 58 the concatenation of resources will be explained in more detail. Outputs can be linked to inputs of downstream resources. The purpose of concatenation is to provide connections between the resources in such a way that the resource array corresponds to the data flow diagram of the respective application problem. Establishing a concatenation: by means of c-operator. Disconnecting the concatenation: by means of d-operator. Variants of the embodiment:
The connections are generated physically (for example, implementation with programmable hardware).
The connections are switched physically (for example, by bus systems or switching hubs (switch fabric).
The connections are described by means of concatenation pointers or in concatenation tables. Based on this information, the resources carry out the respective data transfer automatically (for example, by means of a bus system where they are active as bus master, or by means of a switching hub).
The data transports that correspond to the concatenation are emulated by the platform (the platform carries out corresponding read and write accesses to the concatenated resources, for example, on the basis of stored concatenation tables).

It depends on the respective resources which parameters can be incorporated into the concatenation and which cannot. Results that are to be concatenated must be extended by information that describes the destinations of concatenation. When hardware resources are concerned, additional circuits are required in order to control the corresponding information transport. Technical solutions for indicating concatenation destinations:
1) pointer
2) pointer list
3) stored tables with source and destination information,
4) a kind of horizontal microinstruction that controls the signal paths,
5) transmitting data packets with appropriate destination information.

FIG. 49 shows how the result of a simple processing resource can be linked at the output. The result register is supplemented by a pointer register 67. A state register 68 is assigned to the pointer register 67 and has arranged downstream a sequencer (SEQ) 69 for access control. The pointer register 67 is loaded by c-operators. It contains an address pointer that points to the resource that is concatenated at the input side (i.e., the subsequent resource). The state register 68 contains in the example only one bit. Allocation: 0=no concatenation; 1=concatenation is active.

Function of c-operator: entry of the concatenation address into the pointer register 67 and setting the bit in the state register 68. Function of d-operator: deleting the bit in the state register 68. Function of the y-operator:
the result is generated;
when the bit in the state register 68 is set, the access controls 69 becomes active in order to transport the result according to address information provided in the pointed register 67 to the addressed resource (for example, by requesting a corresponding bus access).

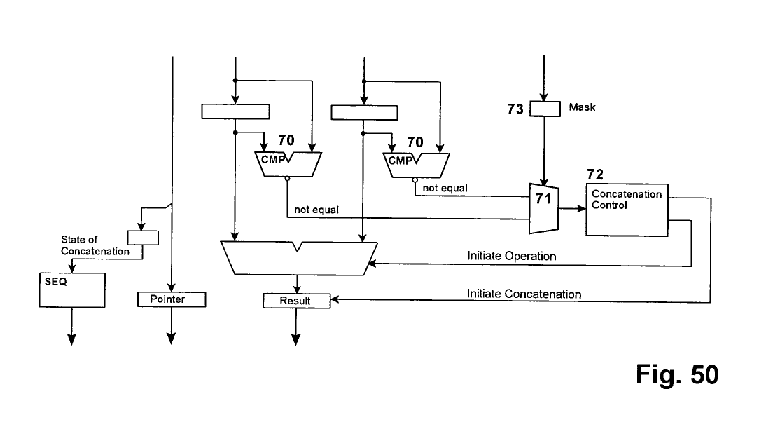

Any resource that is the destination of concatenation must know when it has to begin to compute the results. There are several possibilities for activating such resources:
A. Initiation by y-operator. In the corresponding resources no special provisions are required. However, the platform must ensure a strict sequential operation sequence of the operators. The respective next operator must become active only after the preceding operator has been completely executed. This also includes data transports of the concatenation. The execution of a y-operator for a resource similar to FIG. 49 takes until the concatenated result has been transported. Only thereafter, the next operator becomes active. The sequence of the y-operators of the linked resources must correspond to the concatenation sequence. The simplicity is advantageous. In the case of software emulation and in small systems (for example, with a single universal bus), the strict operation sequence is practically realized automatically (because at any time only one instruction or data transport can be performed). High-performance hardware however cannot be used to its fullest extent. Also, only the l-operators but not the y-operators are eliminated relative to program sequences without concatenation.
B. New computation when changing the input values. According to FIG. 50 the operand registers have arranged downstream comparators 70 that compare the previous contents with the new contents (present at the inputs). The operand comparison takes place when new operands are entered. When the new (incoming) operand deviates from the prior contents of the respective operand register, the respective comparator 70 is activated. The outputs of all comparators 70 are connected by a selection network 71 to a concatenation control 72. The selection network 71 has arranged upstream thereof a mask register 73. The selection network 71 determines when new computations must be initiated. Typical modes of operation:
   1) any change of an operand leads to a new computation,
   2) the new computation is initiated only when all operands have changed,
   3) the new computation is initiated when certain combinations of operand changes occur.

The respective mode of operation is selected by the program by means of the mask register 73. The mask register 73 is set, for example, by s-operators (together with the function selection).
C. Validity control. The individual parameters (=input registers or memory positions) have assigned states:
   1) not connected,
   2) invalid,
   3) valid,
   4) retain validity but invalid,
   5) retain validity and valid.

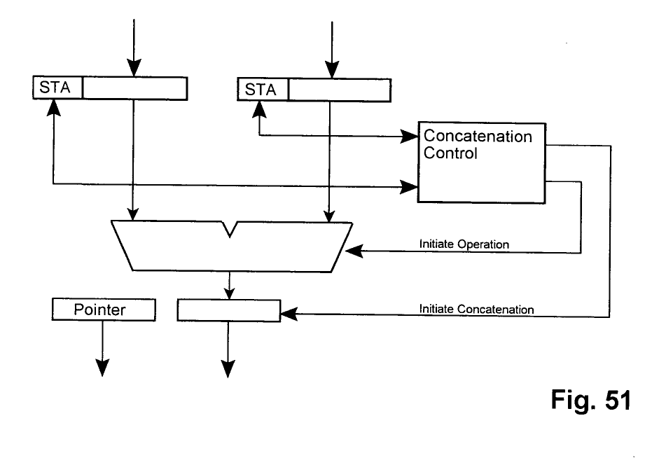

These states can be coded, for example, in three state bits that are assigned to the respective operand register. Table 3 illustrates a state coding scheme. FIG. 51 shows a resource with operand registers that are extended by state bits STA.

TABLE 3

| | state bit | | |
|---|---|---|---|
| | STA2 | STA1 | STA0 |
| value = 0 | not | do not retain validity | invalid |
| | connected | | |
| value = 1 | connected | retain validity | valid |
| delete bit | d-operator | fixedly set or s- | c-operator or |
| | | operator or p-operator | concatenation control if |
| | | or u-operator | STA1 inactive |
| set bit | c-operator | | incoming operand |
| | | | (concatenation) oder p- |
| | | | operator or l-operator |

A c-operator activates loading of the pointer and activation of concatenation. According to Table 3, the state bits are set as follows: STA1 => 0 (invalid); STA2 => 1 (connected). A d-operator initiates the deactivation of concatenation. According to Table 3 STA2 is deleted.

The validity control is advantageously designed such that it is possible to eliminate y-operators for function initiation. For this purpose, the result computation is initiated always when all operands are valid, no matter in which way they are supplied. The connect control acts as follows:
1) The operand registers are initially invalid (STA0=0).
2) The supply of operands makes them valid (STA=>1). An operand becomes valid at the time it is supplied, irrespective of the way it is supplied (concatenation, p-operator, l-operator).
3) When all operand registers of a resource are valid, the results are computed.
4) When the results are ready in the registers, the operand registers are made invalid (this is required in order to support concatenation with inputs of the same resource (result feedback)). Exception: operand registers with state “retain validity” (STA1= 1) remain valid. Operands characterized in this way have no effect on the function initiation (the effect of this state corresponds to exclusion through mask register 73 in FIG. 50). This mode of operation is set, for example, by s-operators, p-operators or u-operators. Utilization: inter alia for fixed values that must be entered only once.
5) The concatenated results are delivered to their destinations should the destinations be free. Otherwise, a waiting period begins (alternative: the results are written into buffers, for example, FIFOs).

Sometimes it is expedient to switch on and off the concatenation mechanisms of the resource as a whole (general concatenation enablement), for example, in order to avoid that during setting or changing of the mode of operation individual control circuits will start up without permission. For this purpose, inter alia special u-operators can be provided. It is also possible to use the y-operator as a general start permission (after setting the mode of operation, the resource is essentially “armed” by means of the y-operator).

Sometimes, it is advantageous to make concatenation operations dependent on conditions (conditional concatenation). This concerns the output-side transfer of results to downstream resources (conditional output concatenation) as well as the conditioned input-side function initiation (conditional input concatenation). In this way, it is inter alia possible to allow the flow of information to take different paths through the connected resources as a function of processing results; to react to special conditions; and to synchronize program execution with certain events.

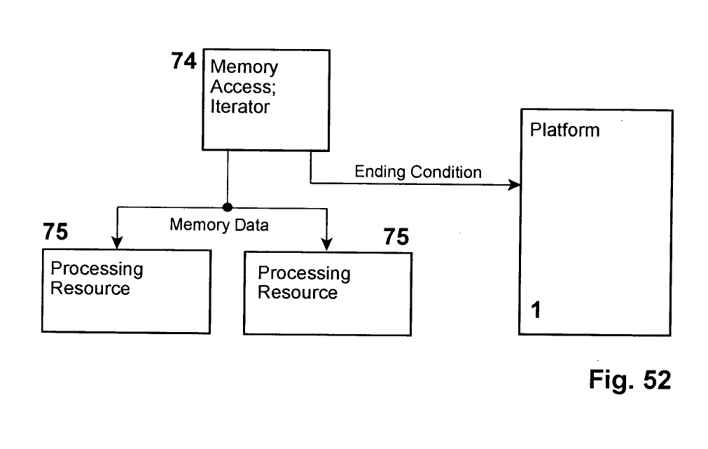

FIG. 52 illustrates an example of conditional output concatenation. A memory access resource (with iterator) 74, for example, an arrangement according to FIG. 39, is connected to two downstream processing resources 75 as well as to platform 1. During the loop passes the memory access resource 74 sends its results (operands fetched from memory) to the processing resources 75. When the loop end is reached, the processing resources 75 are no longer supplied. Instead, the corresponding ending condition is signalized to the platform 1.

For realizing the conditional input concatenation, parameters can be used that serve only for function initiation (function codes, compare, for example, parameter FC in FIG. 43). These parameters are incorporated into in the concatenation. In this context, it is advantageous to design the concatenation control in the resource in such a way that it is not only possible to trigger the processing functions but also to stop them. It is expedient to design the function codes in such a way that the following functions can be coded:
1) no operation,
2) stop resource,
3) start resource (with the previous function code),
4) enter new function code, resource is stopped,
5) enter new function code, resource is started.

The codes 1, 2, 3 effect only the control function, respectively, but are not transferred into the function code register FC (instead, the old content is retained). This principle makes it possible to start processing operations only once certain conditions have been occurred outside of the resource.

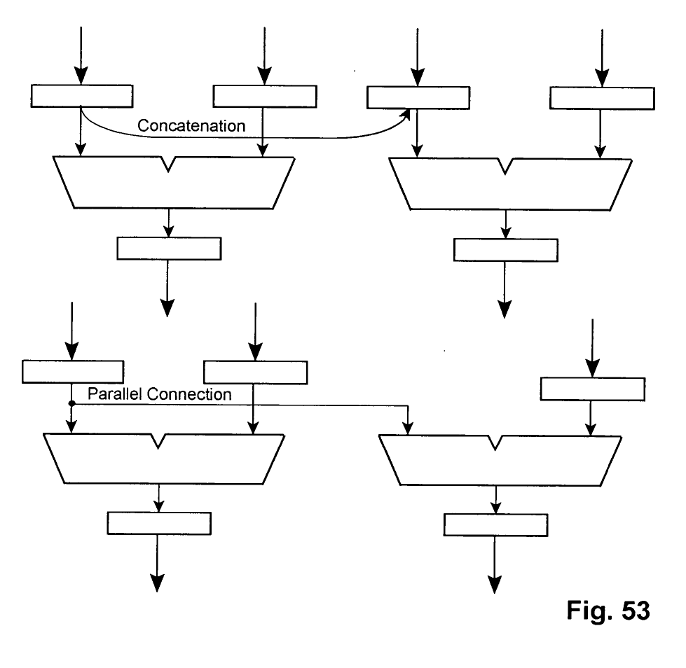

A further advantageous utilization of the concatenation provisions resides in that operands are sent simultaneously to several resources (input concatenation). In FIG. 53, it is illustrated that the input concatenation of several operands practically corresponds to connecting the participating operand registers in parallel.

The concatenation control circuits in the resources act usually in such a way that the actual data are first transferred to all connected operand positions and only thereafter the results are computed. All correspondingly connected resources thus receive the operands almost at the same time (this corresponds to the parallel connection illustrated in FIG. 53).

One modification is the conditional operand concatenation. For this purpose, first the result is computed and subsequently a decision is made in regard to the transfer of the operands (according to a programmable condition). Utilization: for example, in data-dependent loops or for debugging purposes.

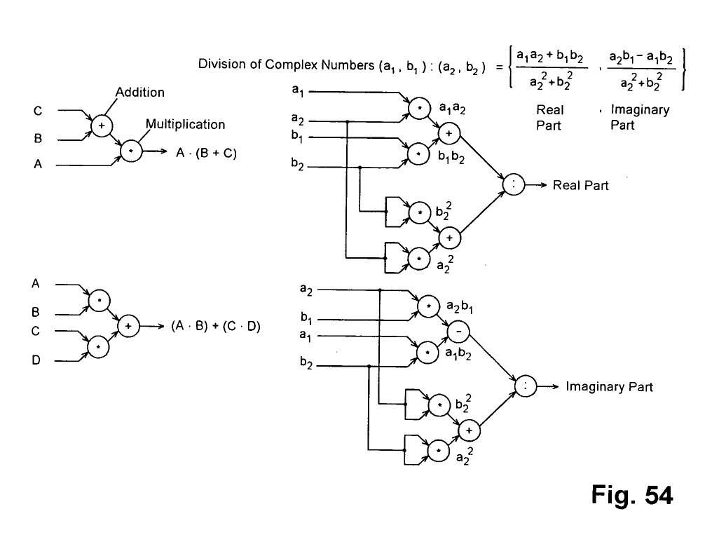

Resources that are configured in accordance with FIG. 49 can transport a result only to a single operand, an output can be connected only to a single input (of a downstream resource). FIG. 54 shows that this type of connection can be used in order to configure inverted tree structures. Such structures are generated upon evaluation of nested expressions, for example, the typical formulae of numerical computation (in FIG. 54, three examples are illustrated). Conventionally, for this purpose elementary stack machines are used (conversion of the expression into a reverse polish notation RPN that is converted directly into instructions of the stack machine). Analogously, such expressions can be converted into inverted tree structures wherein each arithmetic operation corresponds to a resource, respectively. In this way, the simplest form of concatenation is suitable to support many resource configurations that are important with regard to practical applications.

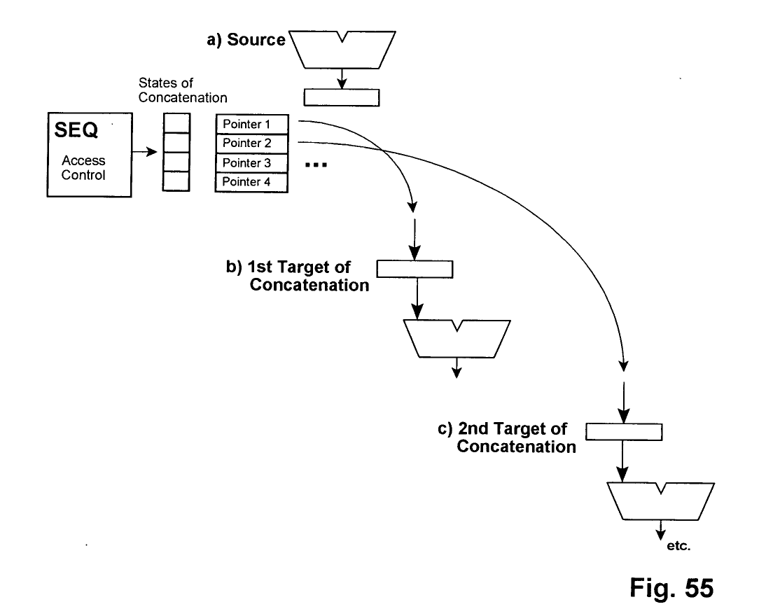

In order to connect an output with several inputs, the output can be supplemented with memory arrays that can contain several pointers and states. Analogously, operand registers that are provided for input concatenation can be supplemented with corresponding memory arrays. According to FIG. 55, the pointer information is combined to a pointer list wherein each pointer has a state bit (connecting state) correlated therewith. This is essentially a multi-arrangement of the switching means 67, 68 according to FIG. 49. When one such resource has computed its results (or the corresponding operand has been entered), the access control addresses the pointer list, retrieves all pointers with set state bits and transports the respective values to the resources indicated in the pointers.

Advantages:
in the downstream resources no special provisions are required;
with corresponding configuration of the hardware (with several bus systems or signal paths that are connected by switching hubs), it is possible to send a result simultaneously to several concatenated resources (parallelization).

Disadvantage: the number of concatenations is limited.

One solution: the pointer list is stored in the memory so that it can be as large as desired. This has however the disadvantage that the concatenation operations require more time.

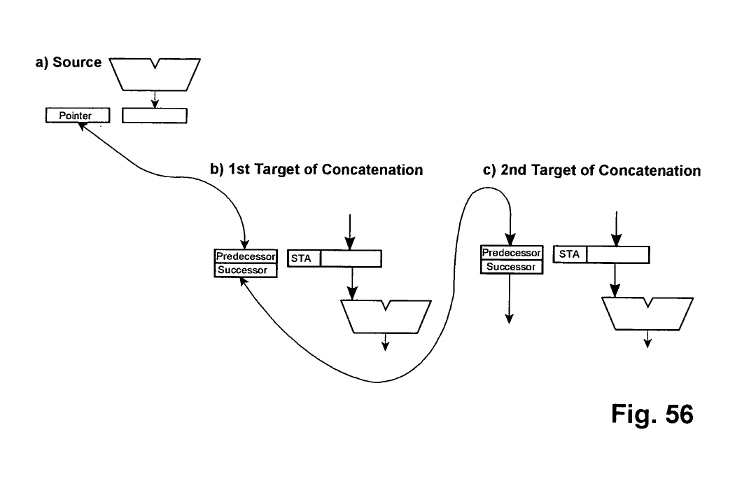

FIGS. 56 to 58 show an alternative: the pointer concatenation (daisy chain). Such a concatenation can comprise as many resources as desired. This type of concatenation however must be supported also by those resources that receive the concatenated results as operands (support of input concatenation). Each operand to be connected in this way requires one or two pointers. The resource that provides the result (source) has only one pointer. This pointer points to the first concatenated operand, the pointer provided thereat points to the second one, and so on. The end of the concatenation is characterized in the last resource by a special pointer value (for example, by a zero pointer).

If it is not necessary to reconfigure the concatenation dynamically (at run time), a single pointer for each parameter is sufficient. When the reconfiguration of concatenation (by means of d-operators and c-operators) is to be supported, two pointers are provided, respectively; the second one contains the return path to the respective preceding resource (predecessor). FIG. 56 illustrates a corresponding arrangement.

When a resource receives an operand for which a successor is indicated, it is not only entered into the own operand register but also transferred to the respective next resource.

A c-operator acts in such a way that the provided pointer chain is queried. In the last position of this string, the terminal identifier (for example, a zero pointer) is replaced by a pointer referencing the newly added resource.

A d-operator acts in such a way that the pointer information of the resource that is to be removed from the concatenation is employed in order to reset the pointers in the preceding resource and the subsequent resource:
The successor information becomes the successor information of the preceding resource (that is addressed, in turn, by the predecessor information).
The predecessor information becomes the predecessor information of the succeeding resource (that, in turn, is addressed by the successor information).

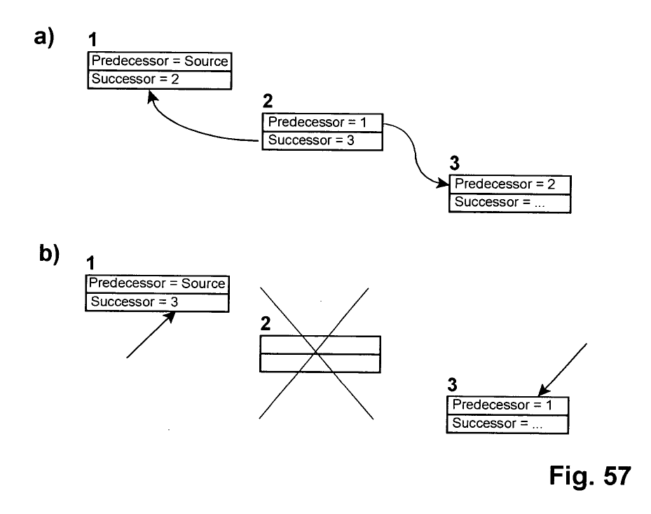

The schematic of FIG. 57 illustrates how such a concatenation can be dynamically reconfigured:
a) Example of pointer chain. The source has arranged downstream resources 1, 2, 3. The arrow indicates the pointer transports required for removal of the resource 2.
b) The resource 2 is removed from the concatenation (operator d (source => 2)). In resource 1 the successor is switched to resource 3; in resource 3 the predecessor is switched to resource 1. In resource 2, the connect function is switched off optionally (for example, by loading of a corresponding state register).

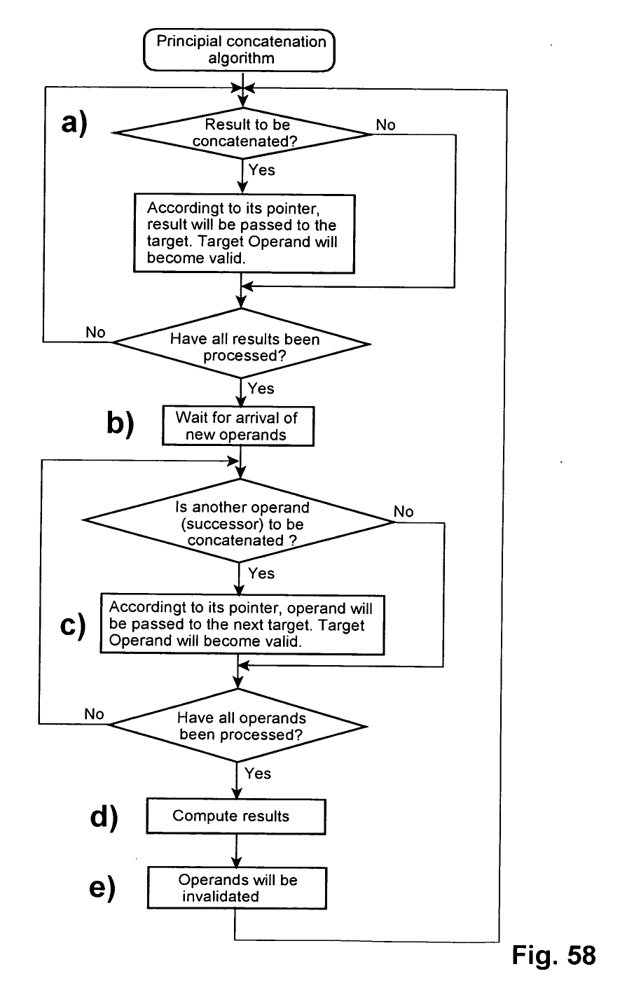

The flow schematic shown in FIG. 58 illustrates a typical concatenation sequence in a resource:
a) Initial state: results have been computed. (The operands of the resource have been invalidated optionally in order to support the feedback to the own inputs.) The concatenated results are transported according to the respective pointer information to their destination resources.
b) The new operands arrive at the operand registers. An operand register loaded in this way automatically becomes valid.
c) When an operand is concatenated to the input of another resource, the operand is transferred.
d) When all operands are valid, the results are computed.
e) The operand registers are invalidated (exception (not illustrated): state=retain validity). The game begins anew.

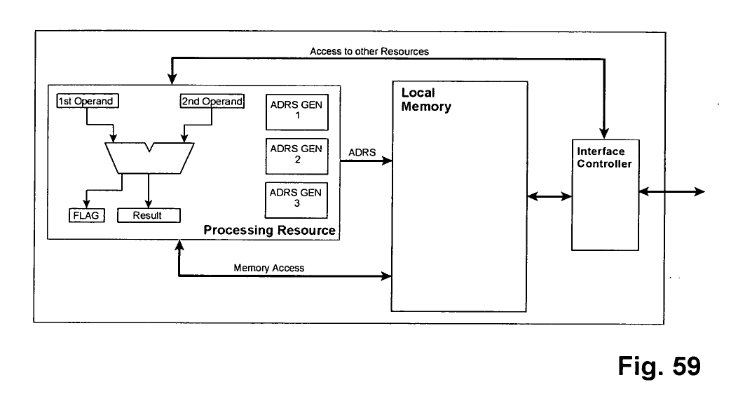

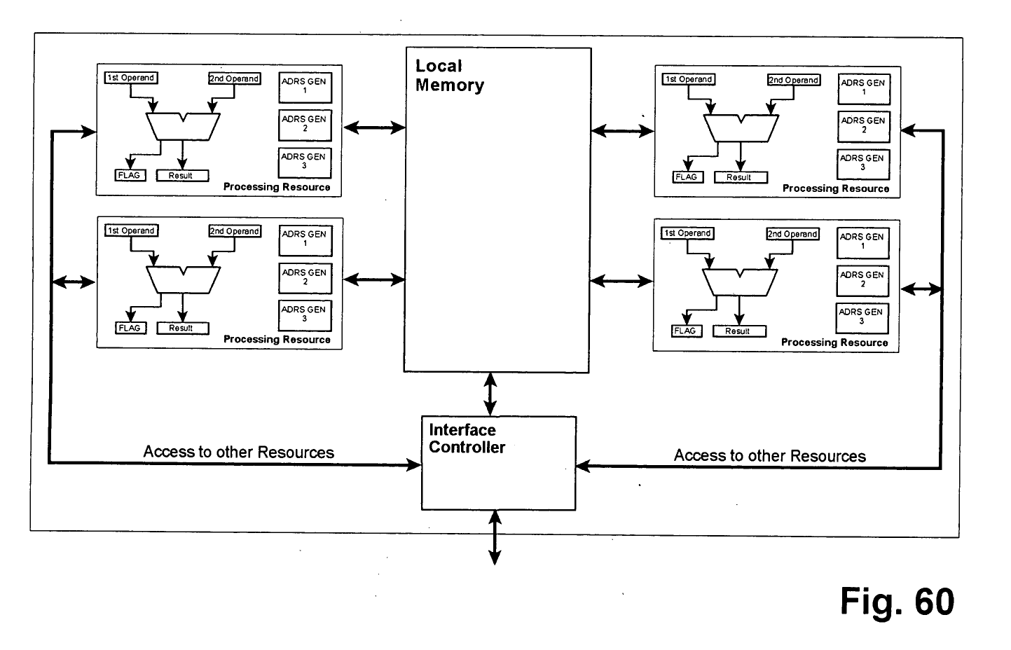

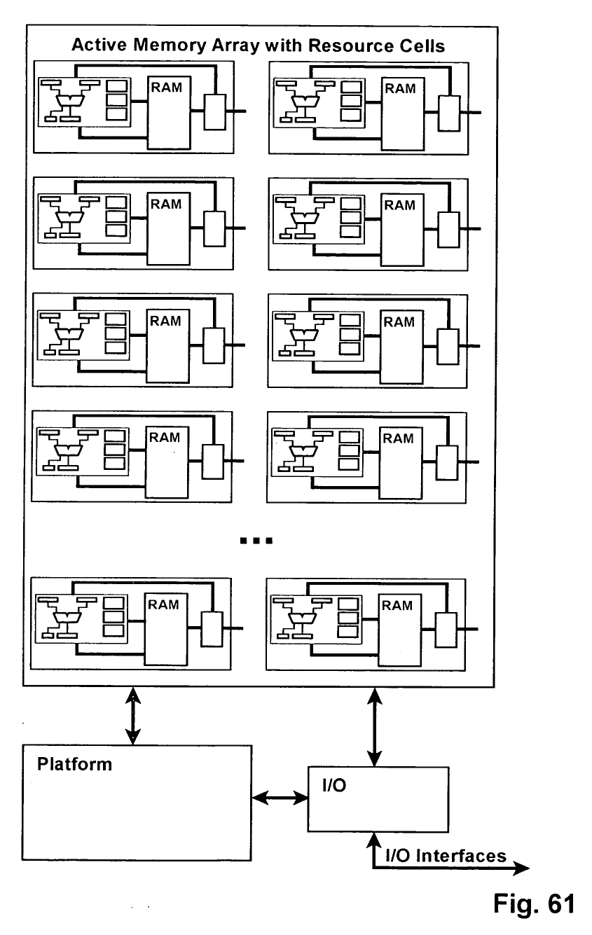

In the following, with the aid of FIGS. 59 to 70 it will be illustrated how resources can be connected to memory means and can be incorporated into memory devices. The data exchange between processing resources and memory is typically time-consuming. In order to reduce these transport times, the resources can be provided with their own memory means. Variants:
A. Each processing resource has its own memory means (FIG. 59). The resource provided as an example corresponds substantially to the configuration of FIG. 46. Memory data bus and memory address bus serve as access path to the local memory. The entire resource is connected by an interface controller to the rest of the system. The interface controller supports the direct access to the resource (operators, concatenation etc.) and enables the system to access the local memory means.
B. Several processing resources are combined to a cluster and connected to common (local) memory means (FIG. 60). The modification relative to FIG. 59 resides in that several resources access the local memory means.
C. Several (also means: very many) arrangements of processing resources and memory means are combined to an active memory array (FIG. 61). The individual resource array with memory (for example, according to FIG. 59) practically represents an active memory cell (resource cell). The entire memory configuration forms a single unified address space.

In the active memory array, the memory and processing resources form a unit. Building large semiconductor memories (primarily DRAMs) from a plurality of memory matrices (banks) is well known in the prior art; likewise, the connection of these memory banks to synchronously operating (clock-controlled) high-speed interfaces is known in the art. An active memory array can be formed, for example, in that each memory bank is connected with corresponding processing circuitry. Memory arrays with incorporated processing resources can be utilized in many ways, for example, in the context of the known methods of parallel processing. Moreover, it is inter alia possible to assign own resource cells to each function call. The advantages are:
At run time the administration overhead is eliminated. Only the actual parameters must be transported but no stack frames must be generated and released, no local variables must be initialized etc.
All functions which can be called principally in parallel can be executed actually in parallel.

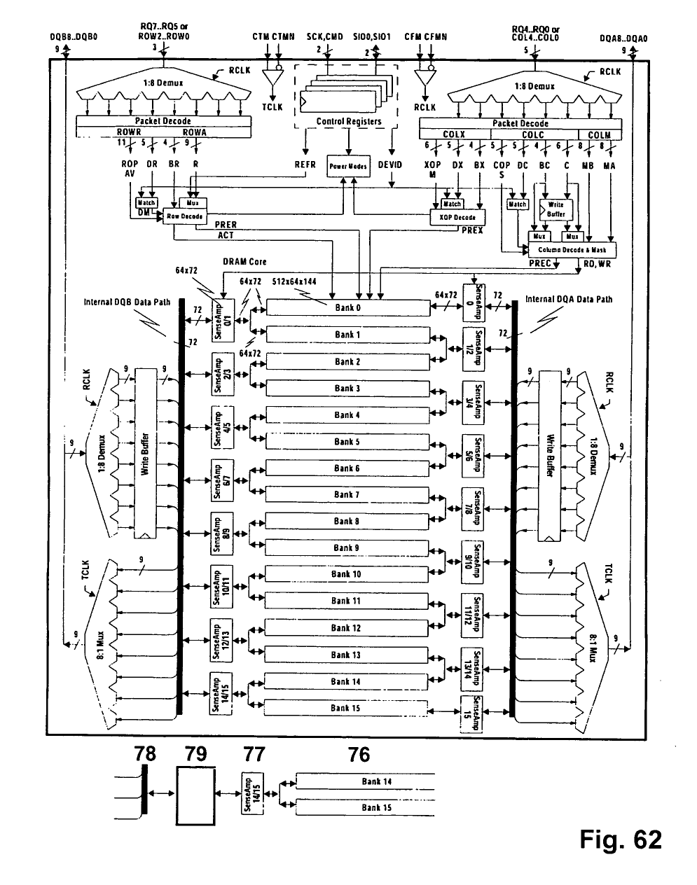

FIG. 62 shows the block diagram of a direct rambus memory circuit (DRDRAM). The memory banks 76 are connected by read amplifiers 77 to internal data paths 78 (in the example they each have a width of 72 bits). Between the read amplifiers 77 and the internal data paths 78, processing resources 79 can be arranged.

Processing resources can be incorporated into any memory devices, for example, cache memory, register files, buffer memory and special-purpose memory areas (e.g. for object reference tables or for stack frames). The memory means at the input and output sides of the processing resources are memory cells of the respective memory device. The basic advantage resides in that the processing resources are essentially on site so that special information transports (from memory cells into registers and vice versa) are not required. (If, for technological reasons, special registers cannot be avoided, comparatively minimal latency results because the transports typically are carried out via short point-to-point connections between the registers and the corresponding memory array.)

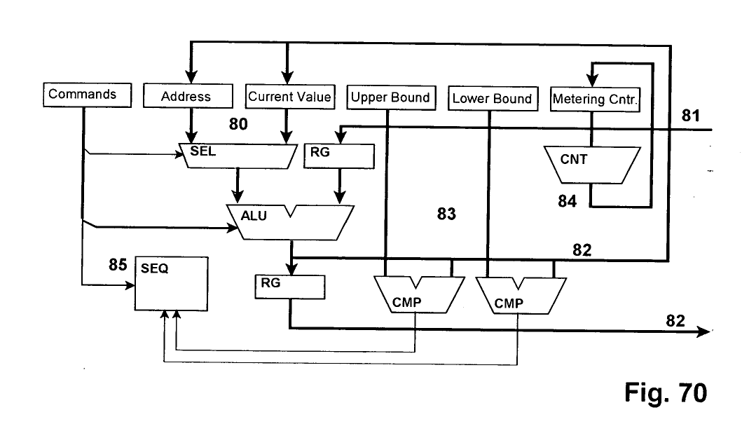

Processing resources in general-purpose memory devices (for example, in cache memory and universal register files) must, in turn, be designed for general-purpose use. Processing resources in special memory devices (for example, in those that are utilized for storing object reference tables; compare FIG. 28) can however be designed such that they support in a special way (special connecting circuits, signal paths etc.) the information processing operations to be performed primarily in the corresponding memory unit. This will be explained infra with the aid of an example (FIG. 70).

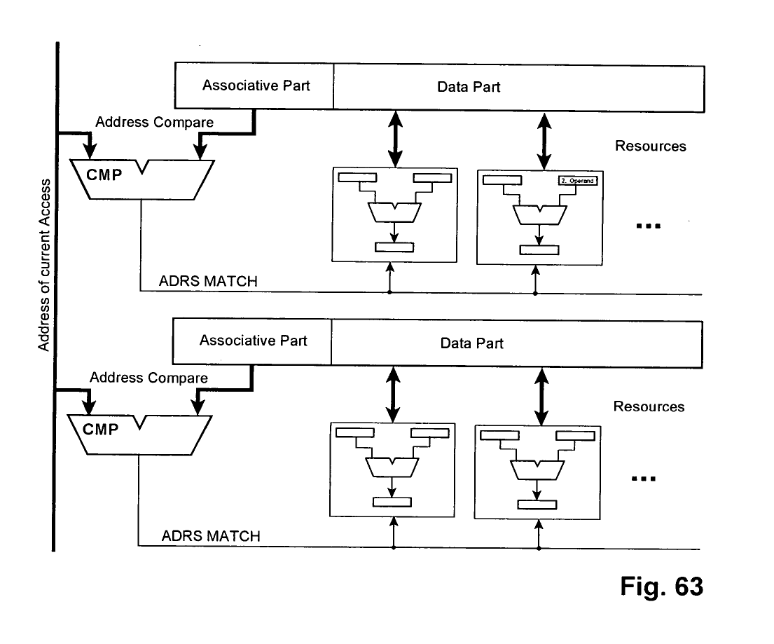

First, the arrangement of processing resources in cache memories will be described in more detail. Cache memories are typically in the form of blocks (cache lines). Each block has a data part (that can receive usually 32 to 256 data bytes) and an associative part. The associative part contains the respective memory address. When memory access is initiated, the access address is compared to the contents of the associative part. When identical (cache hit), no main memory (system memory) access is carried out but the respective data part of the cache memory is accessed. This provides a significantly shorter access time. When not identical (cache miss), the main memory is accessed. In this connection, the contents of the main memory is transported into the data part of the block (so that it is available for the next access). According to FIG. 63, the data parts of the individual blocks can be connected to processing resources. When the desired data are within the cache memory (cache hit), they can be directly processed by the embedded resources. The respective hit indication signal ADRS MATCH has the effect that the corresponding processing functions are carried out. If ADRS MATCH is inactive, a cache miss is present and the corresponding data must be retrieved first in a way known in the art (as in conventional cache memories) from the main memory. Such a configuration saves incorporation of processing resources in the DRAM circuits. For conventional programs (without intensive parallel processing) this may even result, depending on the hit ratio, in a superior processing performance because cache memories have lower access times and the embedded processing resources can be operated at a higher clock rate.

A different modification provides that processing resources are arranged in register files. Large general-purpose registers files (with typically 32 to approximately 256 registers) have been utilized for some time when the goal is to build especially performance-oriented processors. They are utilized primarily as fast-access memories for those data with which processing is carried out currently (for example, for local variables of the currently executed function). At first, the corresponding variables are loaded into the registers. The actual processing instructions then refer only to the registers. They do not carry out memory accesses. In the end, the results of the registers are passed to the main memory (load-store principle). In conventional processors of this type the processing instructions retrieve the data to be operated upon from the registers and return the results to the registers. A typical operation of the type X := A OP B (three address operation) requires either three sequential register accesses or a register file with three access paths. When more than one operation is to be carried out at a time (superscalar principle), a correspondingly large number of additional access paths are required. Such register files require a lot of space on the circuit. When extremely high clock rates are desired, more stages must be provided in the processing pipeline (the sequence reading => computation of result => writing cannot be performed in a single clock cycle). This causes greater latency so that in all the cases in which the sequential flow through the pipeline is interrupted the processing performance drops significantly.

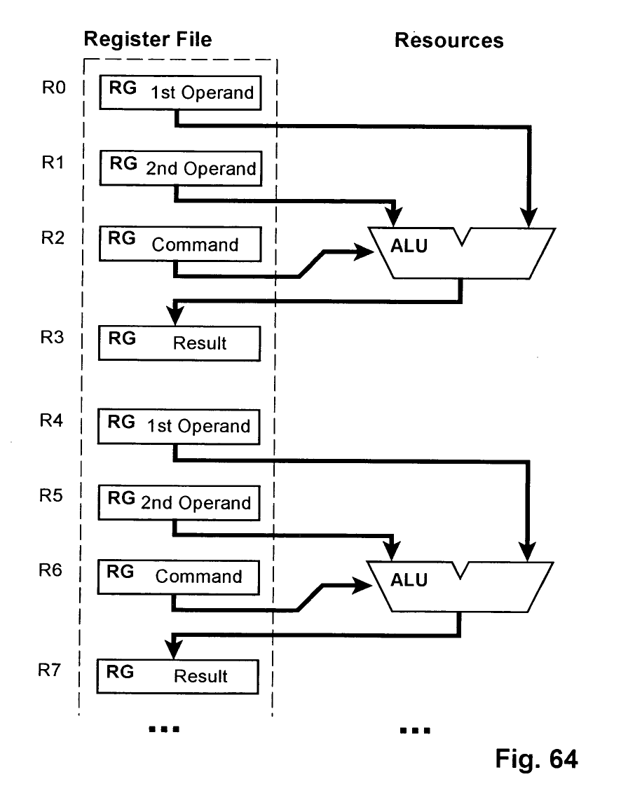

In order to avoid this, the registers are connected directly to the processing resources. FIG. 64 shows an example. Four registers are connected to a conventional arithmetic logic unit (ALU), respectively. However, it is also possible to provide special processing devices.

Two registers receive the operands (operand register)—one the results (result register) and one information that describes the operation to be performed (command register). The command register is preferably loaded by means of s-operators (the s-operator assigns a special function to the general-purpose processing resource (ALU)).

Such a register arrangement requires only two access paths, one for the connected resources and one for general read and write access (data transport). The second access path can be limited to write accesses to the operand registers and command registers and to read accesses to the result registers. Such limited accesses can be performed parallel to the execution of operations. The operand registers can be read through the ALU and the result register; the result register can be loaded through the ALU from each of the operand registers.

An arrangement with, for example, 32 registers can contain 8 operation units (ALUs), one with 128 registers can have 32 operation units. The direct connections between registers and the circuitry of the operation units make it possible to employ only a few pipelines stages (in many cases, a single one should be sufficient).

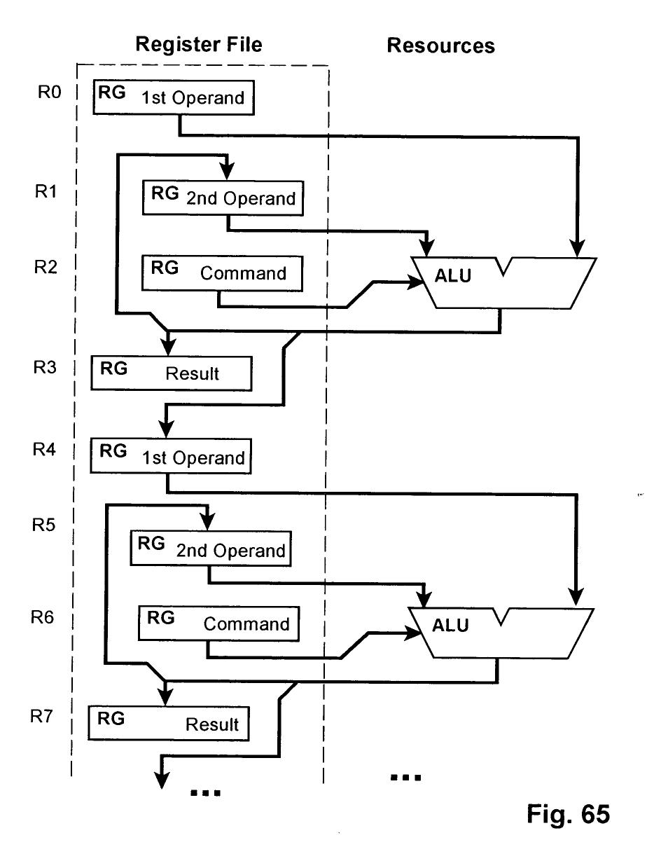

However, no operations with arbitrary register operands are possible anymore, for example <R7> := < R1> OP < R22>. Instead, the operands to be processed must be transferred into the registers of the corresponding resource. More complicated calculations are therefore sequences of computational and transport operations (by which the results become operands of the subsequent operations). In order to eliminate some of these transport operations, according to FIG. 65 certain registers can be used in combination as operand registers and result registers so that the actual result can participate as operand in the next computational operation.

Variants:

A. The result is fed back to operand registers that act therefore as a kind of accumulator.
B. The result is entered into operand registers of other resources (elementary form of concatenation).

These variants can be provided individually or in combination. In combination solutions, the result storage is controlled by an operation code. When all described configurations are combined, the following possibilities result:
1) return to an operand register (feedback),
2) storing in the result register,
3) transfer into operand register2 of the next resource,
4) any combination of 1, 2, and 3.

Since the register file is comparatively simple (it is not necessary to provide several parallel access paths), more registers can be provided within the limits of silicon real estate. In this way, it is possible to store variable values optionally several times and to avoid in this way transports during the processing operations.

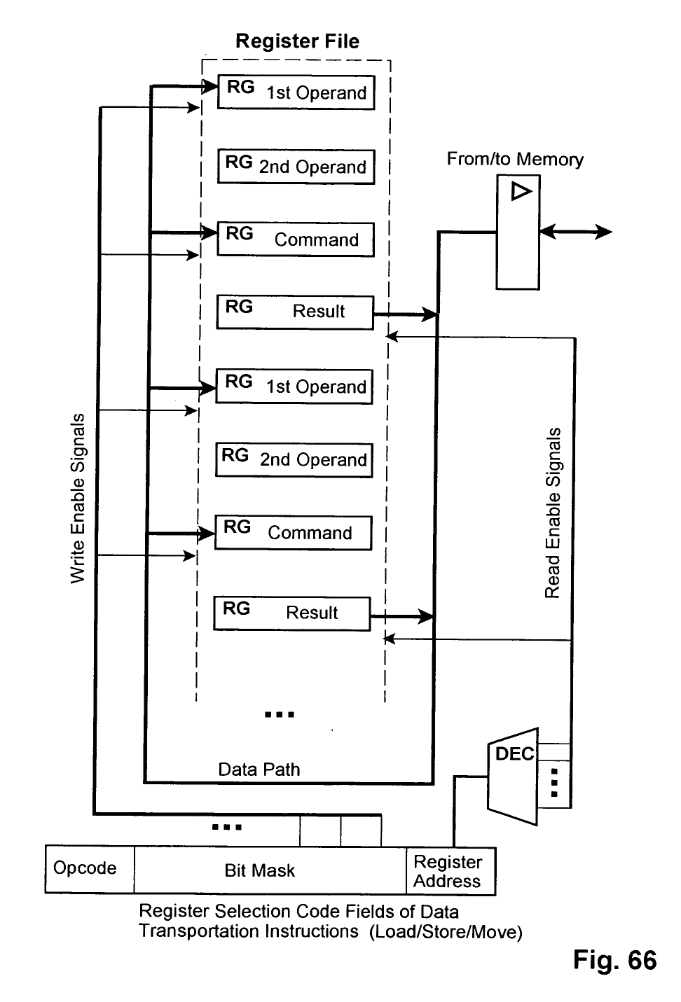

In order to accelerate transport, it is advantageous to design the access paths in accordance with FIG. 66 in such a way that data can be loaded into several destination registers at the same time. The register file is comprised, for example, of 128 registers. Four registers are assigned to one processing resource, respectively. There are 32 processing resources total. Two registers are accessible for write access and one for read access, respectively. The corresponding transport instructions have a bit mask for controlling loading and a register address field for selecting the register to be read. The following types of transport instructions are available:
1) loading with command code (corresponds to s-operator),
2) loading with data word from memory (corresponds to p-operator),
3) storing result (corresponds to a-operator),
4) data transport between registers (corresponds to l-operator).

By setting the bit mask appropriately in the transport instructions, it is possible to load any combination of registers at once. Additional access is carried out by ALUs. For this purpose, corresponding command codes must be loaded. The command register can contain several command codes.

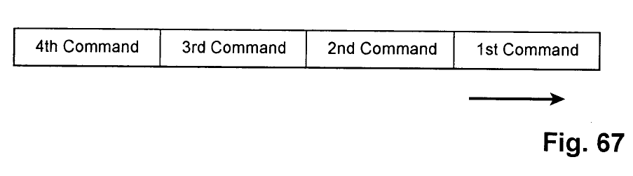

1st configuration: The command register according to FIG. 67 is configured as a shift register wherein each y-operator respectively initiates one command code. Subsequently, this command code is pushed out and pushed in again at the other end. Sequential y-operators have the effect that command after command is carried out cyclically.

2nd configuration: The y-operators have address information by which one of the stored commands is selected, respectively.

3rd configuration: After activation by means of y-operator the commands are carried out automatically (this is a kind of short machine instruction).

In a further alternative configuration (that is more closely related to conventional configurations), the command register contains only one command code that is entered by a respective y-operator and that is immediately activated (operator variant y_f). In this connection, it is expedient to address the command registers separately (so that they do not occupy any positions of the actual register address space).

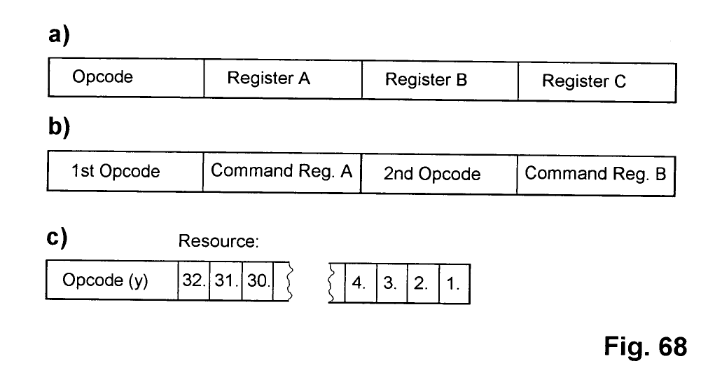

The described configurations enable support of parallel execution of several operations (in the example up to 32) with comparatively compact instruction formats. FIG. 68 illustrates conventional as well as inventive instruction formats:
a) Operation instruction of a conventional high-performance processor available on the market. The register file comprises 128 registers. The individual instruction has a length of 41 bits. A 128-bit word contains three such instructions. It is possible to carry out all three instructions parallel to one another.
b) Modified instruction format for controlling the afore described arrangement. Up to two resources can be made operative simultaneously in that one command code is loaded into the command register, respectively.
c) Format of y-operator that can activate any combination of the 32 processing resources by means of a bit mask.

Processing resources can be incorporated into any memory array. Inter alia, memory areas that are provided for special information structures can be provided with specially designed resources that, for example, support appropriately the typical utilization of object reference tables, stack frames, I-O buffers etc., respectively.

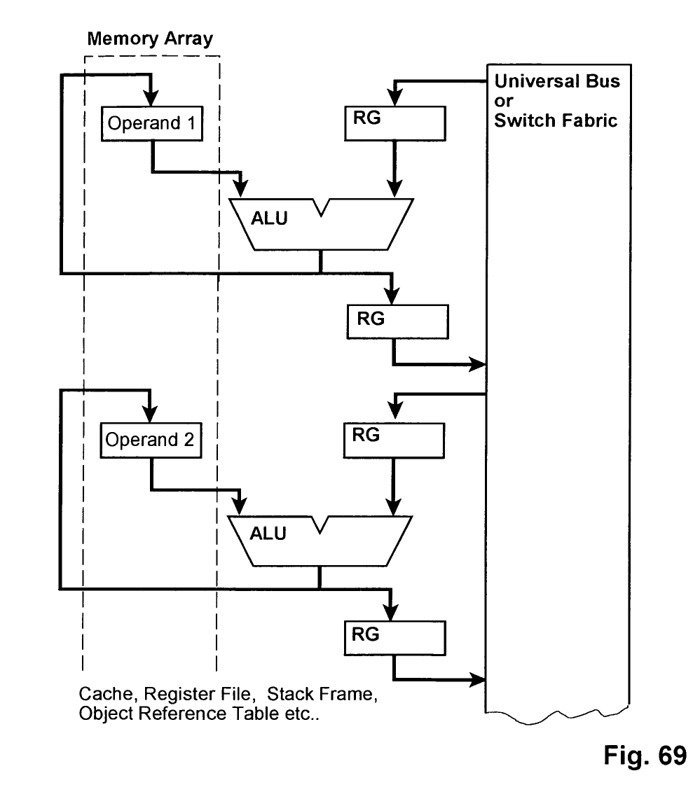

In the afore described embodiments, the processing resources are fixedly assigned to the individual memory blocks or memory cells. This results in a comparatively simple structure but requires that all data to be processed by one resource are within the same memory block. In order to eliminate this limitation, in an alternative configuration universal connecting means between the resources are provided, for example, bus systems or switching hubs. In contrast to the above described configurations, not all registers of the resources belong to the address space of the memory array. FIG. 69 shows an arrangement in which in each resource an operand register is accessible via the memory address space. The additional registers are connected to the universal connecting means. As an example, FIG. 70 illustrates a memory array provided with resources and designed to receive object reference tables. Each memory cell contains operands and is connected to processing resources, for example, with a universal ALU. Result lines of the processing resources are fed back to the memory cells so that they optionally can be used like an accumulator. Further operand registers and result registers are connected to universal connecting means, for example, to a universal bus or a switching hub (switch fabric). In this way, any operation between the register contents can be performed.

In the example according to FIG. 70, the object reference table is designed to contain the addresses of data objects but also to support calculations with the associated values. The objects are numbers whose value range is limited by a maximum value and a minimum value (compare the range declaration in the programming language Ada). Moreover, a measuring counter is provided in order to determine, for example, the utilization frequency of the object or in order to record how many programs are currently correlated with the object (reference count). In FIG. 70 the numbers have the following meaning:
80: it is possible to compute alternatively based on the address or the actual value (selection),
81: the second operand is supplied by the general-purpose connecting means,
82: the result can be fed back to the operand register or can be retrieved through the general-purpose connecting means,
83: checking the value range,
84: measuring counter,
85: sequence control.

The setting of the range limits (upper bound, lower bound), the retrieval of the contents of the counter etc. are not illustrated. However, it is self-evident that the corresponding registers are to be connected to the access paths 81 of the general-purpose connecting means or to an additional bus system (special access paths for administrative purposes and the like will be explained infra).

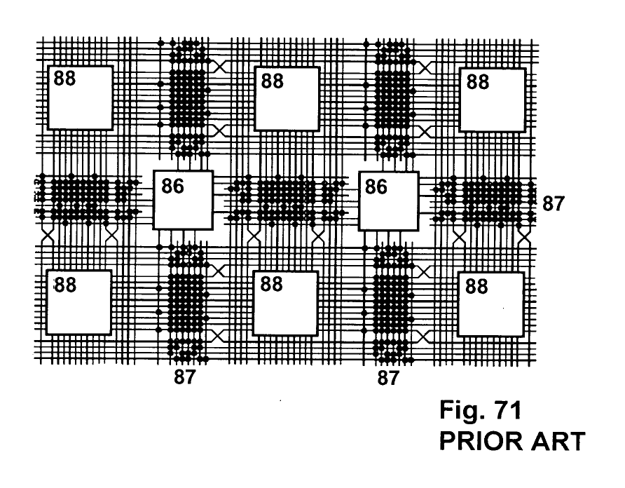

In the following, with the aid of FIGS. 71 to 79 it is illustrated how resource arrays can be incorporated into integrated circuits, preferably into programmable ones. FIG. 71 illustrates how large programmable circuits (field programmable gate arrays; FPGAs) are usually configured. They comprise programmable cells (logic cells) 86 that are connected by connecting paths 87 and switching matrices circuits (hubs 88) that are also programmable. The individual logic cells are of a comparatively basic structure. With a single cell, for example, a combinational operation with four to eight inputs and one flipflop can be realized. The hardware expenditure for programming the logic cell and the connecting network is significant. In order to implement certain functional requirements, it is often required to have more than ten times the number of transistors in comparison to “real” application-specific circuits (on which the circuitry is optimized down to the transistor).

Therefore, especially complex and frequently used functions are implemented on some FPGAs the hard (non-progammable) way (this concerns interface control etc. as well as complete processors). Such circuits are however comparatively expensive and less universal. For example, it is possible that the embedded hard processor is too large for the particular application (circuit is too expensive) or that it does not perform well enough (complex additional hardware necessary).

In order to avoid these disadvantages, resource cells can be provided that comprise processing circuits and a certain memory configuration. The resource cells are of a hard configuration (they are not comprised of programmable logic cells but of hard-wired transistors or gates). Only the function and the processing width can be set. As an embodiment a resource cell configured in accordance with FIG. 59 having the following features is assumed:
a) function: arithmetic logic unit (ALU),
b) processing width: can be set (maximally 32 bits),
c) concatenation: supported for all parameters,
d) memory: 1 k words at 32 bits.

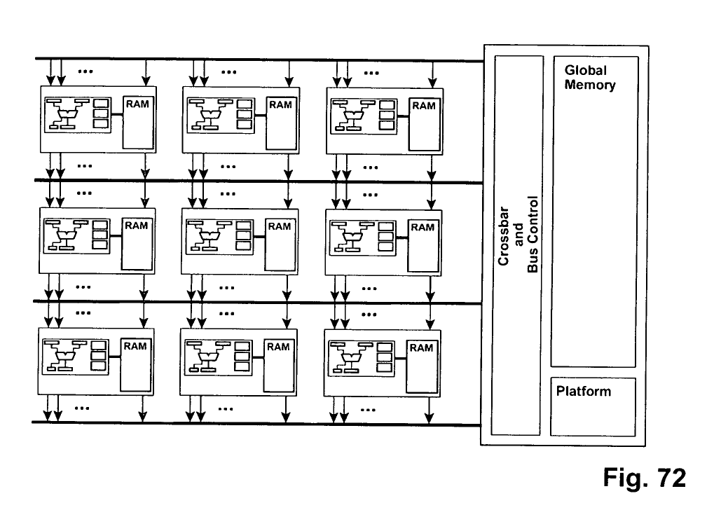

The programmable connecting paths are optimized for typical utilizations of the resources (they can be designed relatively simply because it is not necessary to support arbitrary connections between all cells on the circuit). FIGS. 72 to 78 show different arrangements of resource cells. Such arrangements can be provided in programmable as well as in application-specific circuits.

FIG. 72 illustrates the arrangement of resource cells on the circuit. The resource cells are connected to one another by bus systems. Each bus system is capable of supplying a row of resource cells with parameters and to pass on the results of the resource cell row arranged above. The bus control provides the connection between the individual bus systems. On the circuit, a common memory configuration as well as the platform circuitry are arranged.

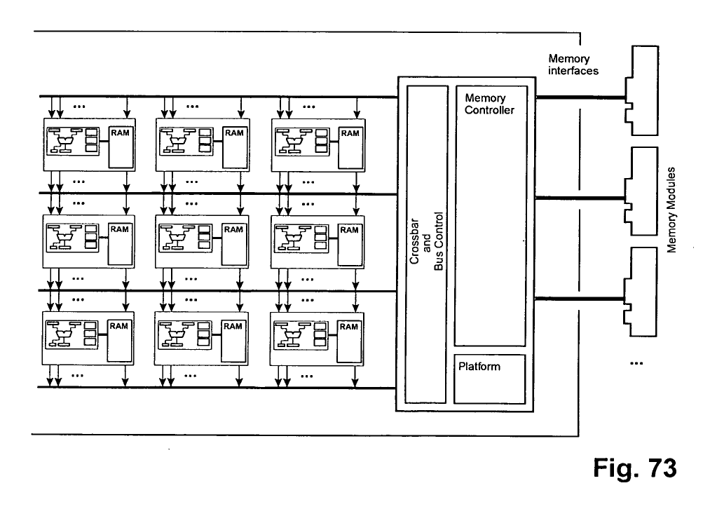

FIG. 73 shows how such an arrangement can be expanded by external memories. Often, very large memory capacities (megabytes to gigabytes) are required. It is then advantageous to utilize the mass-produced products and (outside of FPGA circuits) inexpensive memory circuits (for example, DDR-DRAMs) or memory modules. The required memory controller has a hard configuration.

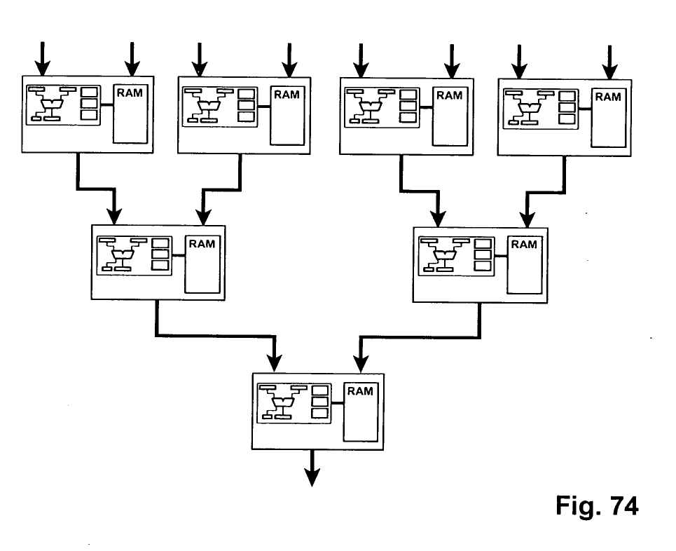

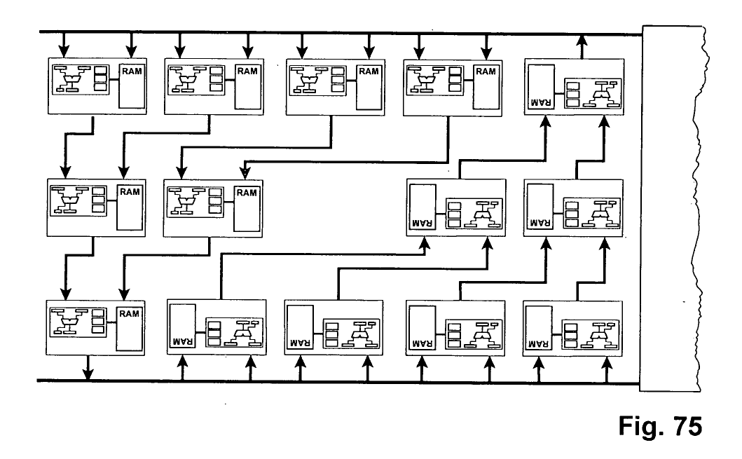

FIG. 74 illustrates an alternative for connecting by means of bus structures: the connection of resource cells as inverted tree structures (in the example: as binary trees). The evaluation of nested expressions can be easily mapped onto inverted tree structures (compare FIG. 54). The advantage: the connections between the cells of the tree structure are simple point-to-point connections. They are short and require no programming provisions on the circuit. In order to utilize the silicon real estate well, according to FIG. 75 two tree structures are arranged in opposite directions. For loading the operands and for retrieving the results, two bus systems are provided. The inputs and outputs of the sequentially arranged inverted tree structures are connected in a reshuffled arrangement to the bus systems (the first bus system is connected to the operand inputs of the first tree structure and the result outputs of the second tree structure; the second bus system is connected to the operand inputs of the second tree structure and the result outputs of the first tree structure etc.). As a result of the reshuffled and opposite arrangement, each of the bus systems is utilized in the same way for write and read access (uniform workload distribution). With regard to electrical considerations, the two bus system are also uniformly loaded (same number of connected receivers and drivers).

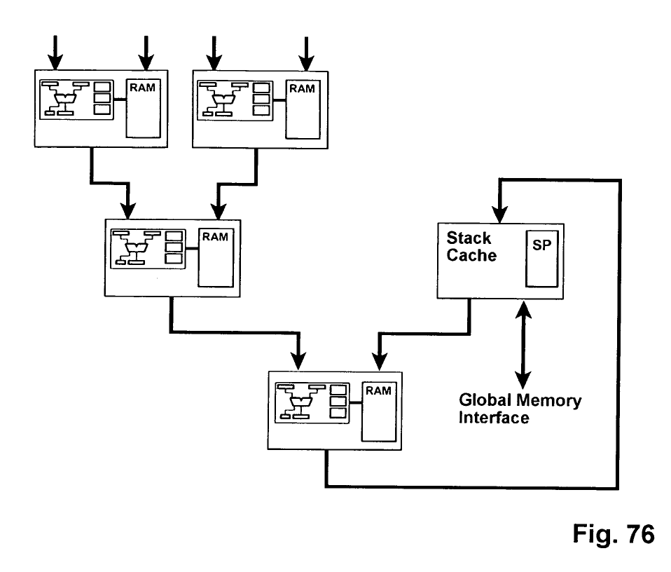

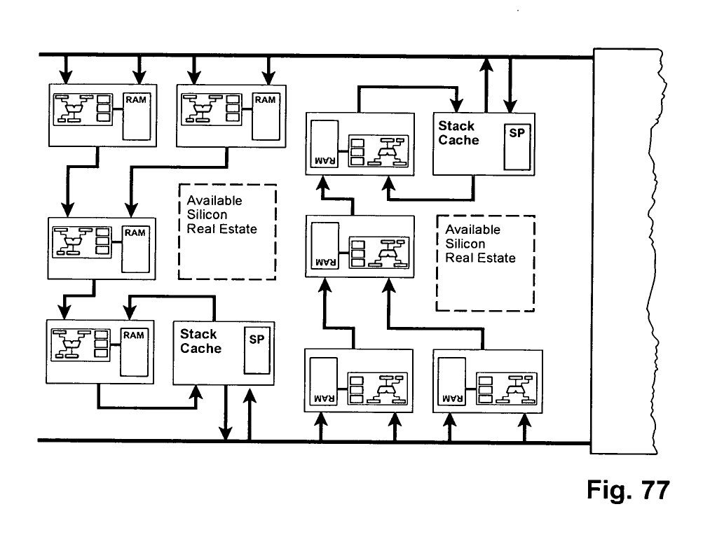

A deep tree structure cannot always be utilized appropriately. When the nesting depth of the processing operations is not too great, a combination between tree structure and stack is advantageous. The last processing device of the tree structure receives one of its operands from the stack and loads its results into the stack. In order to accelerate stack access, a stack cache is provided for each tree structure. The stack cache, for example, can be a conventional cache memory array according to FIG. 76 that is addressed by a stack pointer in the way known in the art. FIG. 77 shows that by opposite arrangement of such tree structures (compare FIG. 75), the silicon real estate can be utilized very well. The free spaces in FIG. 77 result only because the illustration is not to scale. Should such free spaces be actually present in practice, they can be utilized, for example, for larger stack cache memories.

Utilization of such circuits:
1) The application problem is described with suitable means (graphic illustrations, state diagrams, programming languages).
2) Based on this, the development environment generates a corresponding code (that requests resources, supplies them with parameters etc.).
3) Accordingly, a circuit with matching resource configuration is selected and the code is modified accordingly.

Conventionally, the developer must decide which functions are to be solved by software (on an embedded processor) and which by hardware (=programmable logic). In this context there is no such separation. Instead, by the development environment and—at run time—the incorporated platform, a purpose-oriented resource configuration is generated and modified as needed dynamically (processors are generated as needed (on the fly) and are optionally dismantled.

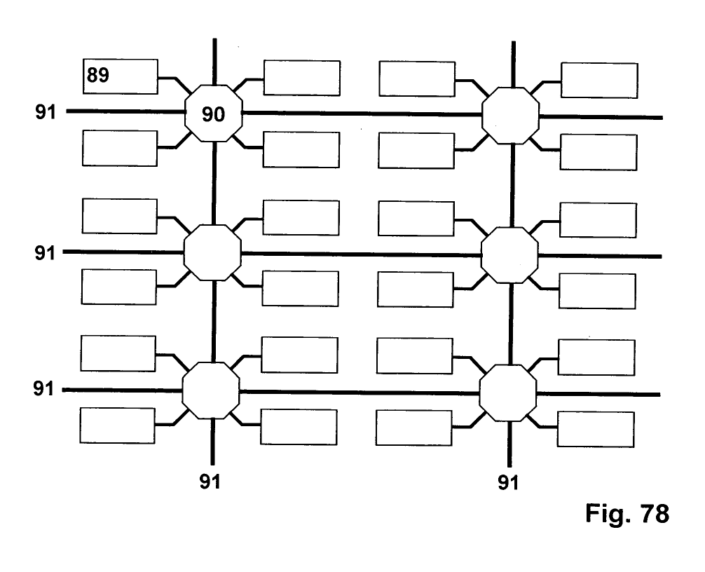

General-purpose high-speed interfaces that are coupled by switching hubs with one another are an alternative to bus structures. They are supported inter alia in different FPGA circuits. FIG. 78 illustrates the configuration of a circuit whose resource cells 89 are connected by point-to-point interfaces to hubs 90 that, in turn, are connected by programmable (global) signal paths 91 with one another.

General-purpose hard resources (for example ALU structures) are not suitable for certain application tasks. Therefore, it is often expedient not to allocate the entire circuit with hard resource cells (for example, according to FIG. 72) but to provide areas with conventional programmable logic cells in order to be able to build as needed arbitrary processing and control circuits. Such arrangements however cannot cooperate easily with other (hard) resources. Therefore, these cell areas are surrounded by hard interfaces that correspond to those of the hard resource cells (parameter registers, concatenation hardware, bus interfaces etc.).

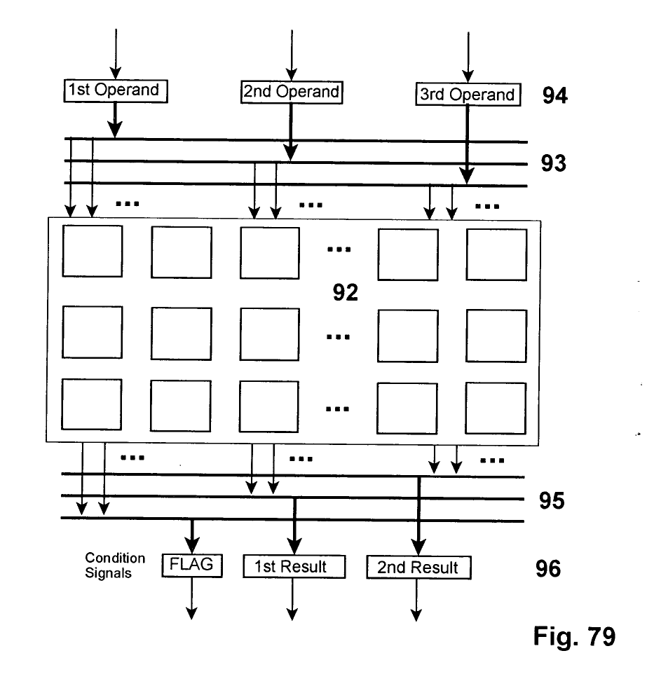

FIG. 79 shows a corresponding programmable (soft) resource cell 92 that is comprised of programmable logic cells with programmable connections. Its inputs are connected by programmable signal paths 93 to hard resource interfaces 94 (for example, several operand registers) provided at the input side. Analogously, the outputs are connected by programmable output signal paths 95 to hard resource interfaces 96 at the output side, for example, to some result registers and to an operating register. Such soft resource cells are connected like the hard resource cells to the signal paths of the circuit, for example, by means of the bus systems illustrated in FIG. 72 (the inputs of the operand registers (resource interfaces 94) are connected according to FIG. 72 to the upper bus system, respectively; the outputs of the result registers (resource interfaces 96) are connected to the lower one, respectively). All registers of the resource interfaces 94, 96 are provided with corresponding access provisions and concatenation provisions (state register, pointer register, concatenation control circuitry etc.; compare FIGS. 49, 51 and 56). Since hard circuits are concerned, these auxiliaries require only comparatively little silicon area.

There are FPGA circuits in which the programming data of the logic cells and of the connecting signal paths are held in RAM structures. Conventionally, they are programmed anew after each power-on (by loading the RAM content) before actual operation begins. During operation (at run time) reprogramming is not possible. In contrast to this, circuits that are provided with hard resource cells can be designed such that they can be reprogrammed even at run time (because the structure comprised of hard cells, for example, according to FIG. 72, remains unchanged while the soft cells can be reprogrammed). Reprogramming can be initiated by s-operators (making available resources), u-operators (resource administration) as well as c-operators and d-operators (concatenation). For this purpose, the programming signal paths of the soft cells in question are to be connected to corresponding hard structures, for example, to a platform device (can be arranged on the circuit or outside the circuit).

Subsequently, with the aid of FIGS. 80 to 85 an overview of the resource administration will be provided. At compile time as well as at run time it is sometimes required to administer the resources that are present in systems according to the invention. For this purpose, detailed information is required in regard to:
the resource types available in the system,
the properties of the individual resource types,
the states of the resources that are present (how many are present of each type, how many of them are available etc.),
the resources assigned to the individual running program (task, thread, process or the like).

It is obvious to arrange this information in table structures. Similar tasks are present for administration of a virtual memory, in file systems, during compiling of programs etc. The configuration of table structures and the corresponding access methods are general knowledge in the field of computer science. Therefore, a brief description with the aid of examples should be sufficient in this context. Table entries can be realized in different ways:
by name (character string),
by a sequential number (ordinal number),
by an address.

The following description refers to access by means of sequential numbers (ordinal numbers) of the entries. This type of access is only slightly slower than direct addressing (it is sufficient to carry out a simple calculation in order to determine the address based on the ordinal number). The table structures can be supplemented without problems in order to support the access by name. Appropriate methods are known in the field of computer science. Corresponding functions are provided in any assembler or compiler. Therefore, they must not be described in detail in this context. There are three types of tables: the resource type table (one in the system); the resource pool table to be provided as necessary (one for each resource type); and the process resource table (one in each running program (process, task, thread).

The resource type table contains the descriptive information and the administrative information in regard to the individual resource types. It has one entry for each resource type. Such an entry contains:
1) a general type identifier,
2) information regarding the parameters (operands and results),
3) administrative information.
   The information regarding the parameters contains
1) the number of parameters,
2) a description of each individual parameter.
   The administration information comprises:
1) the number of all resources of the particular type,
2) the number of actually available resources,
3) the state of each individual resource; in the simplest case, one bit for each resource is sufficient in order to differentiate between the states “available” and “unavailable”; sometimes it is advantageous to also provide a reference to the program in which the resource is used presently.

The administration of the resources corresponds substantially to the administration functions that are required in a file system or a virtual memory organization. This concerns, for example, finding a suitable free resource when executing an s-operator. Corresponding principles are within the general knowledge of computer science.

Each parameter is described by the following information:
1) type identifier,
2) type of parameter (operand, result or both),
3) information in regard to the concatenation control,
4) the length in bits.

Optionally required working (scratch) areas of the resources (compare FIG. 5) are described with special parameter information.

FIG. 80 provides an overview of the contents of a resource type table:
a) The resource type table as a whole; each resource type has one entry.
b) The contents of an entry: type identifier, description of parameter, administrative information.
c) Elementary administrative information concerns the number of available resources of this type and provides information in regard to which of these resources is available. For example, this is recorded in a bit string (one bit per resource).
d) The parameter description as a whole. Each parameter has an entry.
e) The contents of an entry: type identifier (elementary types are, for example, binary numbers and floating point numbers), type of utilization, length, structure description (as needed). Initially, the length is provided generally in bits, independent of the structure. This supports first decisions for providing memory space, for transport through the bus systems, interfaces etc. (all parameters are in the end bit strings that must be transported and stored). Complex parameters have additionally a structure description.
f) The utilization of the parameter is described as follows: one bit each for the basic utilization (operand or result or both) as well as concatenation information (characterizes whether a concatenation is possible at all and provides the type of concatenation).

Since the resources are configured differently, there are table entries of different length. In computer science, there are many solutions to problems of how to arrange such tables in practically manageable data structures. Therefore, a brief description of an exemplary embodiment will suffice in this context.

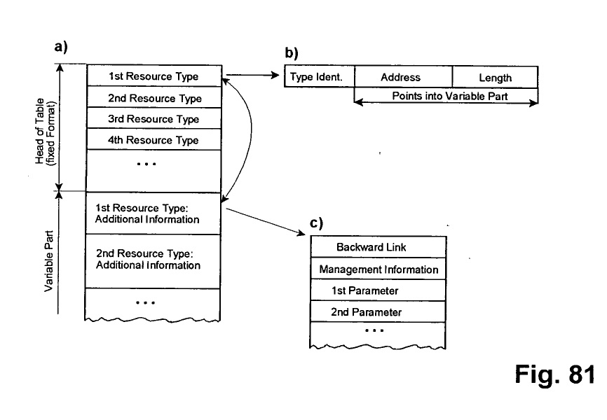

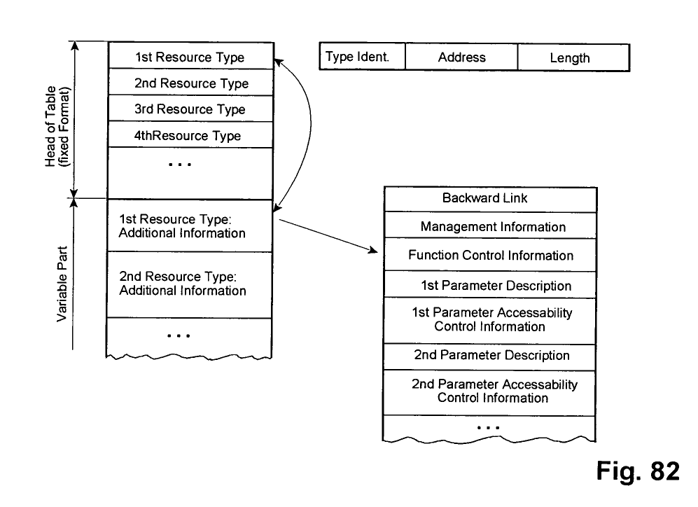

The tables are comprised of a header that contains for each table entry a fixedly formatted information. The table entries can be directly addressed. The header is followed by a variable part in which the remaining information is stored. Each entry in the table header contains a pointer that points to the corresponding area in the variable part. At the beginning of each area a backward link (reference) to the table header is provided in order to support administration of the variable part (FIGS. 81, 82).

FIG. 81 shows one example for a corresponding formatting of the resource type table:
a) shows the table structure as a whole;
b) shows an entry in the table header; in the example, it contains only a descriptor that describes the correlated area in the variable part (address pointer, length information); other implementations can contain further fixedly formatted information, for example, in regard to the number and availability of the resources;
c) illustrates how one area of the variable part looks like; it contains the additional information to the resource type (compare FIG. 80).

The parameter entries can contain additional information for supporting the resource utilization and administration. In the following, with the aid of FIG. 82 two examples (function control information; accessibility control information) will be explained briefly.

Function control information serves to set general-purpose resources that are able to provide several functions to the respectively required function. They are two principles of function control.
A. The general-purpose resource is requested by means of s-operator and, by entering corresponding control information (for example, by p-operators or u-operators), is set to the respective function. For example, a universal ALU is requested and by means of p-operator set to 16-bit operand width and to adding.
B. The individual functional variants are administered as separate resources. There are, for example, 8-bit adders, 16-bit adders etc. as well as specific resource types. When by means of s-operator, for example, 16-bit adders are requested, a universal ALU (for example, according to FIG. 47) is made available and configured automatically (as an additional function of s-operator) as a 16-bit adder.

In the second case, logic and physical resources must be differentiated. Both types are listed in the resource type table. When the s-operator requests a logic resource (for example, a 32-bit adder), it will find an entry that references the respective physical resource (for example, a general-purpose 64 bit ALU). This reference is contained within the function control information. Here it is also indicated in which way the physical resource must be configured (for example, by function codes that are to be loaded into certain registers).

Accessibility control information concerns special operations that are required in order to transfer parameters into the resources or to fetch them from the resources. The respective operators (p, a, l) must initiate, depending on resource and the parameter, different control actions (for example, certain bus systems or point-to-point connections must be utilized, registers must be addressed etc.). This holds true analogously for the concatenation operations. Appropriate information can be stored in the resource type table. This information can be, inter alia:
1) access control words, microinstructions or microinstruction sequences that control certain signal flows in the hardware,
2) sequences of elementary machine instructions (transport routines),
3) pointers relating to corresponding transport routines,
4) address information (for example, bus addresses of the hardware).

If needed, for each access type (p-operator, a-operator, l-operator, concatenation) special information can be provided.

It can also happen that each individual resource is accessible in its own fashion (for example, at a special address) so that not all resources of one type can be treated generally in the same way. It can then be expedient to provide for each resource type additionally a resource pool table that contains the corresponding information in regard to each individual resource. Principle:
the general parameter descriptions (type, length etc.) are provided in the resource type table;
the state information and accessibility information are listed in the resource pool table; they can optionally supplemented by additional administrative information (providing information in regard to the utilization frequency, the number of accesses etc.).

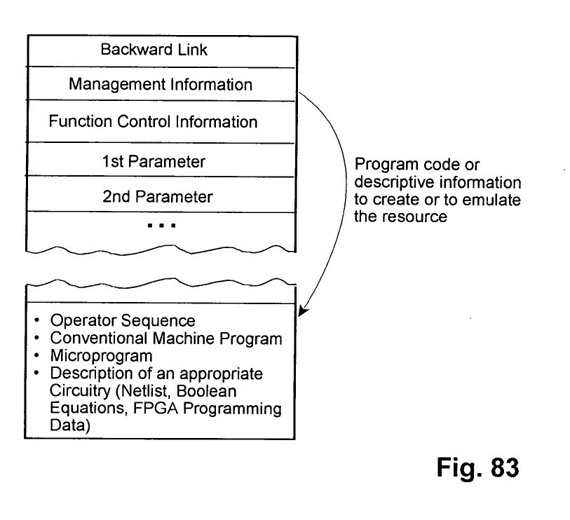

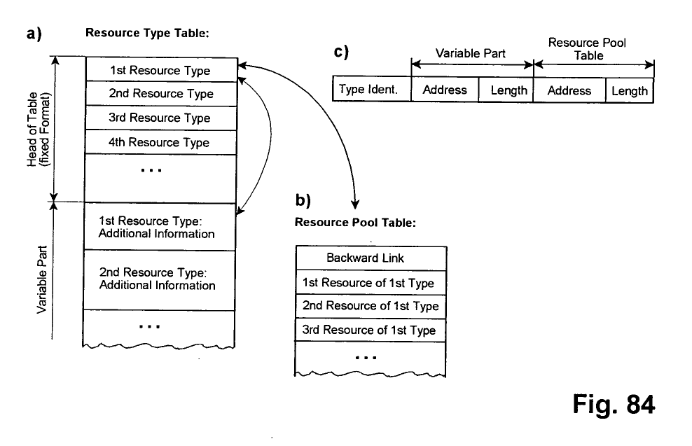

Some resources are combined of other resources (recursion), some are not at all present as hardware. Their function is instead emulated by the program (emulation, simulation). In addition, resources can be generated on corresponding programmable circuits as needed. The required information can be stored, for example, according to FIG. 83, in the resource type table. FIG. 83 shows an entry in the variable area of a resource type table according to FIGS. 81 and 82. The entry is extended by an area that contains the operator code for building the resource from simple resources (recursion), a machine program or microprogram (emulation), or a corresponding circuit description (netlists, Boolean equations, FPGA programming data or the like). The administration information of the corresponding resource types contain a descriptor describing this area (beginning, length). The operator codes, machine programs etc. stored therein are typically templates with space holders that are filled as needed with resource numbers or addresses (machine independent or logical coding). Example: a resource is composed of four other resources. The stored operator code addresses these resources by means of sequential numbers 1, 2, 3, 4. Now, such a resource is to be built actually. As components, the resources No. 11, 19, 28, and 53 are available. The operators must now address resource 11 instead of resource 1 (replacement of the logical resource numbers by the physical resource numbers). FIG. 84 shows a resource pool table in connection with the resource type table:
a) resource type table similar to FIG. 81,
b) a resource pool table is available for each different resource type and contains individual information in regard to the individual resources,
c) the entries in the header of the resource type table contain two descriptors, one for the area in the variable part of the resource type table and one for the corresponding resource pool table.

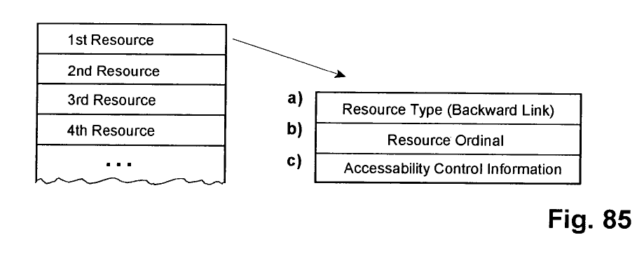

The process resource table describes the resources that are requested (see FIG. 85) by the respective running program (process, task or the like). Each of these resources has an entry. This entry contains:
1) the resource type (backward link (reference)),
2) the ordinal number (sequential number) of the resource of the corresponding type,
3) accessibility control information, for example, memory or hardware addresses, microinstructions or pointers in regard to transport routines; such information is taken, as the function of the s-operator, from the resource type table or the resource pool table and is optionally modified (in that, for example, logical addresses are replaced by physical addresses).

For a software solution (emulation), the accessibility control information is typically a pointer into the resource emulation area. This is the memory area that contains the parameters as well as optionally required working areas (compare FIG. 5). Often a single pointer is sufficient because the parameters are addressed sequentially. However, sometimes a separate pointer information for each parameter is required.

The tables are typically utilized in the following way: the s-operator accesses the resource type table and finds therein an available resource. A sequential number (ordinal number) is assigned to this resource. Optionally, the required control information is set up (function, operand width etc.). The information required for the additional operators are transferred into the process resource table. The sequential number of this entry provides a further ordinal number by which all other operators are related to this resource.

Example:
1) A 16-bit adder is required. Call: s (ADD_{—}16). This resource type will be assigned the ordinal number 25. Therefore, the s-operator in symbolic machine code is s(25).
2) The s-operator finds that the resource No. 6 of this type is available.
3) The resource is characterized as being used (busy). Optionally, the resource is initialized by entering function settings for the required processing function.
4) The resource is entered in the next free position of the respective process resource table (resource type 25, resource No. 6, etc.). The 11th position of the process resource table be free. Accordingly, the ordinal No. 11 is assigned to the resource.
5) All p-operators, y-operators etc. relate to resource No. 11 and access with this value the process resource table in order to obtain physical addresses and other accessibility control information.

In practice, these operations typically are performed at compile time and (partially) at loading. Executable machine programs contain physical resource addresses and other accessibility control information; they must not access tables.

In the case of software-based emulation, the address resolution at compile time is as follows. The s-operator accesses the resource type table and fetches the memory requirement (within the resource emulation area). The process resource table is used only temporarily during compiling. The operation is stored within the resource emulation area. Accesses at run time are carried out only by “conventional” (=determined by the compiler) addresses (all accesses at run time refer to addresses in the resource emulation area). The resource emulation area can be arranged optionally in hardware registers (compare FIGS. 64 to 66).

There are variants of the s-operator by which very specific resources can be addressed, for example, the adder No. 22 or the special processor MAX by IP address 123.45.67.89.

In order to be able to determine the format of the table structures, descriptive information etc., it is necessary to know how many resources, parameters etc. are to be taken into account. The systems of the present invention differ inter alia in how many resources are available, respectively. There are basically two types of numbers with regard to the size of the resource pool:
A. Finite. Such numbers have a fixed upper bound. The upper bound is valid for a certain implementation. Example: a processor with 16 processing units. Accordingly, no more than 16 processing resources can be assigned at the same time.
B. Transfinite. The number of resources is limited only by the limits of the addressing capability of the descriptive data structures.

When resources are emulated by software, the number can be essentially transfinite. It is limited only by the size of available memory (resource emulation area); s-operators and r-operators control only the allocation of the emulation area. Details of the administration methods are a matter of system optimization. This concerns the well-known problem in computer science of administering free memory space including the so-called garbage collection, i.e., to make available again for utilization memory areas released piece by piece or to provide by appropriate data transport a single contiguous free memory area. An administration strategy could be that garbage collection is initially not used, i.e., with each s-operator only presently available memory space is assigned and the function of the r-operators is limited to simply registering the released memory area. A garbage collection takes place only at characteristic points in the program operation, for example, when a certain program branch actually terminates and is not executed again. The memory administration could be, for example, supported by corresponding h-operators and u-operators.

When resources are actually implemented as hardware, their number is essentially finite. Each individual resource must be administered (at least it must be stated whether it is available or not).

A few examples for address length, numbers etc. as they are encountered in practice will be given:

a) Analogy to conventional superscalar machine:

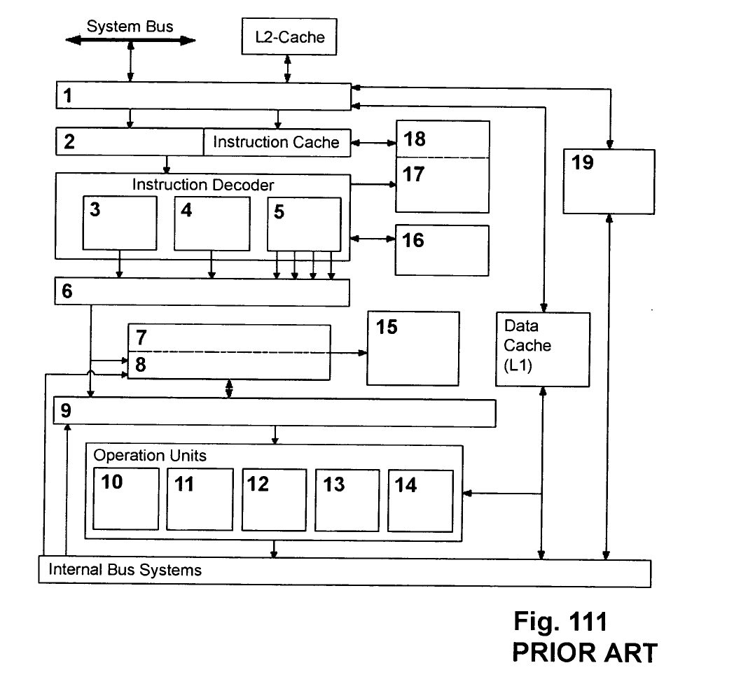

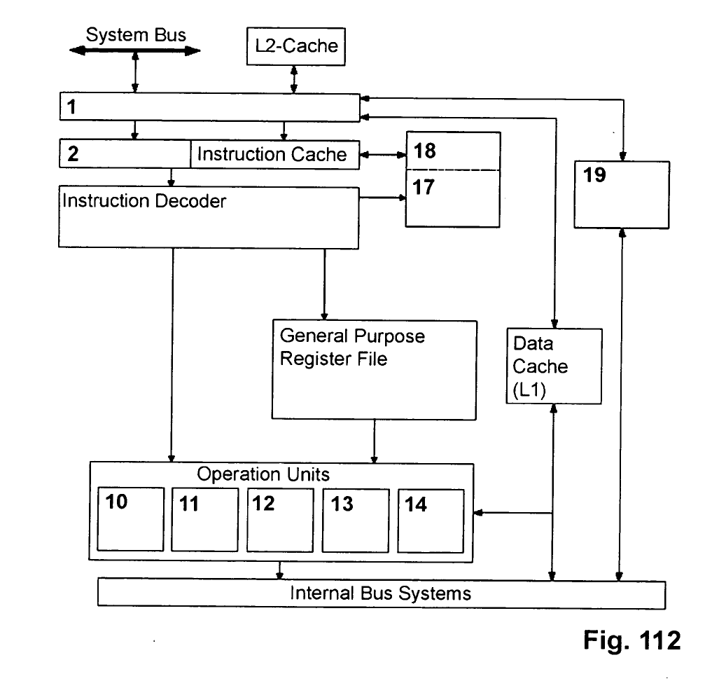

1) 64 to 256 resource types (=hardware for performing machine instructions);
2) maximally 4 to 8 parameters; simple operations generate from two operands a result plus a condition indication (flag bits); some operations that are usually considered to be elementary, require a few more parameters; this concerns, for example the multiplication and division of binary numbers (compare FIG. 48 and Table 2);
3) 16 to 256 active resources (conventional superscalar machines have typically 4 to 16); future large-size circuits can contain, for example, 4 to 16 conventional processors whose resource configuration corresponds to 4 to 16 processing units, respectively (compare infra the explanations in regard to FIGS. 111 and 112).
   b) Massive parallel processing with conventional operations:
1) 64 to 256 resource types (=hardware for performing machine instructions);
2) maximally 4 to 8 parameters (compare item 2) above);
3) number of active resources: transfinite (reference value: 1 k to 64 k).
   c) Emulation:
1) number of resource types, transfinite,
2) number of active resources, transfinite,
3) parameters: different stages, for example, 4, 8, 16, 32, 64, 512, 4 k, transfinite; experience has shown that more than 4 k parameters practically do not occur; most functions have fewer than 64 parameters.

Transfinite means in this context that it must be assumed that the complete utilization of the value range or address space in accordance with the processing width will occur, i.e., 2¹⁶ in a 16-bit machine, 2³² in a 32 bit machine etc. In machine-independent coding, the complete bit number according to processing width and address space is to be used (16, 32, 64 bits etc.). Machine-specific codes on the other hand may have appropriate limitations (e.g. 40 instead of 64 address bits).

In the following, an overview of further problems of resource administration will be presented.
A. Numbering of resources. The resource numbers (ordinal numbers) are assigned when selecting the resources (s-operator). All further operators then refer to the assigned numbers. Typical problems of the assignment:
   a) utilization of resource numbers as addresses (conversion of these numbers into addresses or into other accessibility control information of the hardware, for example, in access control words),
   b) treatment of resources that have been released in the meantime (r-operator).
   Different methods can be utilized:
   a) the resources are sequentially numbered when selected from the resource pool (s-operators),
   b) numbering can be controlled by u-operators (for example, by setting an initial value),
   c) the ordinal number or address information is included in the s-operators (s_a operators): s_a (resource type => resource number or address).
B. Numbering and release (r-operator). Typically, it is not expedient to react to each release by changing the numbering (administrative overhead). The alternative: sequential numbering in the s-operators is continued independent of whether in the meantime resources have been released or not. Released resources can be reassigned without problems; they simply obtain the higher sequential numbers (ordinal numbers). Numbering begins anew only when the actual resource assignment has been completely released (for example, at the end of the program).
C. Building and releasing resources. There are obviously no advantages to request resources individually, to use them and released them immediately. In order to utilize the inherent parallelism to the maximum, it would be best to request all resources required for a certain program at once and to operate them in parallel as much as possible (the program begins with an s-operator that requests all required resources and ends with an r-operator that releases all resources). However, this is not always possible (limited number of hardware resources, limited memory capacity). Therefore, the resource utilization is to be organized essentially piece by piece. Obvious separating locations where a complex program can be divided into easily manageable blocks are inter alia:
   a) individually compiled program pieces including the functions called therein,
   b) regular program constructs (conditional statements, loops etc.),
   c) program blocks (that which in conventional programming languages is between BEGIN and END or between curly brackets) including the functions called therein,
   d) base blocks (linear sequences of data transports and operations a base block ends with a branch or with a function call); base blocks in conventional machine languages comprise typically fewer than 10 instructions.
   For the respective program piece all resources are requested, utilized and released again. A simple assignment method resides in that one starts with the base blocks. When resources are still available after the current base block has been supplied, the subsequently called function can be taken into consideration, for example.

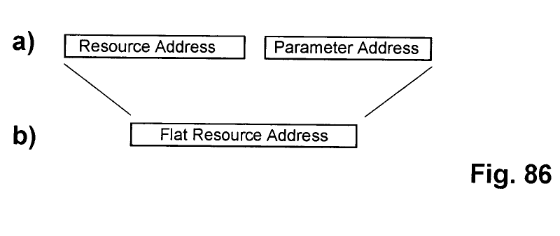

Subsequently, with the aid of FIGS. 86 to 95 more details of resource addressing will be explained. It is general knowledge in the art to operate only at compile time with ordinal numbers but at run time with address information. In byte codes and machine codes resources and their parameters are to be addressed. Two variants of address space are available (FIG. 86):
a) split resource address space: independent addresses for the resources and for the parameters within the resource,
b) flat resource address space: a single address that indicates a certain parameter within a certain resource.

FIG. 86a illustrates a split resource address space. There are two types of addresses: one selects the respective resource (resource address) and the other the parameter within the resource (parameter address).

Advantages:

Most resources have only a few parameters (reference value: 3 to 8). When the resource address is correspondingly buffered (for example in state buffers (buffer registers)), only the parameter addresses must be moved along in many operators (code shortening).
Shorter address information in y-operators and r-operators.
Simplified address decoding in the interior of the resource (compare conventional solutions in conventional microcontrollers, peripheral circuits etc.).
Addressing in the interior of the resources is independent of which other resources must be supported.
   Disadvantages:
Complex machine codes (because two address types must be supported.
Buffer registers or other state buffers are required.
When resources with very many parameters are present, the parameter address becomes long, also for all those resources that have only a few parameters. When different parameter address lengths are provided to solve this problem, the machine code becomes more complex.

There are two possibilities for configuring the parameter address in the split resource address space:
A. Independent addressing of operands and results. As a function of the respective operator, the parameter address concerns either an operand or a result. In p-operators operands are addressed; in a-operators results are addressed. In l-operators, c-operators, and d-operators, the first parameter address concerns a result and the second one an operand, respectively. When the function code is set up at the time of selecting the resource (s-operator), the corresponding memory means (for example, function code register) must be addressed only in corresponding instructions or u-operators. The y-operator typically must address only the resource; a parameter address is not required.
B. Unified addressing of operands and results. The parameter address concerns all parameters.

Independent addressing typically saves one bit for each address information. Example: there are 4 operands and 3 results. Independent addressing requires 2 bits, unified addressing 3 bits. However, this requires sometimes a higher expenditure with regard to hardware: not only the address must be taken into account but also the type of utilization (which, for example, would have to be transmitted in a bus system via special lines). Special functions would have to be optionally considered in the machine code (for example, special variants of the c-operators and the d-operators would have to be provided for supporting the input concatenation).

A further possibility of code shortening results in that the resources typically have more operand parameters than result parameters. Accordingly, optionally the address length can be designed to be shorter for results than for operands.

FIG. 86b illustrates a flat resource address space. There is a single address space in which a certain address is assigned to each parameter of each resource (sequential addressing).

Advantages:

simple machine code;
unified linear address space has been a proven architecture principle for a long time;
a sufficient address length enables support of arbitrary mixtures of resources with arbitrary numbers of parameters in a simple way.
   Disadvantages:
sometimes higher memory demand for the machine code (because of longer address information);
sometimes more complex address decoding (in the hardware) because for each individual parameter the address must be decoded in full length; when only address ranges are decoded in order to simplify the decoder hardware (compare PCI bus), unsatisfactory utilization of the address space can result (which can lead to the problem of having to extend the addresses even more);
sometimes administration difficulties (overhead) when resources are selected and released at run time (dynamic resource administration).

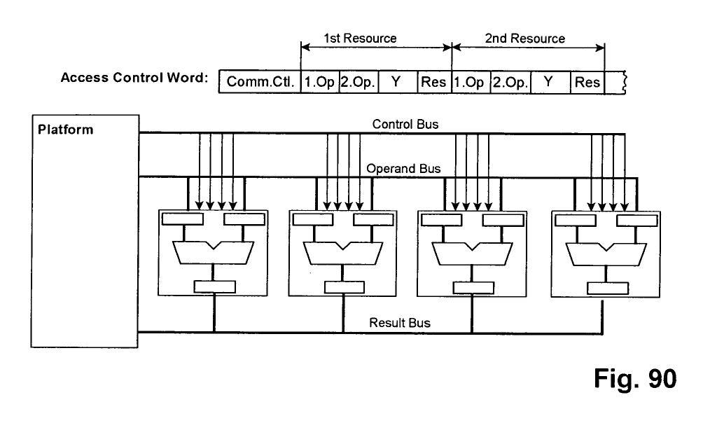

Embodiments of resource addressing:
a) there are only resources with comparatively few parameters (split address space);
b) there are only resources of the same type: split address space or activation by access control words (compare the explanations in regard to FIG. 90 infra);
c) mixed resource allocation (including resources with comparatively many parameters): flat address space.

Depending on the system configuration, technology and application, different sizes of resource address spaces will result (Table 4 contains a few examples):
A. Systems with transfinite number of resources (that optionally can be requested in huge numbers). Preferable utilization: as virtual machines for program development and program optimization. This relates to detecting the inherent parallelism as much as possible (i.e., across the entire program without limitation by missing hardware) and to find out how a concrete architecture with limited number of resources and further restrictions (SIMD, VLIW etc.) can be used expediently.
B. Systems with, in the end, finite (and technically realizable) hardware configuration (for example, on FPGA circuits). The number of registers cannot surpass certain limits. In the case of fixed configurations, it is possible to assign the register addresses in the design phase (compare register addressing in conventional circuits). In program-controlled configurations the resources can have assigned special configuration registers through which the respective addresses can be set (compare addressing of the bus systems with plug-and-play support).

C. Realization by means of software (emulation). The number of resources can be considerably large (question of program optimization).

TABLE 4

| resources | parameter | address length¹⁾ | | remarks |
|---|---|---|---|---|
| 4 | 4 or 8²⁾ | 4 or 5 | bits | superscalar machine of conventional |
| | | | | size |
| 32 | 4 or 8²⁾ | 7 or 8 | bits | expanded superscalar machine, |
| | | | | software solution on microcontrollers |
| 64 | 4, 8 or 16^{2),3)} | 8 to 10 | bits | expanded superscalar machine, FPGA, |
| | | | | software solution on microcontrollers |
| 256 | 8 or 16^{2),3)} | 11 or 12 | bits | FPGA, software solution on |
| | | | | microcontrollers |
| 1024 | 8 or 16^{2),3)} | 13 or 14 | bits | FPGA (very large), parallel processing |
| | | | | system, software solution on |
| | | | | microcontrollers or the like |
| 64k | 16 | 20 | bits | run time environment on high- |
| | | | | performance computers; compiling |
| | | | | target e.g. for conventional C-programs |
| 1024k | 64 | 26 | bits | software solution |
| Remarks to Table 4: | | | | |
| ¹⁾The number of bits that are required for address encoding (number of resources (resource address) + Id number of parameters (parameter address)). | | | | |
| ²⁾Simple arithmetic logic units (compare FIG. 47) do not have more than 3 operands ( A, B, function code) and 2 results (C, flags). When the function is fixedly initialized at the time of selecting the resource | | | | |
| # (s-operator), only two operands (A, B) must be addressed. It is then possible to only use one bit for split addressing and two bits for unified addressing. When the function code is provided as a parameter, in the case of | | | | |
| # unified addressing 3 bits are required and in the case of split addressing 2 bits for the operands and 1 bit for the results are required. For addressing a more powerful arithmetic logic unit (compare FIG. 48), typically 3 bits | | | | |
| # are sufficient. For a corresponding configuration (function code is no parameter, some of the memory access operations mentioned in Table 2 are eliminated) it is possible to use only 2 bits, respectively, for split addressing | | | | |
| # (operands A, B, C, D: results X, Z; flags), | | | | |
| ³⁾By means of an additional address bit up to 16 parameters can be addressed. This is sufficient for many special processing units and for resources that correspond to typical functions in C programs (most of these | | | | |
| # functions have fewer than 16 parameters). | | | | |

In addition to the resources and their parameters, the variables to be processed must be addressed. The variables are typically contained in the memory devices of the platform. They are transported as operands into the resources or overwritten with the results of the resources. Such transports are carried out by the platform (p-operators and a-operators), but can also be carried out by corresponding resources. Usually it is sufficient to design the variable addressing by the platform in such a way that the access principles that are conventional in the run time systems of the conventional higher programming languages (i.e., address computation scheme base+displacement wherein as a base address register at least one frame or base pointer (FP/BP), a stack pointer (SP), and a further pointer register is provided) are supported.

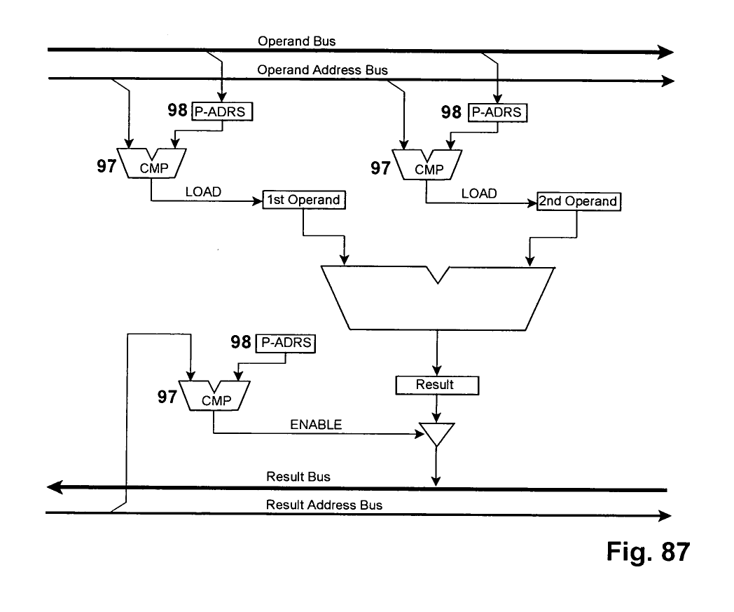

The addressing in the hardware is explained in more detail in the following with the aid of FIGS. 87 to 90. Each parameter corresponds typically to a register. Address information is basically in the form of ordinal numbers (selection of the 1st, 2nd, 3rd register etc.). Often, it is sufficient to assign fixed addresses to the individual registers. The implementation of address decoders has been known for long time. Simple address decoders, inter alia, can be AND gates that are connected (directly or inverted, respectively) to the respective address lines or comparators that are connected to the address lines and to address setting means which provide the corresponding address values (compare I-O circuitry of microprocessors, plug-in cards for bus systems etc.). One alternative to this is the central address decoding in the platform. All address decoders are located in the platform; the load control inputs of the memory means at input side and the output enable inputs of the memory means at the output side of the resources are connected to the address decoder of the platform.

FIG. 87 illustrates the parameter addressing in a hardware resource. Each parameter register has an address comparator 97 with address setting means 98 arranged upstream. This is a fixed address setting or an address register that can be loaded by configuration access cycles. The outputs of the address comparator 97 are connected to load control inputs of the operand register or to output enable inputs of the result register. The destination of the parameter that is to be overwritten is laid onto the operand address bus, the source of the parameter to be read is laid onto the result address bus. When one of the address comparators 97 recognizes that the supplied address corresponds to the set address 98, the corresponding access function is carried out (loading of an operand register from the operand bus, driving result data onto the result bus).

FIG. 88 shows the parameter transport between two resources with the aid of an I-operator. The resources are configured in accordance with FIG. 87. The result of the resource B becomes the first operand of the resource A (l-operator). The sequence in detail:
The source address (SOURCE) is laid onto the result address bus. The corresponding address comparator 97 in resource B is activated. As a result of this, the content of the result register is driven onto the result bus.
The destination address (DEST) is passed to the operand address bus. The corresponding address comparator 97 in resource A is activated. As a result of this, the data on the operand bus are loaded into the respective operand register.

The principle can be applied analogously to serial interfaces that are connected, for example, to switching hubs. The conversion of conventional bus protocols into protocols of a bit-serial high-speed transfer is general knowledge in the art (compare e.g. PCI Express).

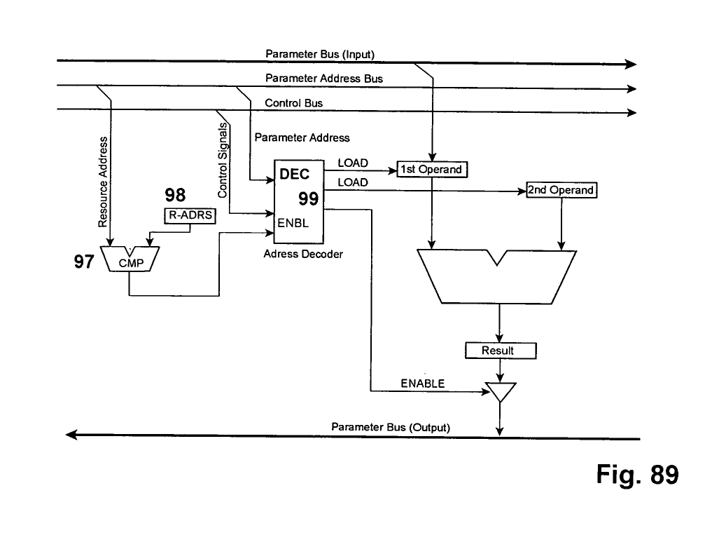

FIG. 89 illustrates the configuration of a resource for parameter addressing by means of a split address space. The arrangement comprised of address comparator 97 and address setting means 98 is present only once within the entire resource. The address comparator 97 is connected to the resource address. Its output is connected to the enable input of the address decoder 97 that is connected at the input side to the parameter address. The outputs of the decoder are connected downstream to the load inputs and output enable input of the parameter registers. For simplifying the illustrations, a solution is presented that has a common address and control lines for input and output (parameter address bus, control signal bus). The data paths can be combined in a bidirectional data bus (compare the typical bus systems of microprocessors). In FIG. 89 the decoding of a unified parameter address is illustrated. For this purpose, a single address decoder 99 is provided that has arranged downstream the operand registers as well as the result registers. For decoding split parameter addresses two address decoders are required, one for the operand registers and one for the result registers. The enable inputs of these address decoders must be connected additionally to the respective access control signal.

FIG. 90 shows an alternative configuration. The resources are not activated by a binary address but by access control words. This can concern the operation initiation (y-operator, concatenation) as well as parameter transfer. An access control word acts at the same time on several resources. In one such control word the functions of several operators according to the invention can be combined. If this principle is applied to the last extreme, a control word can initiate all transport and processing operations that can be performed actually at the same time in all resources. In the example of FIG. 90 the access control word has one bit position for each resource and operation. The function of the individual bits is as follows:

1.Op: entering parameter of operand bus into the first operand register of the resource,

2.Op: entering parameter of operand bus into the second operand register of the resource,

Y: initiating operation,

Res.: result is driven onto result bus.

These bits have a common control field Comm.Ctl. arranged upstream. Here the following functions are encoded:
1) driving data word for memory onto the operand bus,
2) storing result,
3) driving result from the result bus onto operand bus,
4) selecting the next control word (inter alia by branching or subroutine call).

In FIG. 90 one of the simplest system structures (one bus system with two data paths) is illustrated. At one time only one operand and one result can be transported. The operand can be input at the same time in any number of resources. Higher developed systems can have several bus structures or switched point-to-point connections. The control words contain address fields instead of the individual bits.

The resources differ from one another furthermore in that they are either stateless or have a state. The term “state” is to be understood in the context of the general programming model. A program is at any given time in a given processing state. In the case of interruptions, task switching etc., this state is to be saved. When the program again receives run time at a later point in time, the saved state can be restored. When designing a system according to the invention, there are two alternatives:
A. Resources with states. The information stored in the resources belong to the processing state or the program context. When a resource is included into the processing state, this has the following consequences:
   a) The information stored in the resource is to be saved in the case of interruptions, task switching etc. and, at a later time, to be restored (requires corresponding access paths etc. and increases latency of the context switching).
   b) The memory means (registers etc.) in the resources are adequate memories in the sense of programming models; it is possible to keep variables, intermediate results etc. in the resources alone.
   c) Results can be fed back to inputs of the same resource (INOUT parameter; FIG. 91).
   d) Concatenation can be used without restrictions.
   e) Interruptions, task switching etc. can be carried out anytime, i.e. without having to consider the internal processing state of the resources (all processing operations that take longer (e.g., than a few microseconds) can be interrupted anytime).
   If concatenation is applied to the extreme, there are practically no local variables that must be especially saved in the corresponding memory areas (for example, stack frames). Also, the corresponding transport instructions for storing and fetching again of intermediate results (a-operators and p-operators) are no longer required.
B. Stateless resources. These resources are not included into the processing state. A resource is referred to as stateless when it does not store its parameters beyond the respective actual processing operation; in other words, it is essentially acting as a combinational circuit. This has the following consequences:
   a) The information stored in the resource are not saved when interruptions, task switching etc. occurs (corresponding access paths are not required, the latency of the context switching is comparatively small).
   b) All variables, intermediate results etc. are to be kept within the main memory (system memory).
   c) There are no parameters that at the same time are inputs and outputs (INOUT). No input can be read back, no output can be overwritten (by entering operands).
   d) Concatenation can be used only to a limited extent (for example, for fetching operands and for storing results).
   e) Before initiating a y-operator all inputs must be always entered anew. This concerns also those values that are unchanged since the previous y-operator.
   f) Interruptions or task switching can take place only after the results of the processing operations triggered in the resources have been transferred into the main memory. Also, all operations that have been initiated by concatenation must have been terminated. No processing operation is interruptible in itself.

FIG. 91 illustrates two variants of resources with states:

a) a result is used in the next processing operation as an operand (feedback),

b) this parameter is operand as well as result (type INOUT).

The selection of the configuration typically depends on whether primarily short latency or high processing efficiency is important. The problem in question occurs only when the resources are to be used for multiple purposes, for example, for interrupt handling or for execution of several tasks at the same time (time slicing).

Resources with states require time for saving and restoring but the processing operations are interruptible at any time and during processing fewer memory accesses must be performed. When the resources are stateless, saving and restoring are not needed, but the processing operations are not interruptible and, overall, more memory access operations are required.

When minimal latency is required, it must be examined which takes longer: saving and restoring or terminating all processing operation including the additional memory access operations for fetching operands and for saving the results.

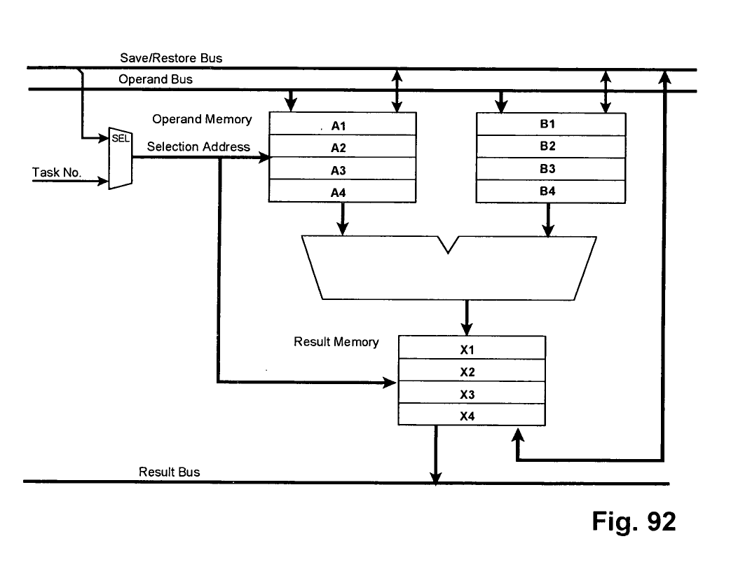

When maximum processing efficiency (performance) is desired, typically resources with states are to be preferred because only this configuration makes it possible to concatenate the resources without limits, to feed back results to inputs, and to utilize the internal memory means for storing data. In order to reduce latency, the resources with states can be equipped with additional memory means (FIG. 92).

FIG. 92 shows a simple processing resource that forms a result based on two operands. The operand memory and the register memory however are no simple registers but addressable memory arrays that are implemented, for example, with register or RAM arrays. The memory addresses are supplied from the exterior, for example, from the platform. Each task (each interruption level) is correlated with a memory position. The memory positions with which the resource operates are selected by means of the task number or the interrupt level. Task switching or interruption only means switching to the corresponding number. Such memory arrays cannot be too large (nominal value: 4 to 64 memory positions) because the access time would otherwise be too long (which would require that the clock rate is lowered or pipeline stages are added). One solution is the transfer of memory contents that currently are not in use via independent access paths (in FIG. 92: save/restore bus) into the main memory and, as needed, retrieval of the memory contents from the main memory (restore operation). These operations can take place parallel to the actual processing operations.

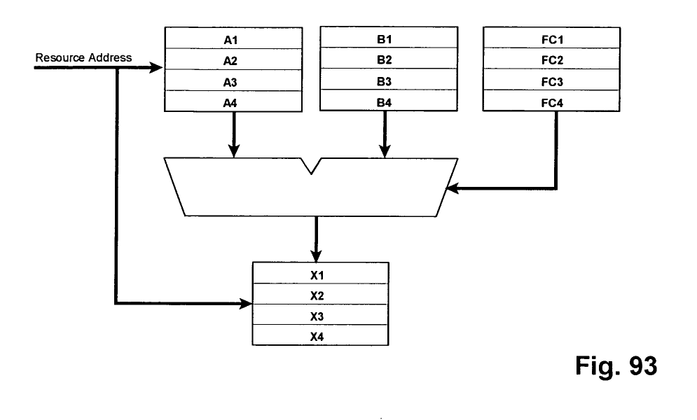

FIG. 93 shows how the principle illustrated in FIG. 92 (the operand and result registers are memory arrays that can be addressed from the exterior) can be used in order to implement with one processing unit more than one resource (reduction of expenditure). For this purpose, the operand and result registers (A1, B1, X1 etc.) are supplemented by function code memory (e.g., FC1). All of these memory means are addressed by resource address information that is supplied, for example, by the platform. Each resource address selects a set of operand and result registers as well as a function code that sets the processing hardware to the functions of the respective resource type. Example: the first resource (A1, B1, X1, FC1) carries out additions, the second resource (A2, B2, X2, FC2) carries out AND operations.

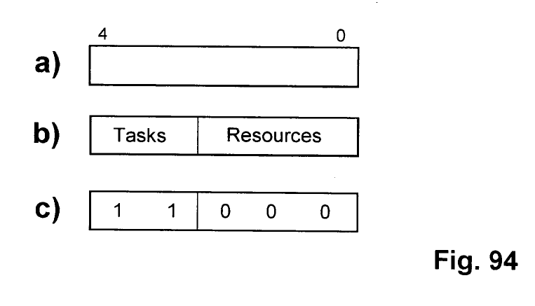

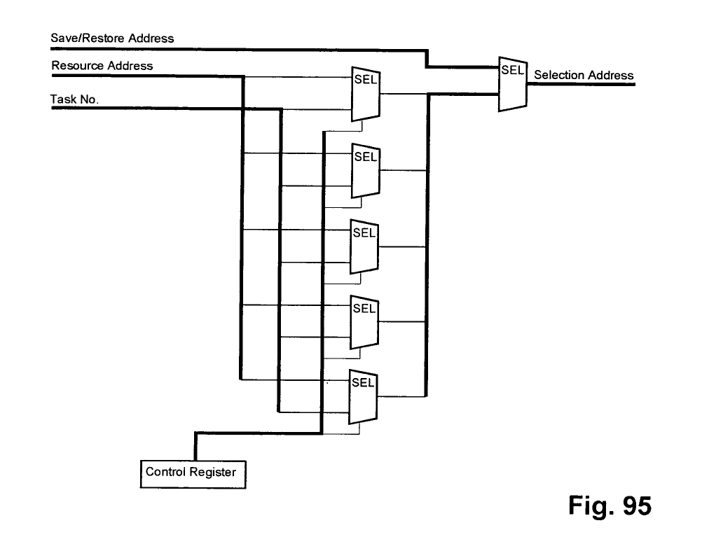

Further modifications:
A. Independent address paths for the operand and result registers. In this way, I-operators and concatenations can be accelerated.
B. Combining the addressing and utilization modes according to FIGS. 92 and 93. The memory configuration (operand registers, result registers etc.) can be utilized alternatingly in order to support the execution of different tasks or in order to provide the running task with several processing resources. With the aid of FIGS. 94 and 95 a program-controlled switching between two utilization modes will be illustrated. For this purpose, the address of the memory arrays illustrated in FIG. 93 is combined of a task address and a resource address. The program controls how many address bits are supplied by the task address and how many by the resource address. In this way, one has the possibility of assigning few resources to many tasks, respectively, or of assigning many resources to a few tasks, respectively.

FIG. 94 illustrates the principle with the aid of a 5 bit address:
a) The entire 5 bit address. It can support up to 32 parameter positions. The save address (compare FIG. 92) that is supplied by the save/restore bus has this length so that all memory positions can be incorporated into saving/restoring.
b) Address division for supporting 4 tasks (2 address bits) and 8 resources for each task (3 address bits).
c) A control register that controls the address division. Each address bit position is switched individually: 0=bit is coming from the resource address, 1=bit is coming from the task number.

FIG. 95 shows a corresponding hardware. Resource address and task number are supplied bit-wise to selectors whose selector inputs are connected downstream of the control register (FIG. 94c). These selectors have a further selector arranged downstream that, in turn, is connected to the restoring address. The selection address corresponds to the resource address of FIG. 93.

It is one of the basic principles of the inventive method to consider the resource pool as being unlimited. Because the number of resources is however always limited in practice, there is sometimes the necessity to carry out operations that require an almost unlimited resource pool with a limited number of resources. This will be described in the following in more detail. There are in principle three types of limitations:
addressing capability,
memory capacity,
number of processing devices.

The addressing capability (the length of the corresponding address information) limits principally the size of the resource pool (the resource pool is not infinite but transfinite). The resources that are taken from such a pool will be referred to in the following as virtual resources.

The actually usable memory capacity can be expanded as is known in the art (virtual memory organization) to the limit of the addressing capability.

The number of actually usable processing devices (=real processing resources) is always kept comparatively small (magnitude, for example, 2² to 2¹² compared to typical address spaces of 2³² to 2⁶⁴).

The information processing operations are sequentially carried out by means of actually present (real) resources (serialization). For this purpose, conventional machine instructions, microinstructions or the like can be used (emulation). This corresponds to the mode of operation of conventional general-purpose computers. In another variant the real resources carry out one after another the information processing operations of several identical virtual resources (virtualization). For all selected virtual resources, working areas are provided in the memory. The working areas moreover can be included into a virtual memory organization as it is supported by modern operating systems. When a processing operation is to be carried out, the memory contents of the operands are transported into a corresponding hardware resource. The results are returned optionally into the memory. There are different possibilities for implementing this principle:
1) The transport operations are programmed. The compiler adds optionally corresponding transport instructions (translation at compile time).
2) The transport operations are part of the respective operators. For this purpose, the operation control circuits can be implemented, for example, as microprogrammed control units (the control of complex transport and processing operations by means of microprograms is known in the art and must not be explained in detail in this context).
3) Processing resources are embedded in the cache memory arrays (compare FIG. 63) so that the transports are carried out by the inherently present cache hardware. In this way, it is at the same time ensured that unnecessary transports are eliminated (when the memory area of the corresponding virtual resource is present already within the cache, a cache hit results and the processing resource can become active immediately (compare signals ADRS MATCH in FIG. 63).
4) Processing resources are furnished with addressable memory arrays similar to FIGS. 92 and 93. Such a processing resource corresponds for example to 2 to 8 virtual resources wherein one of the virtual resources is active at a time. Entering operands and transporting results can be carried out parallel to the processing operations being performed in the respectively active resource (compare save/restore bus in FIG. 92).
5) The processing resources have their own associative hardware.

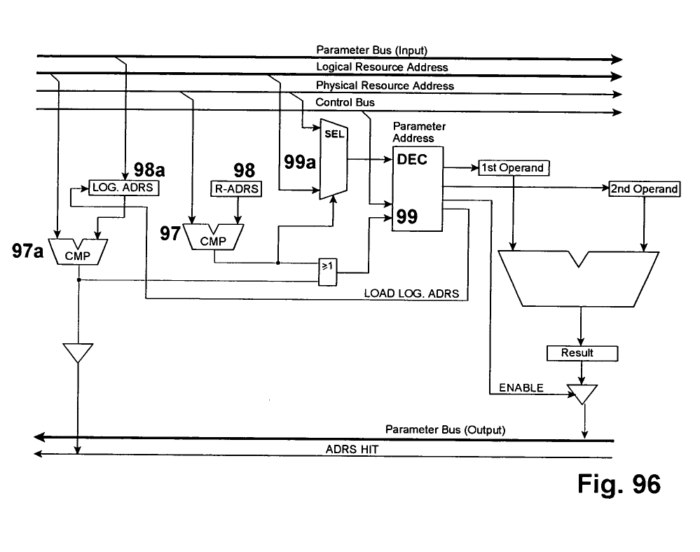

FIG. 96 illustrates a resource that is modified in comparison to FIG. 89. Address comparator 97 and address setting device 98 act in the way described in connection with FIG. 89. They are used for decoding the real (physical) resource address. In addition, an address comparator 97a and an address register 98a for the address of the respectively correlated virtual resource is provided (logical address). The logical resource address is supplied by means of additional bus lines. Upstream of the address selector 99 an address selector 99a is arranged. Both address comparators 97, 97a are concatenated in disjunction to the address decoder 99. Moreover, the output signal of the address comparator 97a is connected to the hit line ADRS HIT. There are two ways of accessing:
A. Physical access via address decoder 97. The address is fixed (it is either unchangeable or it is set after power-on in the context of configuration sequences). The address length is not very large (for example, 6 bits when a total of 64 resources are provided). The address selector 99a sends the physical parameter address to the address decoder 99.
B. Logical access with a virtual resource address by address decoder 97a. Such address information can be long (for example, 32 to 64 bits). The address selector 99a sends the logical parameter address to the address decoder 99. The respective logical address must be loaded prior to this, by means of physical accesses, into the address register 98a. For this purpose, the address register 98a is connected like an additional operand register to the parameter bus and to the address decoder 99 (load control signal LOAD LOG. ADRS). When upon access with a certain logical address the address comparator 97a becomes active, it excites the hit line ADRS HIT, and the arrangement acts as the corresponding virtual resource. When upon accessing with a virtual resource address ADRS HIT remains inactive, one of the hardware resources must be assigned to the respective virtual resource. This procedure for selecting a suitable hardware resource as well as for swapping operands and results is known in the art (compare conventional cache memories and virtual memories).

The respective access mode can be selected, for example, by means of different instruction or operator formats. In the extreme, all operators are provided twice (logical and physical). In an alternative configuration the access mode can be made dependent on the working state. Systems with several states are known in the art. Typical are at least two states: user mode and supervisor mode. In the user mode logical access is carried out; in the supervisor mode physical access is carried out.

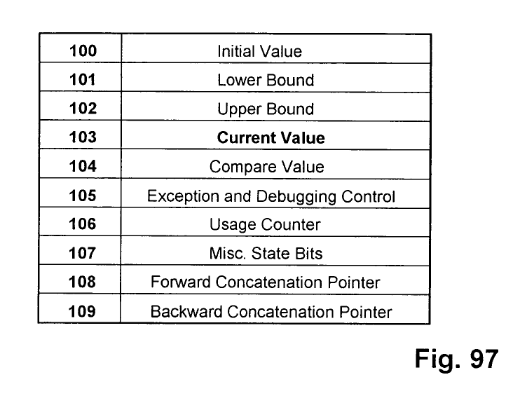

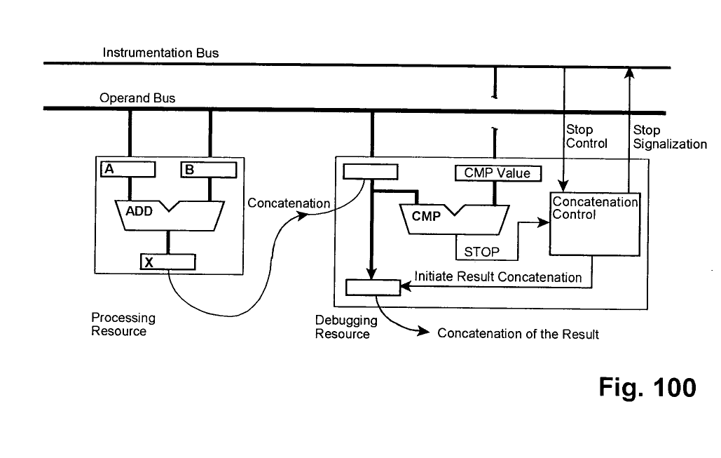

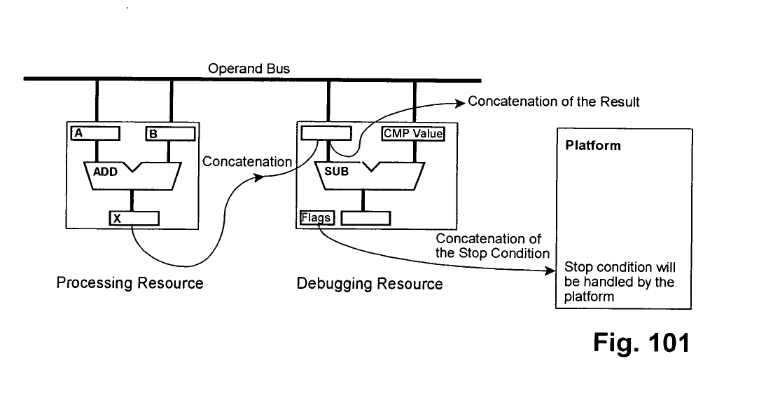

In the following, with the aid of FIGS. 97 to 101 questions of the so-called instrumentation will be considered. In information technology, instrumentation means to provide systems with additional provisions for system management, for efficiency measurement, for debugging etc. In order to be able to provide such functions in systems according to the invention, there are the following possibilities:
The resources are expanded with additional devices (FIGS. 97 to 99);
Special resources for this purpose are provided (FIG. 100);
Corresponding arrangements are generated ad hoc by connecting appropriate resources (FIG. 101).

FIG. 97 shows with the aid of an example how a simple parameter (for example, a binary number) can be supplemented by additional information: 100—initial value for purpose of initialization: 101,102—bounds of the value range; 103—the current value; 104—compare value; 105—control and address information for triggering program exceptions and for behavior upon compare match (current value=compare value); 106—usage counter; 107—various state bits (inter alia for controlling concatenation); 108, 109—concatenation pointers (compare FIG. 56). Each item of information 100 to 109 corresponds to a register or a memory position (in the resource emulation area).

The run time systems of many programming languages support only the current value 103. The values 100 to 102 support the implementation of appropriate programming languages (example: Ada). The compare value 104 is provided for debugging purposes. Example: stopping of program operation (in order to examine and display program states, current values of variables etc.) when the parameter is of a certain actual value. The usage counter 106 can be used, for example, in order to determine how many times the parameter has been used in processing operations or how much time has passed between two new computations.

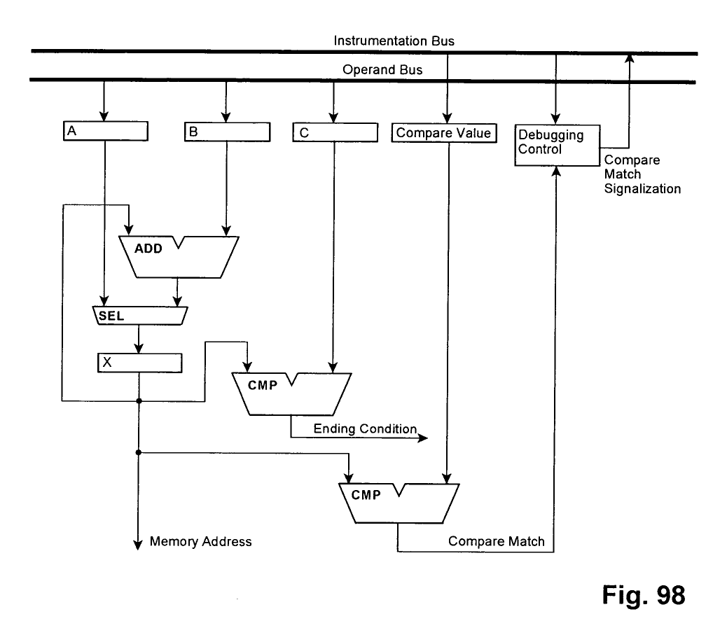

FIG. 98 illustrates a resource with installed debugging provisions. A simple iterator (compare FIG. 37) is expanded by a comparator that compares the generated memory address with a set value and signalizes a stop condition when values are identical (compare match). Analogously, the resources can be provided with circuit means for monitoring value ranges, with measuring counters etc. (compare also FIG. 70).

The stop addresses, range information, counter values etc. can also be set and transported like the usual operands and results. They are simply viewed as additional parameters. This requires however a corresponding expansion of the parameter address space and thus more address bits in the machine code.

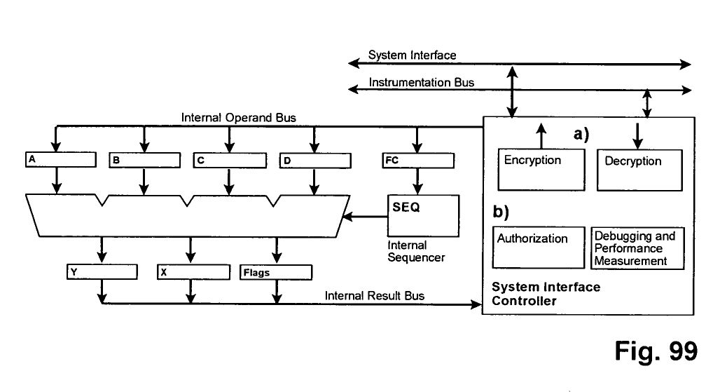

Alternatively, special signal paths for the instrumentation information can be provided. FIG. 99 shows a somewhat more complex processing resource (compare FIGS. 13 and 48) that is provided with instrumentation provisions and in addition is connected to an instrumentation bus. Since the transports of the instrumentation information is not critical to performance (such information is set or queried only from time to time) a correspondingly simple configuration is sufficient (for example, as a serial bus system). In addition to the already explained debugging and performance measuring provisions, the resource according to FIG. 99 is provided with the following functions:
a) Decrypting of incoming operands and encrypting of outgoing results. Encryption devices are known in the art. Here, they are incorporated into the resource. This has the advantage that external bus systems (that are provided, for example, on printed circuit boards) move only encrypted data.
b) Owner-specific identification. In the simplest case this is embodied as fixed values that can be queried. More advanced can be provided with authorization provisions, for example, with password protection; they can be used only when corresponding correct authorization input has been provided beforehand. The advantage is that this protection is inseparable from the processing hardware so that, for example, copying of the utilized software is of no use because the same-type resources in other machines have different authorization information for their utilization.

Known solutions that make available so-called trusted computer platforms are based on deriving a type of signature from the particular properties of the hardware.

Such methods do not solve the basic problem. They require that the corresponding signature is verified via the Internet. This is inconvenient, contradicts the basic principles of privacy or data protection, and impedes the free utilization of the respective computer. The incorporation of directly acting protective measures in hardware resources that are utilized according to the method of the present invention has the advantage that the free utilization of the computer is not impaired and that a query of hardware and configuration data is not required because the protective measures are provided directly. Free programs require no such resources (for example, according to FIG. 99). Programs that are subject to proprietary rights do not run on machines that are not provided with corresponding resources. The encryption and identification functions are provided by the hardware, in particular in the interior of the circuits. The details of operations thus cannot be reverse-engineered by observing the data flow over external connections. The software emulation would be futile (computing times would be too long).

FIG. 100 illustrates how a processing resource is concatenated with a special debugging resource. In addition to the processing resources supplementing instrumentation resources are made available (for debugging, for performance measurements etc.). They are called as needed (s-operators) and concatenated to the processing resources (the actual application program does not change by doing this). In the example, a simple processing resource (an adder) is connected to a debugging resource that supports value comparison. When the result of the processing resource is identical to the set compare (CMP) value, a stop condition is triggered. The debugging resource is designed such that it can concatenate the information to be compared (here: the result of the processing resource) to the actual destination resources. When the stop condition is met, the concatenation does not become effective (conditional concatenation). Accordingly, the processing operation is stopped and, in a manner known in the art (by fetching the register contents), it is possible to examine the actual processing state. When the processing operation is to be continued, the concatenation control in the debugging resource receives a corresponding signal through the instrumentation bus.

FIG. 101 shows how conventional processing resources can be utilized for instrumentation purposes. In this way, it is possible to combine configurations for debugging, for performance measurements etc. as needed. In the example, an adder (processing resource) is combined with a subtractor (debugging resource). The subtractor compares the result of the adder with a predetermined compare values. Moreover, it transports the incoming results to other resources. The stop condition is signalized by a concatenation to the platform (for example, it can trigger an interruption). This however does not ensure always exact stopping at the stop point. More advanced general-purpose resources, that in regard to their functions are also suitable for instrumentation purposes, can be provided with conditional operand concatenation so that, for example, they do not transport a result when a stop condition is met so that therefore the processing operation is stopped temporarily for the purpose of observation.

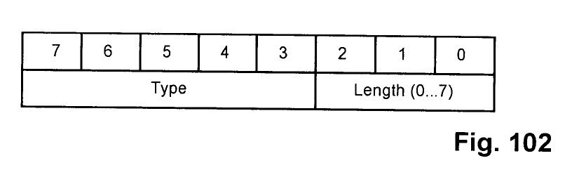

In the following, formats of byte codes and machine codes will be explained in more detail in an exemplary fashion. First, with the aid of FIGS. 102 to 105, examples of machine-independent byte codes will be described. Such byte codes are binary-coded program representations with unlimited addressing capability. (Known byte codes have typically a limited addressing capability. As an example the byte code of Java Virtual Machine—JVM—should be mentioned.) The structure of byte codes is general knowledge in the art of computer science. Therefore, the following is limited to a typical embodiment.

Programs are comprised of strings of bytes. There are control bytes (FIG. 102) and numeric information. Control bytes contain a type information and a length information. There are three types of control bytes:
1) Control bytes for numeric information (numerical values). The length value is in the range of 1 to 7. It characterizes how long the subsequent numeric information is. The type information characterizes the type of the subsequent numeric value (Table 5). Coded length values: 1 byte, 2 bytes, 3 bytes, 4 bytes, 6 bytes, 8 bytes. The remaining length value is reserved.
2) Control bytes for operators. The length value is =0. The type information characterizes the type of operator (Table 6).

3) Control bytes that have zeroes assigned (contents =00H) have no function (NOP).

TABLE 5

| type information | corresponding operator |
|---|---|
| resource type | s |
| ordinal number of resource (in resource | s |
| pool) | |
| number of resources | s |
| type of variable | p, a |
| ordinal number of variable | p, a |
| bit string (immediate value) | p |
| source resource | a, l, c, d |
| source parameter | a, l, c, d |
| destination resource | p, l, c, d, y |
| destination parameter | p, l, c, d |
| function code | h, m, u |

TABLE 6

| operator | function | operator | function |
|---|---|---|---|
| NOP | none | c | connect selected resources by |
| | | | parameters with one another |
| s | select resource | d | disconnect |
| s_a | select resource and assign | l | transport parameters between |
| | number or address | | selected resources (link) |
| | (select & assign) | | |
| p | transport parameter from | r | release resources for other use |
| | memory means of the platform | | |
| | to the selected resource | | |
| p_imm | transport immediate value into | h | additional information (hints) for |
| | the selected resource | | supporting compilation and for |
| | | | process acceleration - reserved |
| y | activate processing functions in | m | additional meta-language |
| | the selected resource (yield) | | information - reserved |
| a | transport parameter from the | u | utilities - here all machine- |
| | selected resource to memory | | specific codes are assigned that |
| | means of platform | | are provided for supporting the |
| | | | actual operators (e.g. for |
| | | | loading registers of the platform) |

According to Tables 5 and 6, there are 11 types of numeric information (values) and 14 types of operators to be encoded. The 5 bit field of the example format therefore provides a reserve of 21 or 18 code positions (i.e., 21 additional types of numeric information and 18 additional operators can be encoded).

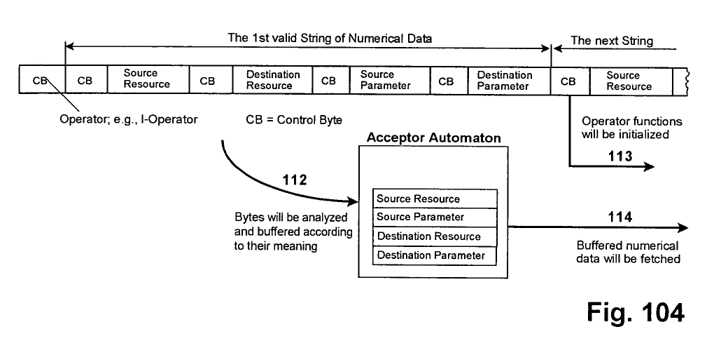

The operators must be supplemented by numeric information. There are two variants:
A. Postfix notation (FIG. 103). First the numeric information is provided followed by the operator. The interpreting system has a kind of state buffer that receives the actual values. When passing from one operator to the next, only the information that has changed, respectively, must be entered anew.
B. Prefix notation (FIG. 104). First the operator is provided followed by the numeric information. Their number must correspond to respective syntax. The interpreting system must have an acceptor automaton that recognizes valid byte sequences. When such a sequence has been recognized, the respective function is initiated. The function of the acceptor automaton is basic knowledge in computer science and must therefore not be explained in detail.

FIG. 103 illustrates a byte code in postfix notation. According to the control bytes the numerical values are entered into the respective positions of the state buffer (this is, for example, a fixedly assigned area in the main memory or a register file). When an operator arrives, the corresponding function is triggered (110). The required information is fetched from the state buffer (111). In the illustrated example, the state buffer 11 has 11 entries, one for each type of numeric information according to Table 5. When, for example, parameters having up to 8 bytes are allowed, each entry must be able to receive the eight data bytes. In a first configuration, the respective actual length value (from the control byte) is stored additionally so that later on (at the time of execution of the operations), the actual length of the parameter can be determined. In an alternative configuration, all parameters in the state buffer have, for example, a length of 8 bytes. Shorter values are entered right aligned. A parameter value of a length of one byte is entered at bit positions 7 . . . 0, a value of two byte length is entered at the bit positions 15 . . . 0 etc. In a further modification, the state buffer is a stack. Numeric values are pushed onto the stack, operators fetch their parameters from the stack. Control bytes with subsequent numeric values essentially represent push instructions; control bytes that encode operators represent operation instructions (wherein their execution causes the operands to be removed from the stack).

FIG. 104 illustrates a byte code in prefix notation. The acceptor automaton analyzes the byte stream (112). Each operator is characterized by a certain valid string of numerical values (Tables 7, 8). The recognized numerical values are buffered. After recognizing a complete valid string of bytes, the corresponding function is triggered (113). In this connection, the buffered information stored in the acceptor automaton (114) is retrieved. Such a string can be followed by a further valid string or an operator.

The afore described configurations of the byte codes can work with ordinal numbers as well as with address information; this is only a question of interpretation. Table 7 concerns ordinal number information or a split resource address space; Table 8 concerns a flat resource address space.

TABLE 7

| operator | syntax of the numerical data |
|---|---|
| s | number of resources - resource type |
| s_a | resource type - resource number - destination resource |
| p | type of variable - variable number - destination resource - |
| | destination parameter |
| p_imm | immediate value - destination resource - destination parameter |
| y | destination resource |
| a | source resource - source parameter - type of variable - variable |
| | number |
| l | source resource - source parameter - destination resource - |
| | destination parameter |
| c | source resource - source parameter - destination resource - |
| | destination parameter |
| d | source resource - source parameter - destination resource - |
| | destination parameter |
| r | destination resource |

TABLE 8

| operator | syntax of numerical data |
|---|---|
| s | resource type address |
| s_a | resource type address - resource address |
| p | variable address - destination resource address |
| p_imm | immediate value - destination resource address |
| y | destination resource address |
| a | source resource address - variable address |
| l | source resource address - destination resource address |
| c | source resource address - destination resource address |
| d | source resource address - destination resource address |
| r | destination resource address |

In the following, different configurations of machine codes will be explained. The machine code can be a byte code (variable length) or fixed-format instruction code. The development of machine instruction formats is general knowledge in the art of computer architecture. Therefore, it is sufficient to briefly explain a few examples. The following four examples illustrate:
instructions of different length (16, 32, 64 bits as well as byte codes with variable length),
instruction formats with addressing capability as large as possible (=long address fields),
instruction formats that support as many as possible simultaneously initiated functions,
formats with shorter and longer instructions,
instruction formats with flat and split resource address space,
utilization of buffer registers for transfer of data that does not fit the respective instruction format.

Important considerations of the instruction format design are inter alia:
1) address fields as long as possible,
2) sufficiently long resource type fields in the s-operator (8 bits are typically the lowest limit),
3) simple decoding,
4) good utilization of the instruction length,
5) provisions for entering elementary immediate values; for this purpose, an additional variant of the p-operator is provided (p_imm=p immediate),
6) sufficient reserves in order to be able to encode further instructions.

When the instruction set is preferably provided for software-based emulation, long address fields are important while the simultaneous initiation of several functions (parallel work) is practically meaningless (it cannot be supported by the emulator anyway). In contrast to this, in the instruction sets for special hardware (special processors, processing devices in FPGAs) parallel processing is the primary concern. The resource address information must be only of such a length that they can support the actually present hardware. For general-purpose hardware (microcontrollers, high-performance processors) typically a compromise between address length and simultaneously initiated functions can be found.

All examples provided in the following contain unused bit positions or special reserved formats that can be used for extension of the respective instruction set (for example, for m-operators, h-operators, u-operators; for s-operators for requesting resources via the Internet; for instructions for controlling the platform etc.). Additional instructions can also occupy several instruction words. The extension of an instruction set by additional instructions has been known in the field of computer architecture for a long time so that a more detailed description is not required.

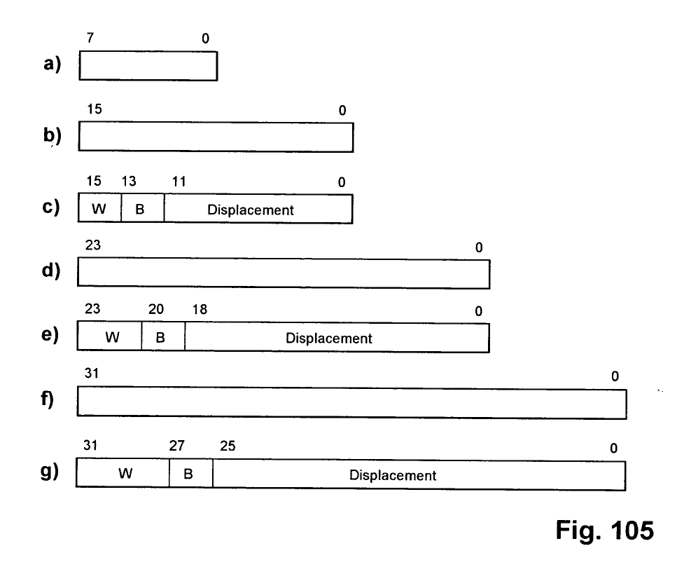

Example 1 concerns instructions of variable length that are comprised of sequential bytes (byte code). Instruction formats with variable length are conventional in many computer architectures. Such an instruction begins with an operation code byte that determines the instruction function as well as the number and meaning of subsequent bytes. Those bytes constitute information fields containing ordinal numbers, addresses or immediate values. In the example according to Table 9 and FIG. 105, in contrast to the above described machine-independent byte codes, each instruction has only a single function (for example, five s-operators must be provided in order to select five identical resources).

TABLE 9

| operator | 1st field | 2nd field | 3rd field | 4th field |
|---|---|---|---|---|
| s | resource type | | | |
| s_a | resource type | resource | | |
| p | address of | resource | parameter | |
| | variable | | | |
| p-imm | immediate value | resource | parameter | |
| y | resource | | | |
| a | resource | address of | | |
| | | variable | | |
| l | resource | parameter | resource | parameter |
| c | resource | parameter | resource | parameter |
| d | resource | parameter | resource | parameter |
| r | resource | | | |

Table 9 provides an overview of the instruction formats for a split resource address space. In the instructions for a flat resource address space the parameter fields are not needed. The functions of the instructions are shown in Table 6. FIG. 105 shows the formats of the information fields of which the instructions are comprised:
a) 1 byte, for operation codes, resource types, resource addresses, parameter addresses, and immediate values;
b) 2 bytes, for operation codes, resource types, resource addresses, parameter addresses, and immediate values;
c) address of variables; 2 bytes; W=access width, B=base address register (see Table 13); 4 different access widths, 4 base address registers, 12 bits displacement;
d) 3 bytes, for operation codes, resource types, resource addresses, parameter addresses, and immediate values;
e) address of variables, 3 bytes; W=access width, B=base address register (see Table 13); 8 different access widths, 4 base address registers, 19 bits displacement;
f) 4 bytes, for operation codes, resource types, resource addresses, parameter addresses, and immediate values;
g) address of variables, 4 bytes; W=access width, B=base address register (see Table 13); 16 different access widths, 4 base address registers, 26 bits displacement.

The fields according to FIG. 105 and Table 9 can be used like a modular system from which the instruction formats for a certain machine can be combined. Table 10 contains the length of the individual fields (in bytes) for several typical applications. These instruction formats have enough reserves. The addressing capability of the individual fields is practically never completely utilized. It is advantageous (memory space savings) to provide several p_imm operators having immediate values of differently length.

TABLE 10

| | resource | resource | immediate | variable | parameter |
|---|---|---|---|---|---|
| system | type | address | value | address | address |
| hardware for | 1 | 1 or 2 | 1, 2 | 2 | 1 |
| embedded systems | | | | | |
| high-performance | 1 or 2 | 1 or 2 | 1, 2, 3, 4 | 4 | 1 |
| hardware | | | | | |
| software (emulation) | 2 | 2 or 3 | 1, 2, 3, 4 | 2 or 3 | — |
| for embedded | | | | | |
| systems | | | | | |
| software (emulation) | 3 or 4 | 4 | 2, 4 | 3 or 4 | — |
| for the upper | | | | | |
| performance range | | | | | |

Example 2 concerns a 32 bit instruction word and address fields of medium length (Tables 11 to 13). Each instruction corresponds to a complete operator. Some instructions can initiate two functions. The resource address space comprises maximally 4,096 parameters. The 12 address bits can also contain split resource addresses, for example, for 1,024 resources with four parameters or 512 resources with 8 parameters. Applications: high-performance processors according to the invention, specialty processors, complex processing devices in FPGAs etc. Table 11 provides an overview of the machine code, Table 12 describes the instruction functions. Table 13 shows how the access width W and the base address B are encoded.

1. instruction length: 32 bits

2. resource address: 12 bits (flat address space)

3. resource type information: 12 bits

4. immediate value length: 16 bits

5. address of variable (displacement): 14 bits, maximum 4 base addresses (B).

6. fixation of access width: in the instruction; maximum of 4 access widths (W)

7. Special features:

a) y-operator can activate two resources at the same time

b) s-operator can select two resources at the same time.

TABLE 11

| | | | | | | | | |
|---|---|---|---|---|---|---|---|---|
| operator | 31 | 29 | 27 | 25 | 23 | 12 | 11 | 0 |

| y | 0 | 0 | x | x | 0 | 0 | 0 | 0 | 2nd resource (12) | 1st resource (12) |
|---|---|---|---|---|---|---|---|---|---|---|
| y_f | 0 | 0 | x | x | 0 | 0 | 0 | 1 | function code (12) | resource (12) |
| c | 0 | 0 | x | x | 0 | 1 | 0 | x | 2nd resource (12) | 1st resource (12) |
| d | 0 | 0 | x | x | 0 | 1 | 1 | x | 2nd resource (12) | 1st resource (12) |
| s | 0 | 0 | x | x | 1 | 0 | 0 | x | 2nd resource type (12) | 1st resource type (12) |
| r | 0 | 0 | x | x | 1 | 0 | 1 | x | 2nd resource (12) | 1st resource (12) |
| l | 0 | 0 | W | | 0 | 0 | 1 | x | 2nd resource (12) | 1st resource (12) |
| s_a | 0 | 0 | x | x | 1 | 1 | 1 | 1 | resource address (12) | resource type (12) |

| | | | | | | |
|---|---|---|---|---|---|---|
| a | 0 | 1 | W | B | displacement (14) | resource (12) |
| p | 1 | 0 | W | B | displacement (14) | resource (12) |

| | | | | | |
|---|---|---|---|---|---|
| p_imm | 1 | 1 | W | immediate (16) | resource (12) |

TABLE 12

| operator | function |
|---|---|
| y | initiating the result computation in the selected resources; the fields concern |
| | the function code parameter of the respective resources; value = 0: no |
| | initiation |
| y_f | initiating the result computation in the selected resource according to the |
| | selected function code; function code = 0: no initiation; utilization: for |
| | resources with selectable function |
| c | establishing a concatenation 1st resource => 2nd resource; the fields concern |
| | an operand parameter and a result parameter |
| d | disconnecting the concatenation 1st resource => 2nd resource; see also under c |
| s | selecting (requesting) two resources according to type field; value = 0: no |
| | function |
| r | releasing the selected resources; the field concerns the function code |
| | parameter of the respective resources; value = 0: no release. |
| l | parameter transport 1st resource => 2nd resource (access width W) |
| s_a | selecting a resource according to type field and assigning the selected |
| | resource address; the resource address is the start of resource numbering in |
| | additional s-operators (+1 increment); value = 0: no selection (only setting the |
| | initial address) |
| a | result transport resource => parameter address (<base B + displacement>, |
| | access width W) |
| p | operand transport parameter address (<base B + displacement>, access width |
| | W) => resource |
| p_imm | immediate value - parameter transport immediate => resource; if access width |
| | W greater than 16 bits, the immediate value is sign-extended |

TABLE 13

| W = access width: | B = base address: |
|---|---|
| 1 byte | stack pointer (SP |
| 2 bytes | base pointer (BP) |
| 4 bytes | global pointer (GP) |
| reserved | reserved |

Example 3 concerns a 32 bit instruction word with address data of 28 bit length (Table 14 to 17). Application: primarily for software emulation (virtual machines) in the upper performance range. It is not possible to accommodate two information fields in a 32 bit word. Therefore, in the platform four buffer registers are provided that can be loaded with u-operators (Table 14). Some operators require therefore two instructions. The resource address space comprises maximally 256M parameters. The 28 address bits can also accommodate split resource addresses, for example, for 16M resources with 16 parameters or for 1M resources with 256 parameters. Table 14 shows how the buffer registers are used, Table 15 provides an overview of the machine code, Table 16 describes the instruction functions. In Table 17 it is indicated how the access width W and the base address B are encoded.

1. instruction length: 32 bits

2. resource address: 28 bits (flat address space)

3. resource type information: 26 bits

4. immediate value length: 26 bits

5. address of variable (displacement): 24 bits; maximum 4 base addresses (B)

6. fixation of access width: in the instruction; maximum of 8 access widths (W)

7. buffering: four buffer registers.

TABLE 14

| buffer register | loaded with | utilized by |
|---|---|---|
| 1: address of variable | u_va | p |
| 2: immediate value | u_imm | p_imm |
| 3: resource address | u_rs | l, c, d, a |
| 4: resource address counter | u_ra | s |

The arrangement of buffer registers enables, in contrast to the self-evident doubling of the instruction length, often multiple utilization of the entered information:

transport of immediate value to several resources (p_imm),

transport of a variable to several resources (p),

assignment of a result to several variables (a),

transport of a result to several operands (l, c, d).

TABLE 15

| | | | | | | |
|---|---|---|---|---|---|---|
| operator | 31 | 29 | 27 | 25 | 23 | 0 |

| | | | | | | |
|---|---|---|---|---|---|---|
| others | 0 | 0 | 0 | 0 | *) | res. |
| s | 0 | 0 | 0 | 0 | 11 | resource type (26) |

| | | | | | |
|---|---|---|---|---|---|
| r | 0 | 0 | 0 | 1 | resource (28) |
| p_imm2 | 0 | 0 | 1 | 0 | resource (28) |
| y | 0 | 0 | 1 | 1 | resource (28) |
| l_2 | 0 | 1 | 0 | 0 | resource (28) |
| c_2 | 0 | 1 | 0 | 1 | resource (28) |
| d_2 | 0 | 1 | 1 | 0 | resource (28) |
| u_rs | 0 | 1 | 1 | 1 | resource (28) |

| | | | | | | |
|---|---|---|---|---|---|---|
| a_2 | 1 | 0 | 0 | W | B | displacement (24) |
| u_va | 1 | 0 | 1 | W | B | displacement (24) |

| | | | | | |
|---|---|---|---|---|---|
| u_imm | 1 | 1 | 0 | W | immediate (26) |

| | | | | | |
|---|---|---|---|---|---|
| p_2 | 1 | 1 | 1 | 0 | resource (28) |
| u_ra | 1 | 1 | 1 | 1 | resource address (28) |

*): Codes 00, 01, 10

TABLE 16

| operator | function |
|---|---|
| s | selecting (requesting) a resource according to type field; assignment of the |
| | resource address according to resource address counter (buffer register 4) |
| r | releasing the selected resource |
| y | initiation of the result computation in the selected resource |
| l_2 | parameter transport 1st resource => 2nd resource (access width W); 1st |
| | parameter according to buffer register 3, 2nd parameter according to address |
| | field; complete l-operator: u_rs (1st resource); l_2 (2nd resource) |
| c_2 | establishing a concatenation 1st resource => 2nd resource; 1st parameter |
| | according to buffer register 3, 2nd parameter according to address field; |
| | complete c-operator: u_rs (1st resource); c_2 (2nd resource) |
| d_2 | disconnecting the concatenation 1st resource => 2nd resource; 1st parameter |
| | according to buffer register 3, 2nd parameter according to address field; |
| | complete d-operator: u_rs (1st resource); d_2 (2nd resource) |
| u_rs | loading the content of the address field into buffer register 3 (resource |
| | address) |
| a_2 | result transport resource => address of variable (<base B + displacement>, |
| | access width W); parameter according to buffer register 3; complete a- |
| | operator: u_rs (resource); a_2 (parameter address) |
| pimm_2 | immediate value parameter transport immediate => resource; immediate value |
| | according to buffer register 2; immediate value is sign-extended according to |
| | access width W; complete p_imm operator: u_imm (immediate value); p_imm2 |
| | (resource) |
| u_va | loading the address of the variable into buffer register 1 |
| u_imm | loading the immediate value into buffer register 2 |
| p_2 | operand transport address of variable (<basis B + displacement>, access |
| | width W) => resource; address of the variable according to buffer register 1; |
| | complete p-operator: u_va (address of variable); p_2 (resource) |
| u_ra | resource address for s-operator to be set (buffer register 4); the resource |
| | address is the beginning of resource numbering in subsequent s-operators; |
| | complete s_a-operator: u_ra (resource address); s (resource type) |

TABLE 17

| W = access width: | B = base address: |
|---|---|
| 1 byte | stack pointer (SP) |
| 2 bytes | base pointer (BP) |
| 4 bytes | global pointer (GP) |
| 8 bytes | reserved |
| 16 bytes | |
| reserved | |

Example 4 concerns an instruction format that enables encoding of very many parallel executable functions (Table 18 to 24). For this purpose, longer instructions are required (64 bits). Up to 64 resources with maximally 8 parameters are supported (split address space). The parameters for the individual operators are supplied in pieces. In order to provide the final information, three buffer registers are arranged in the platform. For loading the buffer registers, additional operators u_rs1, u_rs2, u_ra are provided. The y-operator can activate up to 60 resources at the same time (by means of bit mask). Applications: special processors, processing devices in FPGAs etc. Table 18 shows the content of the buffer registers, Table 19 illustrates the basic instruction format. Table 20 contains details in regard to parameter information in the operators p, p_imm and a (compare Table 13 in regard to base address information B). The operation codes are illustrated in Table 21. Table 22 shows the structure of the instruction formats, Table 23 provides an overview of the contents. Table 24 describes the instruction functions.

1. instruction length: 64 bits

2. resource address: 6 bits (split address space)

3. parameter address: 3 bits

4. resource type information: 10 bits

5. immediate value length: 12 bits

6. address of variable (displacement): 10 bits, maximum 4 base addresses (B)

7. fixation of access width: in the resources

8. simultaneous initiation for:

a) 10 parameter transports between the resources, or

b) 10 concatenation control functions, or

c) 4 parameter transports between resources and platform, or

d) activation of maximally 60 resources, or

e) entry of 10 resource addresses into a buffer register, or

f) allocation of 6 resources, or

g) release of 10 resources.

TABLE 18

| | | | | | | | | | | |
|---|---|---|---|---|---|---|---|---|---|---|
| buffer register 1 | s1 | d1 | s2 | d2 | s3 | d3 | s4 | d4 | s5 | d5 |
| buffer register 2 | s6 | d6 | s7 | d7 | s8 | d8 | s9 | d9 | s10 | d10 |

| | | | | | | |
|---|---|---|---|---|---|---|
| buffer register 3 | ra 1 | ra 2 | ra 3 | ra 4 | ra 5 | ra 6 |

TABLE 19

| | | | |
|---|---|---|---|
| 63 | 60 | 59 | 0 |

| | |
|---|---|
| Opcode | address information, immediate value information or control |
| | information |

TABLE 20

| | | | | | | |
|---|---|---|---|---|---|---|
| operation | 14 | 12 | 11 | 3 | 2 | 0 |

| | | | |
|---|---|---|---|
| p, a | B | displacement (10) | parameter |

| | | |
|---|---|---|
| p_imm | immediate (12) | parameter |

TABLE 21

| opcode | format |
|---|---|
| 0 | y_1 |
| 1 | y_2 |
| 2 | u_ra |
| 3 | others |
| 4 | res. |
| 5 | res. |
| 6 | c |
| 7 | d |
| 8 | l |
| 9 | p |
| A | a |
| B | p_imm |
| C | r |
| D | s |
| E | u_rs2 |
| F | u_rs1 |

TABLE 22

| operator | bits 59...0 (see Table 23 for details) | | | | | | | | | |
|---|---|---|---|---|---|---|---|---|---|---|
| l, c, d | s/d1 | s/d2 | s/d3 | s/d4 | s/d5 | s/d6 | s/d7 | s/d8 | s/d9 | s/d10 |
| r | r1 | r2 | r3 | r4 | r5 | r6 | r7 | r8 | r9 | r10 |
| u_rs1 | s1 | d1 | s2 | d2 | s3 | d3 | s4 | d4 | s5 | d5 |
| u_rs2 | s6 | d6 | s7 | d7 | s8 | d8 | s9 | d9 | s10 | d10 |

| y | 60 single bits | | | |
|---|---|---|---|---|
| p, p_imm, a | parm1 | parm2 | parm3 | parm4 |

| | | | | | | |
|---|---|---|---|---|---|---|
| s | rt1 | rt2 | rt3 | rt4 | rt5 | rt6 |
| u_ra | ra 1 (6) | ra 2 (6) | ra 3 (6) | ra 4 (6) | ra 5 (6) | ra 6 (6) |

TABLE 23

| operator | bits 59...0 contain: |
|---|---|
| p | 4 parameter fields (parm1...4) at 15 bits; compare Table 20 |
| a | 4 parameter fields (parm1...4) at 15 bits; compare Table 20 |
| y_1 | 60 single bits for activation of the resources 59...0 |
| y_2 | 60 single bits for activation of the resources 63...60 and |
| | 55...0 |
| s | 6 resource type fields (rt1...10) at 10 bits |
| u_ra | 6 resource addresses at 10 bits (only 6 bits are utilized, |
| | respectively) |
| l, c, d | 10 parameter address pairs (s/d1...s/d10) (at 6 bits. s = source |
| | parameter (3 bits), d = destination parameter (3 bits) |
| r | 10 resource addresses (r1...r10) at 6 bits |
| u_rs1 | loading of the buffer registers 1 with 5 resource address pairs |
| | (s1, d1...s5, d5) at 12 bits |
| u_rs2 | loading of the buffer registers 2 with 5 resource address pairs |
| | (s6, d6...s10, d10) at 12 bits |
| p_imm | 4 parameter fields (parm1...4) at 15 bits; compare Table 20 |

TABLE 24

| operator | function |
|---|---|
| p | 4 operand transports parameter address (<base B + displacement>) => |
| | parameter in resource; the resource addresses are in the 1st buffer register |
| | (destination resources d1...d4); parameter = 7: no transport |
| a | 4 result transports resource => parameter address (<base B + displacement>); |
| | the resource addresses are in the 1st buffer register (source resources |
| | s1...s4); parameter = 7: no transport |
| y_1 | initiation of result computation in the first 60 resources (59...0). |
| y_2 | initiation of result computation in the last 4 and the first 56 resources (63...60, |
| | 55...0). |
| s | selecting (requesting) 6 resources according to type information (rt1...6); |
| | resource type = 0: no selection; the resource addresses are taken from buffer |
| | register 3; there is no automatic address increment; resource selection always |
| | by sequences u_ra; s (function like s_a operator) |
| u_ra | set resource addresses for s-operator (buffer register 3) |
| l | 10 parameter transports source parameter => destination parameter (s1 => |
| | d1...s10 => d10); resource addresses for the first 5 transport operations (1...5) |
| | in buffer register 1, for the second 5 transport operations (6...10) in buffer |
| | register 2; source parameter = 0: no transport |
| c | producing 10 concatenations source parameter => destination parameter (s1 |
| | => d1...s10 => d10); resource addresses for the first 5 concatenations (1...5) |
| | in buffer register 1, for the second 5 concatenations (6...10) in buffer register |
| | 2; source parameter = 0: no concatenation |
| d | disconnecting 10 concatenations source parameter => destination parameter |
| | (s1 => d1...s10 => d10); resource addresses for the first 5 concatenations |
| | (1...5) in buffer register 1, for the second 5 concatenations (6...10) in buffer |
| | register 2; source parameter = 0: no function |
| r | release of the selected 10 resources (r1...r10) |
| u_rs1 | loading of the buffer register 1 with 10 resource addresses at 6 bits (s1, |
| | d1...s5, d5) |
| u_rs2 | loading of the buffer register 2 with 10 resource addresses at 6 bits (s6, |
| | d6...s10, d10) |
| p_imm | 4 immediate value parameter transports immediate => parameter address; |
| | resource addresses are in the 1st buffer register (destination resources |
| | d1...d4); parameter = 7: no transport |

In the following, a few explanations for performing the method according to the invention in conventional computing devices will be provided. There are two basic possibilities:
A. Emulation. The operators or instructions are fetched by the corresponding software from the memory, the respective functions are emulated by the program.
B. Compilation. A program (source program) present as machine code is converted into sequences of conventional machine instructions and executed.

In conventional program development, the programming goal is typically realized in several stages. Source code in higher programming languages => machine program of an virtual stack machine (executable on the target machine by emulation) => optimized machine program for target machine. Virtual stack machines are generally known in connection with programming languages Pascal (P-code); Forth and Java (Java Virtual Machine JVM). Such stack machines are suitable for processing any nested expressions but are inherently sequential because of the way they function.

By utilizing the method according to the invention a machine program for a virtual machine is generated as an intermediate stage that is based on the above described fundamentals (no stack machine but a resource configuration). The following stages result: source code in higher programming language => machine program of a (virtual) resource configuration (executable on target machine by emulation) => optimized machine program for target machine.

The advantage resides in that it is possible to practically completely recognize the inherent parallelism of the program at compile time. For this purpose, for each programming step new resources are requested, respectively. They are connected as much as possible with one another. Accordingly, a virtual resource configuration is provided in possibly gigantic magnitude (hundreds of thousands of operation units etc.). In subsequent parsing runs, this configuration is then reduced step-by-step to a practicable size. The resources, together with the programs and data, are allocated to the memory (compare FIG. 5). A resource is comprised of:
memory spaces that correspond to registers of the hardware solution,
additional memory spaces for intermediate values etc. (working areas),
a program that emulates the function of the resource.
   Principle:
1) with s-operators all function resources are configured;
2) when a function is to be performed, the corresponding resource is first supplied with parameters (p-operators); subsequently the program execution is initiated (y-operator);
3) finally the results are allocated (a-operators, l-operators, or concatenation).

All transports are transports to fixed addresses. The action of building and releasing stack frames is no longer needed. The areas can instead remain occupied during the entire run time. Accordingly, practically all local variables become global ones. That the process of building and releasing stack frames is not necessary is primarily advantageous when functions in the interior of the program loops are called.

Typically, a single program is sufficient in order to emulate all resources of the same kind. Exception: the platform supports the required address calculations only insufficiently (as it is the case for some microcontrollers). Then several copies of the respective program are required that operate with different addresses (in the extreme, each resource has its own copy).

One example of a function that is implemented in this way is described in the following. int EXAMPLE (int A, int B, double C):

{
int X, Y;
double Z;
float H, I;
...
....
return (Y);
}

Now the function is called:

OMEGA=EXAMPLE (ALPHA, BETA, GAMMA);

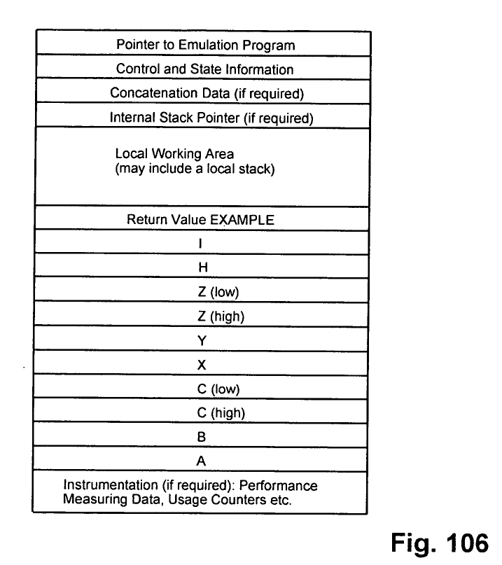

The resource EXAMPLE is defined as a memory area. For each function call such an area is generated. Each function call in the source program corresponds to an s-operator. The entire call chain (function A calls function B; the latter calls function C etc.) is “pre-manufactured” initially by s-operators. The execution of such a function is started with a y-operator. FIG. 106 illustrates an exemplary memory allocation for this function.

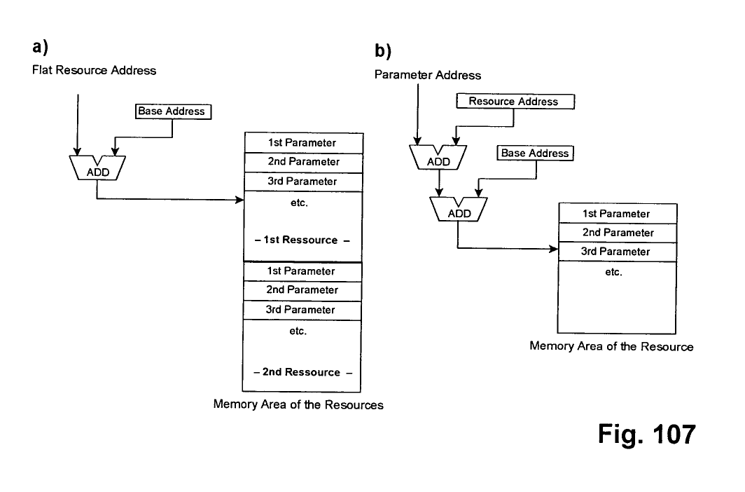

FIG. 107 illustrates parameter addressing in the memory. FIG. 107a concerns a flat parameter address space, FIG. 107b a split parameter address space. Each parameter corresponds typically to a memory position. It is self-evident that the memory positions of the resources are to be arranged sequentially so that the sequential addressing in a flat address space results essentially automatically (FIG. 107a). The split address space requires more expenditure for address calculation (FIG. 107b). An address calculation that goes beyond the scheme base+displacement is however not supported at all by conventional processors or only unsatisfactorily (lower speed).

It is possible in principle to incorporate memory areas that are allocated to resources into a virtual memory organization. Resources that are currently not utilized can be swapped out to the mass storage. In this way, for the emulation of the resources a memory address space in the magnitude of the entire architecture-based address capacity is available. Operating systems that support the method according to the invention can specifically provide virtual address spaces for the resource emulation (for this purpose, it is only required that a proper set of address translation tables (page tables) is administered for each address space).

Moreover, it is possible to store complete resource allocations as files and to load them for the purpose of execution. The resource structure must therefore be built only once (with s-operators and c-operators). For each further utilization a simple loading procedure is sufficient. Such pre-manufactured structures can be generated by the program developer and can be delivered completed within the corresponding software so that at the user site the corresponding s-operators and c-operators must not be executed.

Moreover, it is possible to transfer the execution of individual functions to different processors. The memory areas of especially performance-critical functions can be assigned to register memories (general-purpose or universal register files). In this way, even very large register memories can be utilized effectively (for example with 256 and more universal registers). Moreover, processing resources can be directly assigned partially to the general-purpose registers (compare FIGS. 65 to 69). Such arrangements, as a result of direct (very short) connections between registers and processing circuits, can be operated at higher clock frequency or can be configured as pipeline structures with reduced depth.

The utilization of general-purpose register files is a problem that has been known for some time in machine-oriented programming and program generation (in compilers). In this connection, algorithms have been developed that find out which variables are required the most and therefore are to be allocated with preference in registers (register allocation). Some programming languages support the explicit declaration of register variables (so that the software programmer can affect the allocation). Very large register files (there are processors with, for example, 128 or 192 general-purpose registers) are conventionally made accessible by area addressing. The individual machine instruction views only a section (register window) of the entire register address space. In this window the respective actual stack frame is allocated. When subroutines (functions) are called or terminated, these areas are switched correspondingly. Even though this principle replaces the transport of parameters by the significantly faster switching of the accessible address areas, these switching processes still cost time and the addressing requires additional circuit means that must be passed. This results in a longer basic cycle time or the necessity of introducing additional pipeline stages. Moreover, building and releasing the stack frames is accelerated but not entirely eliminated. It is still necessary to initialize again the local variables upon calling the function; when terminating the function, they are lost again.

The following features of modern high-performance processors can be utilized for speed increase:
several processing units (superscalar principle),
large general-purpose register files,
multiprocessor systems (more than one processor on a circuit, several processor circuits in combination),
parallel execution of several identical operations (SIMD=single instruction, multiple data)
parallel execution of several different operations, controlled by correspondingly long instructions (VLIW=very long instruction word).

The measures for increasing the speed are based in principle on the fact that in machine programs that correspond to the method according to the invention independent processing sequences are searched.

Two resources R1, R2 are independent from one another when in the program the following does not occur:
1) concatenations between R1 and R2 (in both directions),
2) l-operators that concern R1 and R2 (for both directions),
3). further processing of stored results of the other resource, respectively (p-operators for R2 relate to variables that beforehand have been transported by a-operators from R1 to the memory, and vice versa).

The independency is generally a dynamic property dependent on the course of processing (for example, two resources can be independent from one another for a period of time and can be concatenated later).

The architectural features provided for performance improvement of modern high-performance systems can be utilized based on the method according to the invention in the following way:
A. Utilization of the superscalar principle: resources that are independent from one another within a respective time window are activated simultaneously (y-operator).
B. Utilization of multiprocessor configurations: independent resources are assigned to different processors.
C. Execution of SIMD provision: a single machine instruction initiates the execution of several identical operations (compare MMX and SSE instructions in the processors of conventional PCs). Such instruction functions are used conventionally for processing special data structures (for example, for video and audio data). In order to utilize such provisions also for general programs, independent resources with identical operations are searched for in the program whose function can be emulated with the SIMD instructions (same operations, same processing width). Such operations are collected and, when enough are present, are activated together (y-operator initiates execution of the SIMD instructions).
D. Utilization of VLIW provisions: independent resources whose function can be emulated with VLIW instructions are searched for in the program. Such operations are collected and, when a sufficient number is present, are activated together (y-operator initiates execution of the VLIW instructions).

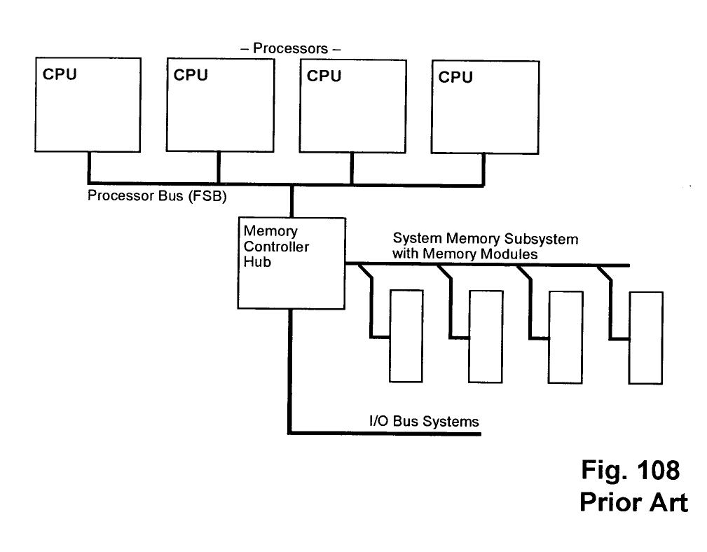

Systems for performing the method according to the invention can be built with conventional processors. For example, a processor can be used as a platform and supplemented or extended by further processors that are utilized as processing resources. The processors are connected conventionally by a bus system or by point-to-point interfaces and switching hubs; see FIGS. 108,109. They can access a unified memory address space.

The platform configures the resource working areas within the memory address space and triggers the processors to carry out the corresponding functions. This can be affected, for example, by interrupt initiation. This solution functions with conventional hardware but has the disadvantage of comparatively long latency. The following contributes to this:
the interrupt initiation (with the required context switching),
filling of the cache memories (after writing into the memory address space the cache memories of the processors must first be filled again)

A solution resides in that the cache memories of the processors are made accessible from the exterior for writing access. This requires corresponding modifications at processor interfaces. It must be possible to address the processors as targets wherein the addresses relate to the internal cache memories and the buffers. For this purpose, only the bus control circuitry must be modified (the other circuits in the processor remain the same).

Still higher processing performance can be achieved when the processor is also configured in the interior according to the principles of the present invention and emulates the operators not by conventional machine instructions but executes them directly. For this purpose, the already present processor structures can be utilized. Instruction decoding and microprogram control must be modified, processing units, connect controls, cache memories, buffers etc. can essentially remain the same.

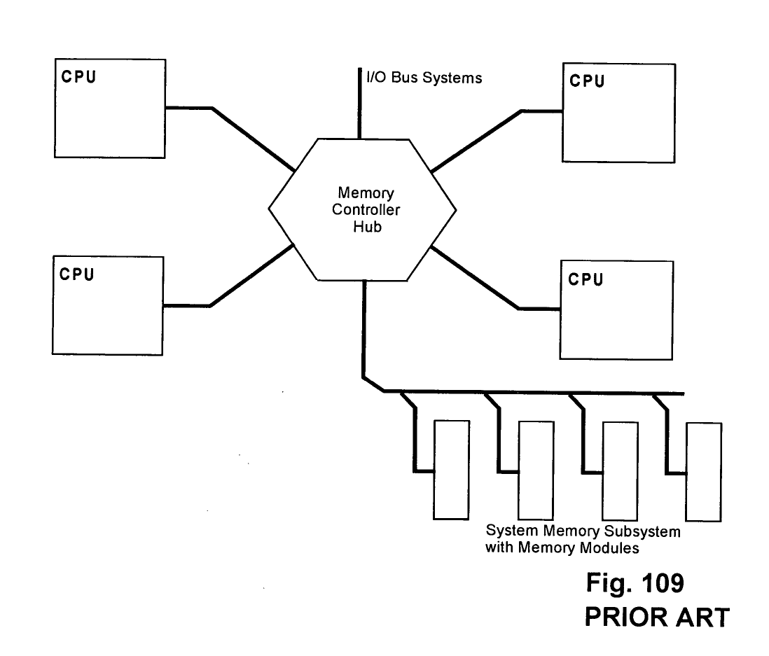

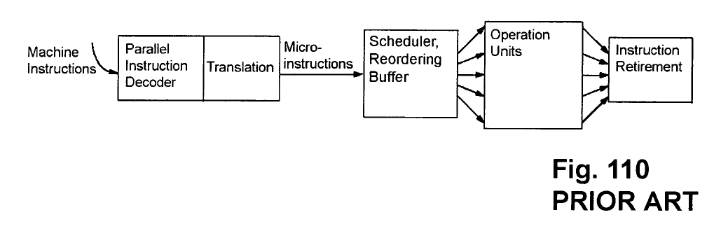

FIG. 108 illustrates a high-performance system in accordance with the prior art; it has several processors that are connected to one another by a bus system. FIG. 109 shows the connection by switching hubs. With the aid of block diagrams, FIGS. 110 and 111 provide an overview in regard to the configuration and function of modern high-performance processors that are configured as superscalar machines. Such processors work typically as follows:
1) several conventional machine instructions are read and decoded at the same time;
2) they are converted to microinstructions;
3) the microinstructions are buffered in an associative control memory (reordering buffer) and supplied to the operation units;
4) a microinstruction is performed when an appropriate operating unit is available;
5) the operations occur without taking into consideration the original instruction sequence;
6) when conflicts are recognized, the corresponding instructions are repeated as often as needed for the conflicts to disappear;
7) the instruction retirement provides the results of instructions that have been terminated conflict-free in such an way that the results of the instruction execution are appearing to the programmer in the same way as if they had been carried out by serial execution according to the original instruction sequence (programming intention).

This type of parallel processing is essentially a trial and error approach. In this connection, the scope where parallel processing is attempted is limited to the number of instructions that can be fetched and decoded simultaneously. The control expenditure is comparatively high.

In FIG. 111, the reference numerals have the following meaning: 1—system bus controller; 2—instruction fetch unit; 3, 4—instruction decoder for simple instructions; 5—instruction decoder for complex instructions; 6—register allocation unit; 7—instruction retirement; 8—microinstructions reordering buffer; 9—microinstructions scheduler; 10, 11—floating point operation units; 12, 13—integer operation units; 14—memory access controller; 15—architecture registers; 16—conventional microprogram control (controls everything that is too complex for parallel execution); 17—branch target buffer; 18—architecture instruction counter; 19—memory access buffer.

Based on such processors, systems for performing the method according to the invention can be configured. In this connection, the complex controllers (positions 3 to 9 in FIG. 111) are not needed. The operation units, the cache memories, the buffers as well as the bus interfaces remain. The instruction decoder is significantly simpler. The general-purpose register file can be extended significantly in comparison to conventional processors (for example, to 64 to 256 registers). The operation units can be directly coupled to the general-purpose registers. Since the complex control circuits are no longer present, optionally the set of operations can be expanded or additional operation units can be provided.

FIG. 112 illustrates the conversion of a conventional superscalar processor into hardware for directly performing the method according to the invention. The reference numerals correspond to those of FIG. 111.

It is apparent that on the basis of the method according to the invention the future possibilities of circuit integration (for example, a few hundred million transistors on a circuit) can be utilized to a large degree. Conventional high-performance processors (for example, similar to FIG. 111) have about 10 to 50 million transistors. On a circuit with 200 million transistors, it would be possible, for example, to arrange four processors each having approximately 50 million transistors. However, the performance capability of this arrangement can become effective in practice only when at least four programs are to be performed at the same time; the individual program cannot be accelerated in itself. When a processors similar to FIG. 111 is divided into its functional units, the operation units 10 to 13 correspond to general-purpose arithmetic-logic units. When cache memories, control circuits etc. in accordance with their size and number are maintained (same size, only modified structure), a circuit with 200 million transistors could comprise 32 general-purpose operation units that, according to the method of the present invention, are administered as resources and therefore could be beneficial for each individual program.

It is the task of the programmer to apply the method according to the invention expediently. The possibilities are between two extremes:
A. Conventional programming: a resource at one time. In analogy to the conventional machine instructions, a resource is requested, supplied with parameters, activated and finally released again. Then the next resource is requested etc.
B. The programming task is converted as a whole into one possibly gigantic virtual special hardware (for each processing operation a separate resource is requested, the resources are concatenated with one another etc.).

The second alternative finds its practical limitations in the memory demand and in the size of the actually available hardware so that compromises must always be found in practice.

Each resource, at least virtually, has a hardware/software interface at the register transfer level, i.e., can therefore be described formally as hardware (Boolean equations, automaton tables etc.). Programs that are based on the method according to the invention are no longer documented in the form of a character or bit string whose function can be recognized only by its execution but in the form of descriptive structures that can be analyzed in depth without being executed.

Based on the described principal solutions and variants, systems in accordance with the present invention can be configured on the basis of a modular system. The selection is based, as is conventional in computer architecture, on cost/benefit considerations and utilization frequency. Example:
a configuration X has advantages for applications of the type A,
a configuration Y has advantages in applications of the type B.

When applications of the type A are used more frequently than those of the type B, the configuration X will be selected, and vice versa.

The method according to the invention can be utilized as follows:

A) for theoretical considerations,

B) in programming practice,

C) in program documentation,

D) for conversion of programs that are formulated in different programming languages,

E) for building systems on the basis of programmable logic circuits,

F) for developing processor and system architectures.

A) Theory.
Conventional programs are essentially present only as text (character strings). Based on the analysis of the program text alone, the behavior of the program can be predicted only insufficiently; the program must be executed in order to recognize its functions. On the other hand, on the basis of the method according to the invention it is possible to convert the programming goal into a virtual circuit structure whose information processing operations can be dissolved down to the individual Boolean equations. In this way, formal correctness proofs are simplified or can be realized (application of graph theory, automata theory, Boolean algebra etc.). The fact that in the end a virtual hardware structure is present can also be used for program debugging; all methods (and tricks) that have been found useful for troubleshooting in hardware can be applied (dividing the entire “circuit” into blocks that can be tested individually, setting up test configurations with test data generation and test result analysis, injection of test patterns into suspected circuitry etc.). As in the case of troubleshooting in hardware where optionally signal generators, logic analyzers etc. are used, in such a system corresponding testing aids can be combined as needed from the already present resource pool.

B) Programming.
Both principles (emulation and compilation) have special advantages for certain fields of application:
a) Emulation. Utilization preferably in embedded systems. Appropriate programs are developed with conventional programming languages as well as with design tools that support formulating the design intentions by graphic means, for example, based on block diagrams, flowcharts, and state machines. Such design systems generate typically an intermediate code in a conventional programming language (C, C++ etc.) that is subsequently converted into a program for the corresponding target machine by means of a conventional compiler. However, the expression means of conventional general-purpose programming languages are not especially suitable for the application problems in question. Programs generated according to the method of the present invention described basically circuit structures, i.e. hardware. Therefore, such programs can be derived obviously from the block diagrams, state diagrams etc. Instead of the intermediate code (for example, in C) a code is provided that selects an appropriately chosen configuration of resources and connects and controls it; the resource pool is optimized in regard to the respective fields of application (for example, in regard to work with Boolean equations and automaton tables).
b) Compilation (generating “real” machine programs for the respective target architecture). Utilization preferably for complex applications of which a high processing performance is expected. A typical developmental course: formulation of the programming goal (in any suitable programming language) => conversion into the code of a virtual machine according to the principles of the present invention => conversion into the machine code of the target architecture => program execution. It is conventional to convert the source code first into a virtual machine code. Such virtual machines are usually designed as stack machines. Stack machines operate however inherently sequentially (one operation at a time). In contrast to this, virtual machines designed according to the present invention have primarily the following advantages:
   1) the inherent parallelism in the program can be recognized better,
   2) it is possible to recognize opportunities for utilization of SIMD provisions and VLIW instructions,
   3) reduction of the portion of housekeeping operations (overhead), for example, when calling functions and when transporting parameters.
Use in fields of application with high requirements in regard to functional safety. The processor (or microcontroller) interprets a virtual circuit structure that, in contrast to a conventional program (which must be run in order to verify its correct function), is accessible to examination and verification also in the static state. Accordingly, microprocessors, microcontrollers etc. can also be used in cases where in the past, for safety reasons, the use of programmable devices has been excluded. Prior art: a circuit solution is developed, tested with regard to compliance to the respective regulations, and finally built as hardware. The alternative: the circuit is described with the expression means of the method according to the present invention (operators etc.), the description is emulated by the processor or controller. A correctly written emulator can never crash, no matter which error is present in the system to be interpreted. Therefore, the software based on the method according to the present invention has the same functional safety as “real” hardware implementation.

C) Program documentation.
A program based on the method according to the invention can describe the programming goal in all essential details—if needed, down to the individual Boolean equation. Therefore, it is to be expected that such programs can be converted without problems into machine code for future systems.
   D) Program conversion; meta-language.
All programs, no matter in which language they are formulated, are in the end control instructions for information processing operations, transports and state transfers in register transfer structures. A sufficiently equipped resource pool (relative to data type, operations etc.) is suitable therefore, in combination with the operators according to the invention, as a general-purpose compiler target or (from a theoretical standpoint) as a general-purpose meta-language in which all expressions of the different programming languages can be reproduced.
   E) Systems based on programmable logic circuits.
The method according to the invention makes it possible to describe complex designs independent of their realization and implementation, with hard or soft circuitry, depending on the expedience. In this connection, it possible to exchange hardware and software with one another.
An instruction set that is based on the principles of the present invention is a uniform machine language that can describe hardware as well as software.
The conventional programmable circuits contain basically only two types of circuit means:
1. General-purpose functional blocks, macrocells etc. that carry out only comparatively simple combinatorial operations and can save only a few bits in flip flops (reference value: 1 to 4 flip flops per cell). This can be referred to as “fine granularity”.
2. Hard IP cores, for example, complete processors. This corresponds to “coarse granularity”.
Soft IP cores occupy a lot of the silicon area. When comparing hard (optimized down to the transistor) and soft implementation of the same function, the soft implementation typically requires more than ten times as many transistors than the hard one. Also the speed is correspondingly reduced (ratio of clock frequency typically 4:1 to more than 10:1).
Hard implementations however are expensive (developmental expenditure) and not as flexible. It is not easily possible to connect them to any circuits as desired; instead, it is necessary to utilize the provided interfaces (for example, bus systems). This requires typically additional expenditure for adaptation.
According to the principles of the present invention, programmable circuits can be designed that have a medium granularity—the “thick” hard processor is essentially dissolved into its components that are made available as individual modules. Also, the connecting structures can be optimized with regard to typical information transports. Based on the available resources (computation circuits, addressing circuits etc.) general-purpose computers or special circuits can be configured as needed and the configurations can be changed while in operation.
   F) Processors and system architectures.
A characterizing feature is the decomposition of the processor structures into the individual functional units and the seamless transition between hardware and software. If the resource pool is standardized appropriately, the fixed (monolithic) proprietary processor architectures, operating systems, and application programs can be replaced by resources of arbitrary origin (distributed system architecture). System functions as well as application functions are provided by resources that are of arbitrary origin and, as needed, are implemented as hardware or software. It is important in this connection that the operators or instructions describe only call, activation etc. of the resources while the actual functional effects are provided in the interior of the respective resource. In order for this to be realized in practice, it is required to standardize comprehensively resource descriptions and universal instruction codes (for example, byte codes).
Prior attempts to realize such concepts are based on higher formal languages or virtual machines that can be emulated comparatively easily. When utilizing higher formal languages, the transition from one platform to another or the change between hardware and software always requires new compilation. For this purpose, an appropriate compiler is required. Because the internal interfaces (for example, the parameter transfer) are not uniformly standardized, there are always compatibility problems. When a virtual machine is used, such difficulties can be avoided to a large degree. Conventional virtual machines however have been developed primarily under the premise of effective compilation of software (example: P-code (Pascal), Forth machines, JVM (Java Virtual Machine)). They are therefore hardly suitable as general-purpose interfaces for complex high-performance hardware (parallel processing, application-specific processing units etc.). When utilizing the method according to the invention, the inherent parallelism can be detected directly based on the programming goal. In this way, it is possible to utilize simultaneously even hundreds of operation units. Memory and processing circuitry can be connected directly with one another. In the extreme, the individual (hardware) resource is a memory array with an operation unit (resource cell).

The specification incorporates by reference the entire disclosure of German priority document 10 2005 021 749.4 having a filing date of May 11, 2005.

While specific embodiments of the invention have been shown and described in detail to illustrate the inventive principles, it will be understood that the invention may be embodied otherwise without departing from such principles.

What is claimed is:

1. A method for program-controlled information processing, wherein resources for information processing form a resource pool, wherein from the resource pool resources are selected for use in information processing and wherein the resources after their use are returned to the resource pool.

2. The method according to claim 1, comprising the steps of:
a) selecting suitable resources from the resource pool that are suitable for performing information processing operations;
b) configuring connections between the selected resources;
c) supplying parameters to the selected resources;
d) initiating the information processing operations in the selected resources;
e) transporting data between the selected resources;
f) assigning results;
g) disconnecting connections that are no longer needed between the selected resources;
h) returning the selected resources that are no longer needed to the resource pool.

3. The method according to claim 2, wherein the step of selecting suitable resources is controlled by stored instructions in the form of s-operators that contain resource type information.

4. The method according to claim 2, wherein the step of configuring connections is controlled by stored instructions in the form of c-operators that contain selection information relating to the resources.

5. The method according to claim 2, wherein the step of supplying parameters is controlled by stored instructions in the form of p-operators that contain selection information relating to storage means and the resources.

6. The method according to claim 2, wherein the step of initiating the information processing operations is controlled by stored instruction in the form of y-operators that contain selection information relating to the resources.

7. The method according to claim 2, wherein the step of transporting data is controlled by stored instructions in the form of l-operators that contain selection and connection information relating to the resources.

8. The method according to claim 2, wherein the step of assigning results is controlled by stored instructions in the form of a-operators that contain selection information relating to the resources and storage means.

9. The method according to claim 2, wherein the step of disconnecting is controlled by stored instructions in the form of d-operators that contain selection information relating to the selected resources.

10. The method according to claim 2, wherein the step of returning the resources is controlled by stored instructions in the form of r-operators that contain information relating to the selected resources.

11. The method according to claim 2, wherein the step of selecting suitable resources is controlled at least partially by stored instructions in the form of s_a-operators that contain, in addition to resource type information, selection information relating to the resources to be correlated with the selected resources.

12. The method according to claim 2, wherein the step of supplying parameters is partially controlled by stored instructions in the form of p_imm-operators that contain immediate values and selection information relating to the resources.

13. The method according to claim 2, wherein the step of initiating the information processing operations is partially controlled by stored instructions in the form of y_f-operators that contain function codes in addition to selection information relating to the resources.

14. The method according to claim 2, wherein at least some of the selected resources are built from resources of the resource pool by recursively applying the method steps of claim 2.

15. The method according to claim 2, wherein the stored instructions necessary to solve a particular application problem are at least partially generated, moved or modified by recursively applying the method steps of claim 2.

16. The method according to claim 2, wherein the step of selecting suitable resources and the step of configuring connections are controlled such that the selected resources form a resource arrangement that correspond to a data flow diagram of an application problem to be solved.

17. The method according to claim 2, wherein, in the step of selecting suitable resources, circuit arrangements for a resource are reserved, initialized and assigned.

18. The method according to claim 2, wherein, in the step of selecting suitable resources, memory space is reserved, initialized and assigned.

19. The method according to claim 2, wherein, in the step of selecting suitable resources, a circuit arrangement is generated by programming programmable cells and connections.

20. The method according to claim 2, wherein stored instructions for controlling the steps a) through h) that are executable simultaneously are combined to control words.

21. The method according to claim 2, wherein the information processing operations are at least partially initiated by supplying parameters to be processed.

22. The method according to claim 2, wherein in the step of configuring connections the selected resources are connected such that some of the selected resources are connected upstream of other selected resources, wherein the selected resources that are upstream automatically transfer at least parts of the results to the selected resources that are downstream.

23. The method according to claim 22, wherein at least some transfers from the selected resources that are upstream to the selected resources that are downstream are carried out only when within the resources that are upstream certain conditions are met.

24. The method according to claim 2, wherein in the step of configuring connections the selected resources are connected such that some of the selected resources are connected upstream of other selected resources, wherein the selected resources that are upstream automatically transfer at least parts of the supplied parameters to the selected resources that are downstream.

25. The method according to claim 24, wherein at least some transfers from the selected resources that are upstream to the selected resources that are downstream are carried out only when within the resources that are upstream certain conditions are met.

26. The method according to claim 2, wherein the steps a) to h) are controlled by stored instructions, wherein selection information relating to the resources contained within the stored instructions has the form of pointers that refer to parameters of the resources.

27. The method according to claim 2, wherein parameters provided for configuring connections according to step b) each have at least one correlated pointer.

28. The method according to claim 2, wherein parameters provided for configuring connections according to step b) each have correlated therewith a first pointer and a second pointer, wherein the first pointer refers to a predecessor and the second pointer refers to a successor within a connection, respectively.

29. The method according to claim 28, wherein a connection to an additional parameter is configured, respectively, in that a c-operator causes the second pointer of the predecessor parameter associated with the respective connection to point to the additional parameter and enters a backward reference to the predecessor parameter associated with the respective connection into the first pointer of the additional parameter.

30. The method according to claim 28, wherein a connection to a particular parameter is disconnected, respectively, in that a d-operator loads the second pointer of the predecessor parameter associated with the respective connection with the content of the second pointer of the parameter to be disconnected and loads the content of the first pointer of the successor parameter associated with the respective connection with the content of the first pointer of the parameter to be disconnected.

31. The method according to claim 2, wherein the resources, after information processing operations have been initiated, automatically import at least parts of the data to be processed from memory devices.

32. The method according to claim 2, wherein the resources, after information processing operations have been initiated, automatically write at least parts of the computed results to memory devices.

33. The method according to claim 2, wherein the resources, after information processing operations have been initiated, automatically read control information for further control of the processing operations from memory devices.

34. The method according to claim 2, wherein some of the selected resources are used to supply the parameters required by other selected resources.

35. The method according to claim 2, wherein some of the selected resources are used to transport the results generated by other selected resources.

36. The method according to claim 2, wherein some of the selected resources are used to cause other selected resources to carry out information processing operations.

37. The method according to claim 2, wherein branching in the sequence of the information processing operations is done by entering branching data, transferring conditions for selecting a branching direction, and triggering a branching operation.
